(19) United States
(12) Patent Application Publication
(10) Pub. No.: US 2009/0096148 A1
(43) Pub. Date: Apr. 16, 2009

(54) Workpiece grasper and workpiece transfer apparatus using the same

(75) Inventor: Hirokazu Usui, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,475

(22) Filed: Oct. 7, 2008

(30) Foreign Application Priority Data
Oct. 10, 2007 (JP) 2007-264735

(51) Int. Cl. B25B 1/20; B65G 65/00; B64F 5/00; B23Q 17/22; B25J 9/22

(52) U.S. Cl. 269/45; 414/283; 414/589; 33/626; 318/568.13

(57) ABSTRACT

A workpiece grasper and a workpiece transfer apparatus shorten the time that a processing facility must be stopped. A workpiece is transferred along a production line and processed in three or more processing facilities. A workpiece grasper grasps and places the workpiece to be transferred between the processing facilities. The workpiece grasper includes a rotation mechanism and two hands capable of grasping and placing the workpiece. The rotation mechanism rotates the two hands above a line along a transfer direction of the workpiece. The rotation mechanism changes the hands for grasping the workpiece from a processing facility and changes the hands for placing the grasped workpiece on a processing facility.

### CROSS REFERENCE TO RELATED APPLICATIONS

The present application is based on and claims priority to Japanese Patent Application No. 2007-264735, filed Oct. 10, 2007, the entire contents of which are incorporated herein by reference.

### BACKGROUND OF THE INVENTION

1. Field of the Invention

The present invention relates to a workpiece grasper and a workpiece transfer apparatus using the same applicable to a production line including two or more transfer processes.

2. Description of the Related Art

The conventional transfer robot described in JP-2001-191278 A provides an example of a workpiece grasper that includes first and second hands used grasps and transfers a workpiece.

When a transfer robot such as is described in JP-2001-191278 A is used in a production line including two or more transfer processes such as transfers to processing facilities 1 through 3 or simply facilities 1 through 3, a known disadvantage is present involving an increase in the time to stop facilities during workpiece transfer operations.

The transfer robot described in JP-2001-191278 A lowers first and second hands to grasp and raise a workpiece from the facility 2. The transfer robot moves the workpiece picked up from the facility 2 to the facility 3 and places the workpiece on the facility 3. After placing the workpiece on the facility 3, the transfer robot returns to the facility 1, lowers the hands to grasp a workpiece from the facility 1, and raises and moves the hands to the facility 2. Disadvantages arise in that during the transfer, the facility 2 needs to stop processing for mounting and dismounting of the workpieces. That is, during the time when the hands travel from facility 2 to facility 3, facility 3 to facility 1, and from facility 1 back to facility 2, which further involves eight separate up and down movements of the arms, facility 2 must stop processing workpieces and is therefore disadvantageously idle.

### SUMMARY OF THE INVENTION

The present embodiment has been made in consideration of the foregoing. It is therefore an object of the present embodiment to provide a workpiece grasper and a workpiece transfer apparatus using the workpiece grasper capable of shortening the time to stop a processing facility.

To achieve the above-described object, a workpiece grasper according to a first aspect is used in a production line for transferring a workpiece and processing a workpiece using three or more processing facilities to grasp and place the workpiece for transferring the workpiece between processing facilities. The workpiece grasper includes two hands that grasp and place the workpiece and a change mechanism for rotating the two hands above a line along a transfer direction of the workpiece so as to change a hand for grasping the workpiece from the processing facility and to change a hand for placing the grasped workpiece on the processing facility.

The two hands can grasp different workpieces at the same time. Further, one hand can grasp a workpiece while the other hand can place the workpiece. The one hand can grasp the workpiece from the processing facility and the other hand can place the grasped workpiece on the processing facility. It is thereby possible to shorten the time to stop the processing facility.

The exemplary workpiece grasper uses one hand to grasp a first workpiece from a first processing facility. While maintaining the state of grasping the first workpiece from the first processing facility with one hand, the workpiece grasper moves to a second processing facility, changes to an other hand, and uses the other hand to grasp a second workpiece from the second processing facility. The workpiece grasper then changes hands at the second facility so as to place the first workpiece grasped at the first facility on the second facility. When the operation is completed, the second facility is again ready for a processing operation. Compared to a transfer of workpieces using only one hand, an exemplary workpiece grasper can decrease the number of necessary movement operations and shorten the time during which the processing facility is stopped.

In accordance with another aspect, the two hands may be provided in an open state with a specified angle for a base member arranged above a line along a transfer direction of the workpiece. The change mechanism may rotate the base member to rotate the two hands above a line along a transfer direction of the workpiece.

The base member is rotated to rotate the two hands above the line along the transfer direction of workpieces, making it possible to easily change the hands.

To achieve the above-described object, the workpiece transfer apparatus according to another aspect includes a first process that uses a first hand of the two hands to grasp the workpiece from a given processing facility out of the three or more processing facilities, a second process that moves the workpiece grasper to a second processing facility as a next processing facility and allows the change mechanism to change, for example, an active hand, from the first hand grasping the workpiece to a second hand, a third process that allows the second hand to grasp the workpiece from the second processing facility, a fourth process that allows the change mechanism to change, for example, the active hand, from the second hand to the first hand after the third process, a fifth process that places the workpiece grasped by the first hand on the second processing facility after the fourth process, a sixth process that moves the workpiece grasper to a third processing facility as a next processing facility and allows the first hand to grasp the workpiece from the third processing facility after the fifth process, a seventh process that allows the change mechanism to change a hand for placing the workpiece to the second hand after the sixth process, and an eighth process that places the workpiece grasped by the second hand on the third processing facility after the seventh process.

It should be noted that upon completion of the fifth process, the second processing facility is ready for operation. Compared to the transfer of workpieces using only one hand, the exemplary workpiece grasper described herein can decrease necessary operations and shorten the time to stop the processing facility.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a schematic diagram illustrating an outlined construction of a production line using a workpiece transfer apparatus having an exemplary workpiece grasper in accordance with an embodiment;

FIG. 2 is a perspective view illustrating an outlined construction of the exemplary workpiece grasper in accordance with an embodiment;

FIG. 3 is a schematic diagram illustrating the exemplary workpiece grasper in accordance with an embodiment mounted on a rail;

FIG. 4 is a flow diagram illustrating an exemplary transfer process of the workpiece transfer apparatus in accordance with an embodiment;

FIG. 5 is a diagram illustrating a difference between the workpiece transfer apparatus in accordance with an embodiment and a transfer apparatus using one hand;

FIG. 6 is a schematic diagram illustrating exemplary drive accuracy correction of the workpiece transfer apparatus in accordance with an embodiment;

FIG. 7 is a diagram illustrating exemplary detection of a jig by contact;

FIG. 8 is a diagram illustrating a perspective view of a correction bar for measuring and calibrating an absolute accuracy;

FIG. 9 is a diagram illustrating a partially enlarged view of FIG. 8;

FIG. 10 is a graph illustrating an exemplary relation between a true value and an instruction value or a drive value;

FIG. 11A is a schematic diagram illustrating an exemplary space with calibrated coordinates and a space around that space;

FIG. 11B is a schematic diagram illustrating an exemplary space with calibrated coordinates and a space around that space;

FIG. 12A to FIG. 12D are schematic diagrams illustrating various reference points;

FIG. 13A and FIG. 13B are diagrams illustrating calibration of a measurement jig;

FIG. 14 is a diagram illustrating a perspective view of a correction bar mounted on the measurement jig;

FIG. 15 is a diagram illustrating a plan view of a calibration jig on the measurement jig;

FIG. 16 is a diagram illustrating a side view of FIG. 15;

FIG. 17 is a diagram illustrating a partially enlarged view of FIG. 16;

FIG. 18 is a diagram illustrating a side view of a hole of a correction jig;

FIG. 19A and FIG. 19B are schematic diagrams illustrating parallel and leveling adjustment;

FIG. 20 is a schematic diagram illustrating true X and Y values;

FIG. 21 is a schematic diagram illustrating a drive value of the exemplary workpiece grasper;

FIG. 22 is a schematic diagram illustrating true coordinate values for the exemplary workpiece grasper;

FIG. 23 is a graph illustrating an exemplary relation between a true coordinate and a drive quantity when multiple calibration jigs are mounted on a rail;

FIG. 24 is a graph illustrating an exemplary relation between a drive value and a weight from an estimated drive value curve;

FIG. 25 is a graph illustrating an exemplary relation between a drive value and a weight from an estimated drive value curve when the number of samples is 4;

FIG. 26 is a schematic diagram illustrating an exemplary relation between a space containing one reference point and a space acquiring a drive value;

FIG. 27 is a graph illustrating an exemplary relation between a true value and a drive value when one reference point is used;

FIG. 28 is a schematic diagram illustrating an exemplary relation between a space containing two reference points and a space acquiring a drive value;

FIG. 29 is a schematic diagram illustrating an exemplary relation between a space containing four reference points and a space acquiring a drive value;

FIG. 30 is a graph illustrating an exemplary relation between a true value and a drive value when four reference points are used;

FIG. 31 is a graph illustrating an exemplary relation between a true value and a drive value when eight reference points are used;

FIG. 32 is a block diagram illustrating an outlined construction of an exemplary calibration system;

FIG. 33 is a schematic diagram illustrating an outlined construction of an exemplary robot instance;

FIG. 34 is a schematic diagram illustrating an exemplary function of converting a true value into a drive value;

FIG. 35 is a schematic diagram illustrating an exemplary function of converting a drive value into a true value;

FIG. 36 is a schematic diagram illustrating an exemplary relation between a true coordinate and a drive quantity for explanation of area determination;

FIG. 37 is a schematic diagram illustrating an exemplary relation between a true coordinate and a drive quantity associated with a calibration range;

FIG. 38 is a schematic diagram illustrating an outlined construction of the exemplary workpiece grasper and the jig associated with calibration of calibrating facility and jig positions;

FIG. 39 is a schematic diagram illustrating an outlined construction of an exemplary facility and jig position calibration system;

FIG. 40 is a diagram illustrating a sectional view of a construction of a hand of the exemplary workpiece grasper;

FIG. 41 is a diagram illustrating an enlarged view of a flange of the exemplary workpiece grasper;

FIG. 42 is a schematic diagram illustrating exemplary automatic inching detection of the facility;

FIG. 43 is a schematic diagram illustrating exemplary automatic inching detection of the jig;

FIG. 44 is a schematic diagram illustrating an exemplary positional relation between the facility and a tool or the hand during the automatic inching detection;

FIG. 45 is a schematic diagram illustrating positional relation between the jig and a tool or the hand during the automatic inching detection;

FIG. 46 is a schematic diagram illustrating a system construction of the automatic inching detection;

FIG. 47 is a schematic diagram illustrating a facility coordinate system and a jig definition coordinate system;

FIG. 48 is a schematic diagram illustrating tool contact positions;

FIG. 49 is a diagram illustrating coordinate symbols corresponding to XYZ parallel shifts and angles to be corrected;

FIG. 50A and FIG. 50B are diagrams illustrating X_XS, Mes, Z_XS, YsttXS, and YstpXS based on XS correction;

FIG. 51A and FIG. 51B are diagrams illustrating nomenclatures and dimensions of an exemplary hand;

FIG. 52 is a diagram illustrating nomenclatures and dimensions for an exemplary contact calibration;

FIG. 53A and FIG. 53B are diagrams illustrating exemplary nomenclatures and dimensions for grasping a workpiece;

FIG. 54 is a diagram illustrating an exemplary relation between a contact probe start point, a probe axis and probe direction, and a probe length;

FIG. 55A is a schematic diagram illustrating an exemplary relation between a reference bar and a coordinate system under a condition of X_PY≧0;

FIG. 55B is a schematic diagram illustrating an exemplary relation between a reference bar and a coordinate system under a condition of X_PY<0;

FIG. 56 is a diagram illustrating contact coordinates MPO, MPX, MPY, MXS, MXL, MYS, and MYL after offset correction;

FIG. 57 is a diagram illustrating an exemplary system for finding an origin from an intersection between straight lines X and Y;

FIG. 58 is a diagram illustrating MZPO, MZPX, MZPY, MXYS, MXYL, and MYXS;

FIG. 59 is a schematic diagram illustrating an equation for an XY plane of a jig measurement coordinate system MM found from MZPO, MZPX, and MZPY;

FIG. 60 is a schematic diagram illustrating an exemplary substitution of (MXYS, Y_YS) and (MXYL, Y_YL) for the XY plane equation and an exemplary calculation of Z coordinate values for the corresponding points;

FIG. 61 is a schematic diagram illustrating an exemplary substitution of a value of (X_XS, MYXS) for the XY plane equation and an exemplary calculation of Z coordinate values;

FIG. 62 is a diagram illustrating exemplary correction items, coordinates, and contact values associated with finding a plane equation from three measure points;

FIG. 63 is a diagram illustrating exemplary replacement of a plane equation;

FIG. 64 is a schematic diagram illustrating the addition of an exemplary value of 50 to the Z axis of a jig definition coordinate system JD;

FIG. 65 is a diagram illustrating exemplary correction items, coordinates, and contact values when finding a Z coordinate;

FIG. 66 is a diagram illustrating exemplary correction items, coordinates, and contact values when finding PZXS;

FIG. 67 is a diagram illustrating an exemplary straight line equation when the straight line gradient and the coordinate of a point on the straight line are known;

FIG. 68 is a schematic diagram illustrating exemplary coordinates Ox, Oy, and Oz for an intersection point between the X and Y axes in the jig definition coordinate system JD;

FIG. 69 is a diagram illustrating an exemplary vector for finding Z axis components Zx, Zy, and Zz;

FIG. 70 is a diagram illustrating MZPO, MZPX, MZPY, MYXS, MYXL, and MXYS;

FIG. 71 is a diagram illustrating exemplary correction items, coordinates, and contact values when finding a plane equation from three measure points;

FIG. 72 is a diagram illustrating exemplary correction items, coordinates, and contact values when finding a Z coordinate;

FIG. 73 is a diagram illustrating exemplary correction items, coordinates, and contact values when finding PZYS;

FIG. 74 is a diagram illustrating an exemplary straight line equation when the straight line gradient and the coordinate of a point on the straight line are known;

FIG. 75 is a diagram illustrating exemplary correction items, coordinates, and contact values when finding origin Ox, Oy, and Oz;

FIG. 76 is a schematic diagram illustrating exemplary coordinates Ox, Oy, and Oz for an intersection point between the X and Y axes in the jig definition coordinate system JD;

FIG. 77 is a schematic diagram illustrating an outlined construction of an exemplary production line;

FIG. 78 is a diagram illustrating an exemplary positional relation between a rail, a workpiece grasper R, a workpiece grasper B, and a reference bar;

FIG. 79 is a diagram illustrating a calculation result indicating positions of a reference bar viewed from the exemplary workpiece graspers R and B;

FIG. 80 is a diagram illustrating a relation between an actual position of the reference bar and a position given to the exemplary workpiece graspers R and B;

FIG. 81 is a diagram illustrating an exemplary positional displacement of the reference bar;

FIG. 82 is a diagram illustrating relation between the reference bar position for the exemplary workpiece grasper R and the reference bar position for the exemplary workpiece grasper B;

FIG. 83 is a diagram illustrating a top view of an exemplary facility when a camera and a laser distance meter are used to measure a height;

FIG. 84 is a diagram illustrating a side view of a positional relation between the exemplary workpiece grasper and the facility when a camera and a laser distance meter are used to measure a height;

FIG. 85 is a diagram illustrating a side view of an outlined construction of a jig used for automatically measuring an offset between the hand and the center axis of the camera;

FIG. 86 is a diagram illustrating a top view of FIG. 85;

FIG. 87 is a diagram illustrating exemplary operations of a hand and a camera for automatically measuring an offset and the center axis of the camera positioned to a white-black boundary;

FIG. 88 is a diagram illustrating exemplary operations of a hand and a camera for automatically measuring an offset and the hand in contact with the jig;

FIG. 89 is a diagram illustrating exemplary automatic measurement of an offset between the hand and a laser height measuring instrument;

FIG. 89 is a diagram illustrating exemplary automatic measurement of an offset between the hand and a laser height measuring instrument and the hand being lowered to the facility;

FIG. 91 is a diagram illustrating a focus and a focal length of an exemplary camera;

FIG. 92 is a diagram an exemplary illustrating positional relation between an observing point and a mark;

FIG. 93A and FIG. 93B are diagrams illustrating plan views of an exemplary separable reference bar;

FIG. 94A and FIG. 94B are diagrams illustrating an exemplary advantage of the separable reference bar;

FIG. 95 is a diagram illustrating a side view of an outlined construction of a vacuum contact pad used as a hand; and

FIG. 96 is a diagram illustrating a side view of FIG. 95.

### DETAILED DESCRIPTION OF EXEMPLARY EMBODIMENTS

Embodiments will be described in further detail with reference to the accompanying drawings.

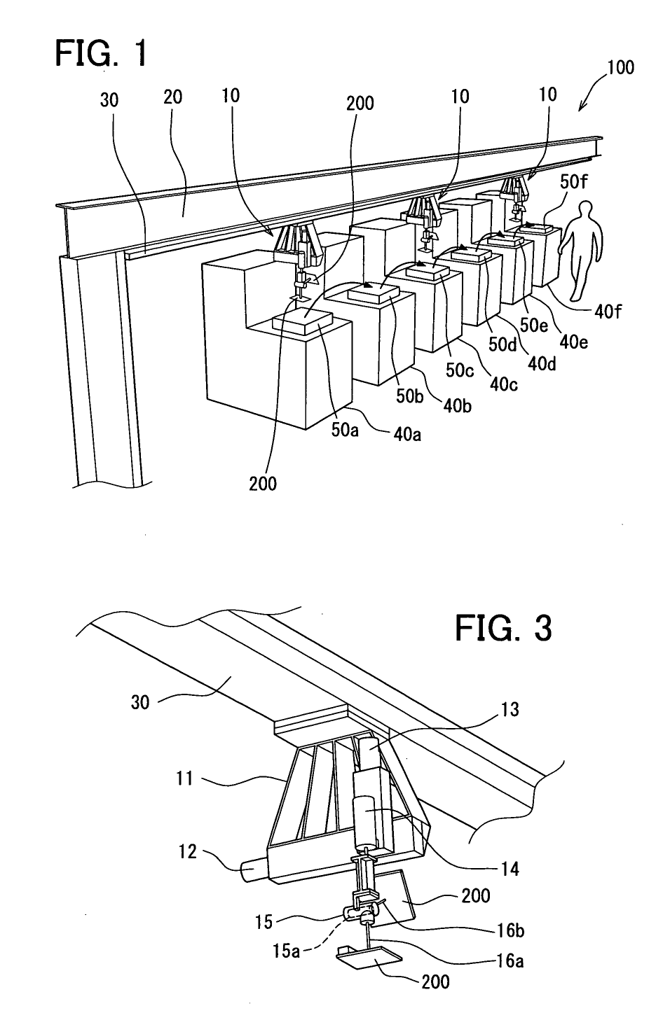

FIG. 1 through FIG. 5 show various aspects of an exemplary workpiece transfer apparatus in accordance with the present embodiment.

As shown in FIG. 1, the workpiece transfer apparatus includes a workpiece grasper 10 and is applied to a production line 100 that uses three or more processing facilities such as processing facilities 40a through 40f that are used to process a workpiece 200. The workpiece transfer apparatus automatically transfers the workpiece 200 including a printed board, printed wiring board, printed circuit board or the like, including a printed board mounted with circuit parts. The processing facilities 40a through 40f are used to process the workpiece 200.

The processing facilities 40a through 40f of the production line 100 correspond to individual processes of the workpiece 200. The workpiece transfer apparatus transfers the workpiece 200 to the processing facilities 40a through 40f, which in the present embodiment can be arranged in an approximately straight line configuration. The processing facilities 40a through 40f are provided with jigs 50a through 50f for mounting the workpiece 200. The workpiece transfer apparatus has a rail 30 for moving workpiece grasper 10 that can be controlled by a controller (not shown).

A support beam 20 is provided above the processing facilities 40a through 40f to support or suspend the workpiece grasper 10 that grasps and transfers the workpiece 200. More specifically, the support beam 20 is provided more or less directly above the jigs 50a through 50f. The support beam 20 is provided to support the rail 30 in the gravity direction against the processing facilities 40a through 40f. The rail 30 movably supports the workpiece grasper 10 in the length direction of the support beam 20.

The support beam 20 and the rail 30 are provided so as to cover a row at least from one end to the other end. In the row, the processing facilities 40a through 40f are arranged. That is, the support beam 20 and the rail 30 are contiguously provided above all the processing facilities 40a through 40f such that the workpiece grasper 10 can move throughout all the processing facilities 40a through 40f. For example, a linear motor moves the workpiece grasper 10 while the workpiece grasper 10 hangs from the rail 30, when the rail 30 is configured as a linear motor drive rail or rail pair.

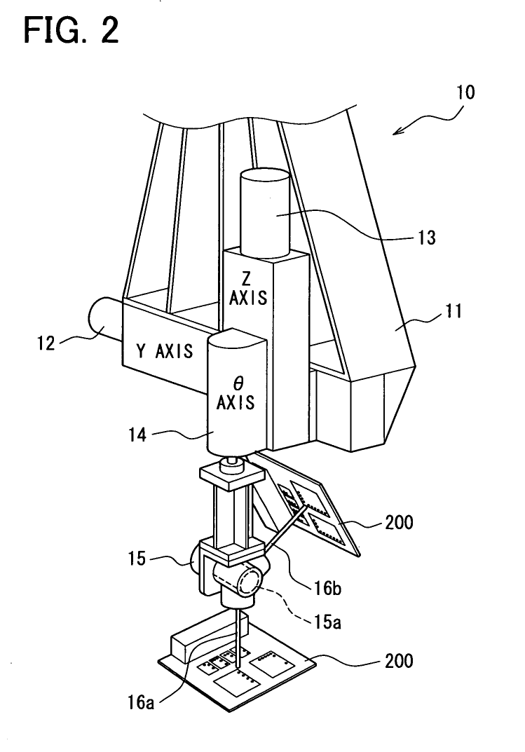

As shown in FIGS. 2 and 3, the workpiece grasper 10 includes a support section 11, a Y-axis adjusting section 12, a Z-axis adjusting section 13, a θ-axis adjusting section 14, a base member 15, and hands 16a and 16b. The support section 11 is provided with the Y-axis adjusting section 12, the Z-axis adjusting section 13, the θ-axis adjusting section 14, the base member 15, and the hands 16a and 16b included in the workpiece grasper 10. The support section 11 is provided with an drive section (not shown) that movably hangs from the rail 30.

The Y-axis adjusting section 12 includes an actuator and adjusts the hands 16a and 16b in the Y-axis direction. The Y-axis direction is parallel to the ground and is perpendicular to the transfer direction of the workpiece 200. The Y-axis adjusting section 12 adjusts the hands 16a and 16b in the Y-axis direction based on instructions from the controller (not shown).

The Z-axis adjusting section 13 includes an actuator and adjusts the hands 16a and 16b in the Z-axis direction. The Z-axis direction is perpendicular to the ground. The Z-axis adjusting section 13 moves the hands 16a and 16b perpendicularly to the ground to move the workpiece 200 near to or far from the processing facilities 40a through 40b. In other words, the Z-axis adjusting section 13 vertically moves the hands 16a and 16b. The Z-axis adjusting section 13 adjusts the hands 16a and 16b in the Z-axis direction based on instructions from the controller (not shown).

The θ-axis adjusting section 14 includes an actuator and adjusts the hands 16a and 16b in the θ-axis direction. The θ-axis direction represents a rotation direction around the direction perpendicular to the ground as a rotation axis. The θ-axis adjusting section 14 rotates the hands 16a and 16b around the rotation axis that is the direction perpendicular to the ground. The θ-axis adjusting section 14 adjusts the hands 16a and 16b in the θ-axis direction based on instructions from the controller (not shown).

The base member 15 is provided with the two hands 16a and 16b opened at a specified angle and includes a rotation mechanism 15a as a switching mechanism including an actuator. The rotation mechanism 15a rotates the base member 15 above a line along the transfer direction of the workpiece 200. The base member 15 rotates above the line along the transfer direction of the workpiece 200 while supporting the two hands 16a and 16b. In other words, the rotation mechanism 15a allows the base member 15 to be parallel to the ground and rotate around the rotation axis perpendicular to the transfer direction of the workpiece 200. The hands 16a and 16b are provided to the base member 15 so as to be opened at a specified angle centering around the rotation axis.

According to an embodiment, the rotation mechanism 15a rotates the base member 15 to switch between the hands 16a and 16b. The rotation mechanism 15a switches between the hands 16a and 16b for grasping the workpiece 200 from the processing facilities 40a through 40f and switches between the hands 16a and 16b for mounting the grasped workpiece 200 onto the processing facilities 40a through 40f. In other words, selecting the hand 16a or 16b to be positioned against the jigs 50a through 50f or the workpiece 200 mounted on the jigs 50a through 50f involves switching between the hands 16a and 16b. The hands 16a and 16b may be provided so as to be attached to or detached from the base member 15.

The hands 16a and 16b independently hold and mount the workpiece 200. The hands 16a and 16b may use cylindrical members to hold the workpiece 200 with vacuum or may grip the workpiece 200 therebetween. When the workpiece 200 has a hole, the hands 16a and 16b may be inserted into the hole to hold the workpiece 200 using an internal pipe and a rod member. The internal pipe has a cylindrical portion extending in the axis direction of the hole and a divided portion divided into multiple portions at the end of the cylindrical portion. The rod member has a projected portion smaller than the hole and larger than the opening of the internal pipe. Before part of the internal pipe and the rod member is inserted into the hole, the projected portion is placed outside the internal pipe. When part of the internal pipe and the rod member is inserted into the hole, the rod member moves opposite to the insertion direction to place the projected portion inside the internal pipe. The projected portion widens the divided portion, and the divided portion holds the workpiece 200. In many cases, a hole is provided for a printed board or a printed circuit board used as the workpiece 200 as mentioned above. Even when no hole is provided, a hole can be relatively easy to provide on the workpiece 200 without affecting the design and the function.

In the above described manner, the two hands 16a and 16b can simultaneously hold different workpieces 200. In addition, one hand such as the hand 16a can hold the workpiece 200 and the other hand such as the hand 16b can seat the workpiece 200. While one hand such as the hand 16a grasps the workpiece 200 from any one of the processing facilities 40a through 40f, the other hand such as the hand 16b can seat the grasped workpiece 200 on the processing facility. It is thereby possible to shorten the time during which the processing facilities 40a through 40f are stopped.

The two hands 16a and 16b can be easily switched by rotating the base member 15 to rotate the hands 16a and 16b above the line along the transfer direction of the workpiece 200.

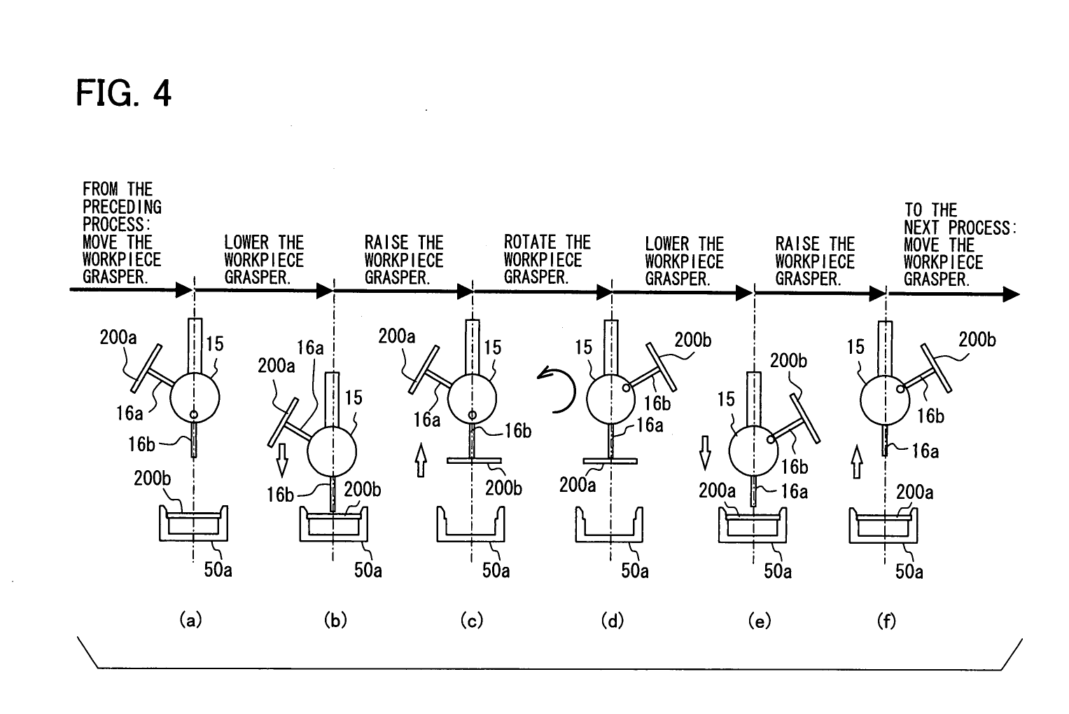

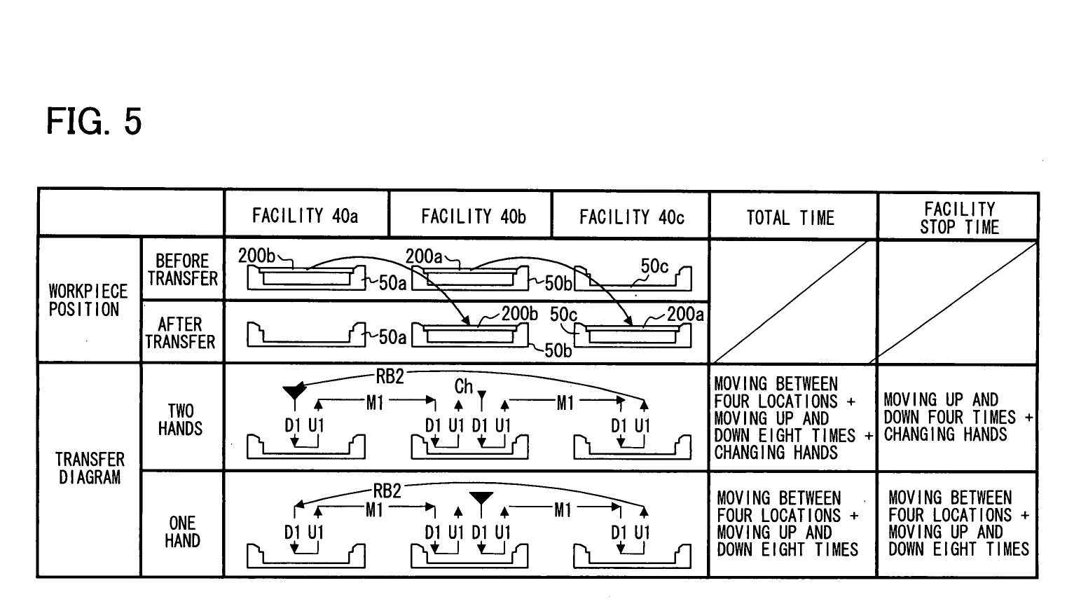

With reference to FIG. 4 and FIG. 5, a workpiece transfer process of the workpiece transfer apparatus with respect to a mounted workpiece such as the example shown in FIG. 3 where a workpiece 200b is mounted on a jig 50a provided for a processing facility 40a. It should be noted that the processing facility 40a must stop operating when replacing the workpiece 200b to be processed.

As shown at position (a) in FIG. 4, the workpiece transfer apparatus moves the workpiece grasper 10 to the processing facility 40a from the previous process. The workpiece grasper 10 uses one hand 16a to grasp the workpiece 200a.

As shown at position (b) in FIG. 4, the workpiece transfer apparatus uses the other hand 16b, which is not grasping the workpiece 200a, to grasp the workpiece 200b mounted on the jig 50a. The workpiece transfer apparatus lowers the hands 16a and 16b to approach the jig 50a and uses the hand 16b to grasp the workpiece 200b.

As shown at position (c) in FIG. 4, the workpiece transfer apparatus changes the hand 16b to the hand 16a so as to place the workpiece 200a grasped by the hand 16a on the jig 50a. The workpiece transfer apparatus raises the hands 16a and 16b to leave the jig 50a.

As shown at position (d) in FIG. 4, the workpiece transfer apparatus rotates the base member 15 to change the hands 16a and 16b. Before the hands 16a and 16b are changed, the jig 50a is positioned perpendicularly to the hand 16b. After the hands 16a and 16b are changed, the jig 50a is positioned perpendicularly to the hand 16a. The workpiece 200a grasped by the hand 16a can be mounted on the jig 50a.

As shown at position (e) in FIG. 4, the workpiece transfer apparatus mounts the workpiece 200a grasped by the hand 16a on the jig 50a. The workpiece transfer apparatus lowers the hands 16a and 16b for approaching the jig 50a.

As shown at position (f) in FIG. 4, the workpiece transfer apparatus places the workpiece 200a grasped by the hand 16a on the jig 50a for moving the workpiece grasper to the next process. The workpiece transfer apparatus raises the hands 16a and 16b to leave the jig 50a. The processing facility 40a is mounted with the jig 50a and is ready for process operations. The processing facility 40a stops process operations between (a) and (e) in FIG. 4.

The following compares the workpiece grasper 10 and the workpiece transfer apparatus in accordance with the present embodiment and a one-hand grasper and a workpiece transfer apparatus using the grasper. FIG. 5 shows an example of a production line using three processing facilities 40a, 40b, and 40c. In FIG. 5, a workpiece 200b is placed on the facility 40a. A workpiece 200a is placed on the facility 40b. A goal is to transfer the workpieces 200a and 200b and place the workpiece 200b on the facility 40b and the workpiece 200a on the facility 40c.

Considering a transfer diagram portion of FIG. 5, for the one-hand grasper and the workpiece transfer apparatus using the grasper, the grasper picks up the workpiece 200a from the facility 40b by lowering the hand, grasping the workpiece 200a, and raising the hand. The grasper moves the workpiece picked up from the facility 40b to the facility 40c and places the workpiece on the facility 40c. After placing the workpiece on the facility 40c, the grasper returns to the facility 40a, lowers the hand to grasp the workpiece 200b on the facility 40a, raises the hand, moves the workpiece to the facility 40b, and places the workpiece on the facility 40b. The facility 40b needs to stop processing in order to mount and dismount the workpieces 200a and 200b. The facility 40b stops processing while the grasper moves between four locations and moves up and down eight times.

Considering a transfer diagram for the workpiece grasper 10 and the workpiece transfer apparatus in accordance with the present embodiment, the workpiece transfer apparatus allows the hand 16a as the first one of the two to grasp the workpiece 200b from the facility 40a in accordance with a first process. The workpiece transfer apparatus moves the workpiece grasper 10 to the next processing facility 40b and allows a rotation mechanism 15a to change the hand 16a as the first hand to a hand 16b as a second hand for grasping the workpiece in accordance with a second process. The workpiece transfer apparatus allows the hand 16b to grasp the workpiece 200a from the facility 40b in accordance with a third process. After the third process, the workpiece transfer apparatus allows the rotation mechanism 15a to change the hand 16b to the hand 16a in accordance with a fourth process. After the fourth process, the workpiece transfer apparatus places the workpiece 200b grasped by the hand 16a on the facility 40b in accordance with a fifth process. After the fifth process, the workpiece transfer apparatus moves the workpiece grasper 10 to the next processing facility 40c and allows the hand 16a to grasp an workpiece (not shown) from the facility 40c in accordance with a sixth process. After the sixth process, the workpiece transfer apparatus allows the rotation mechanism 15a to change the hand 16a to the hand 16b in accordance with a seventh process. After the seventh process, the workpiece transfer apparatus places the workpiece 200a grasped by the hand 16b on the facility 40c in accordance with an eighth process.

In other words, the workpiece transfer apparatus allows the hand 16a to pick up the workpiece 200b from the facility 40a. The workpiece transfer apparatus moves the workpiece grasper 10 to the facility 40b and changes the hand. The workpiece transfer apparatus allows the other idle hand 16b to pick up the workpiece 200a from the facility 40b. The workpiece transfer apparatus then changes the hand and places the workpiece 200a grasped by the hand 16a on the facility 40b. The facility 40b is ready for operation. The time to stop the facility 40b is equivalent to the time to move the workpiece grasper 10 up and down four times and change the hand.

Compared to the workpiece transfer using the one-hand grasper, the workpiece transfer apparatus in accordance with the present embodiment can decrease necessary operations and shorten the time to stop the processing facility.

The workpiece transfer apparatus in accordance with the present embodiment can decrease the time to stop processing at the facility due to replacement of workpieces. The workpiece transfer apparatus can suppress an increase in the load time for the processing facilities 40a through 40f due to an increase in the time for replacing workpieces on the automatic transfer production line. In addition, one workpiece grasper 10 can transfer the workpiece 200 throughout the processing facilities 40a to 40f, making it possible to suppress the investment for the automatic transfer production line.

The following describes drive accuracy correction for the workpiece grasper 10 of the workpiece transfer apparatus.

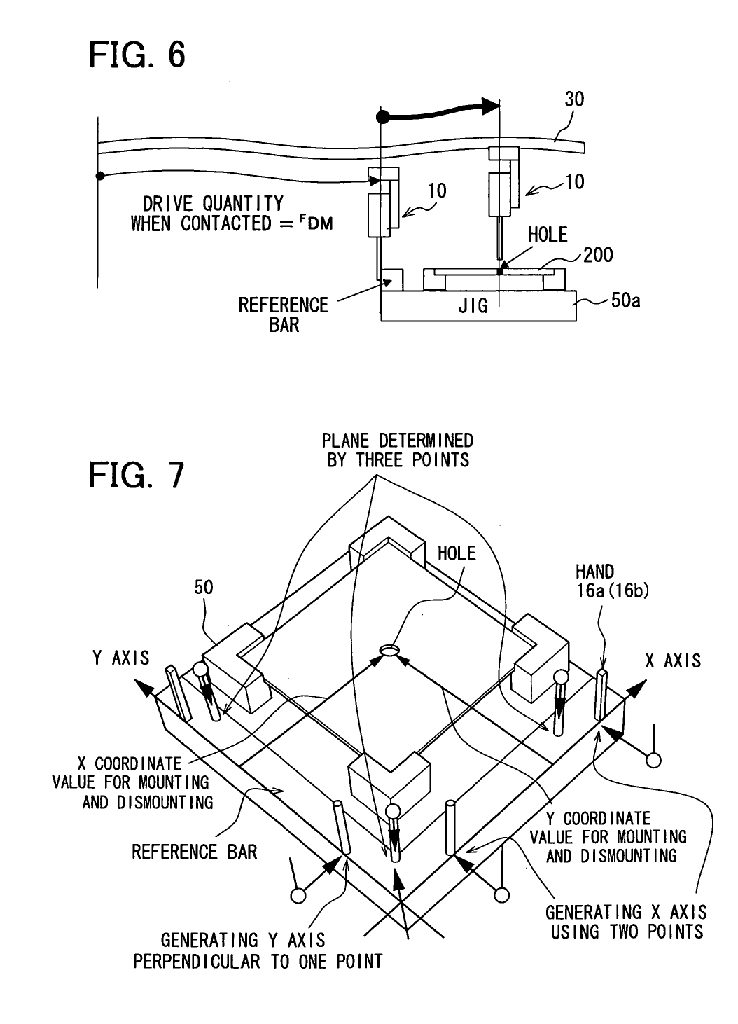

The workpiece grasper 10 can contact with the jig 50a such as a reference bar and accurately move to the end of the jig. The workpiece grasper 10 is hereafter also referred to as a robot. The workpiece grasper 10 may grasp the workpiece 200 by inserting the hands 16a and 16b provided for the workpiece grasper 10 into a hole in the workpiece 200. As shown in FIG. 6, the hands 16a and 16b must be accurately moved to the hole position in accordance with a move instruction value. The hands 16a and 16b are hereafter also referred to as a tool 16. As shown in FIG. 6, the workpiece grasper 10 needs to be accurately moved from the position in contact with the reference bar to the hole position provided for the workpiece 200. Assume that ^{F}DM to be a drive quantity when the workpiece grasper 10 contacts with the reference bar. The measurement and calibration of movement accuracy in accordance with the present embodiment is based on previous measurement of accuracy of movement ranging from the position of the workpiece grasper 10 in contact with the reference bar to the hole position provided for the workpiece 200.

As shown in FIG. 7, the workpiece transfer apparatus for the production line 100 in accordance with the present embodiment detects a jig position by contact to establish the coordinate system for the reference bar as the jig 50 to be used actually. The workpiece transfer apparatus moves the workpiece grasper from the coordinate system to the hole position of the workpiece 200 and positions the tip of the tool 16 to the hole of the workpiece 200.

Absolute accuracy is required for traveling a distance precisely the same as the specified dimension in terms of X and Y coordinate values for mounting and dismounting. However, an ordinary robot system ensures only the repetition accuracy, not the absolute accuracy.

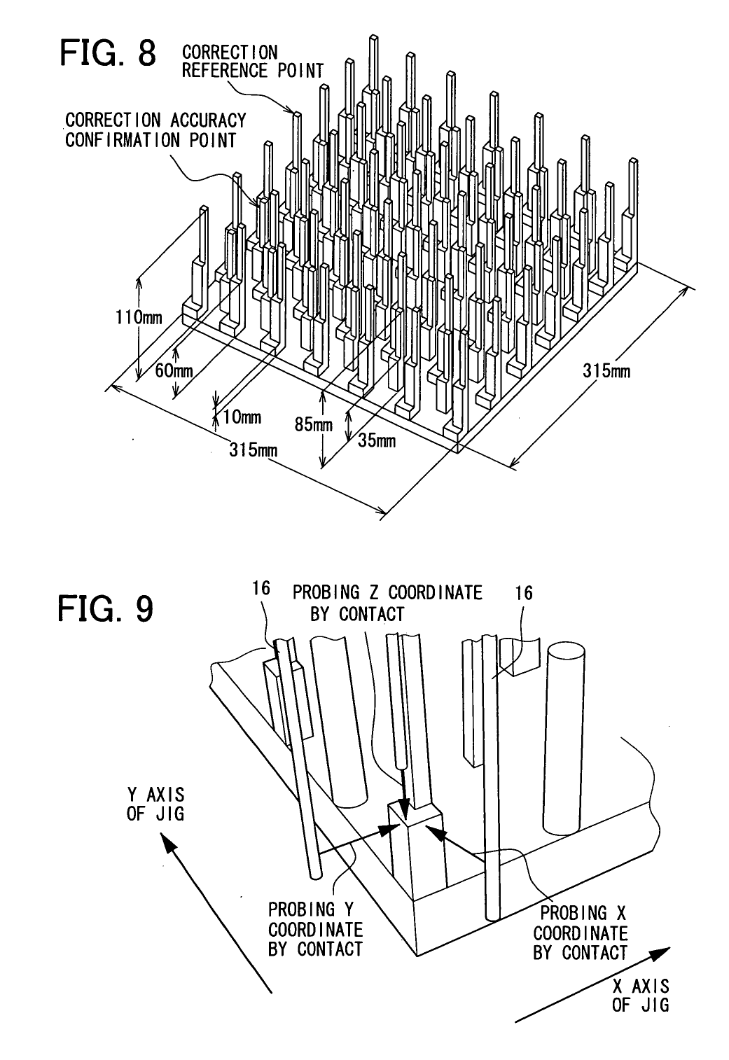

To provide absolute accuracy, a jig as shown in FIG. 8 is used to measure and calibrate the absolute accuracy. The jig is provided with a rectangular metal column having a corner positioned to a specified grid point. The corners are provided at three levels such as 10, 60, and 100 mm, for example. The tool 16 is attached to the corners as shown in FIG. 9 to read X, Y, and Z drive values of the workpiece grasper 10 at a given time. Making contact with the jig acquires X, Y, and Z drive values of the workpiece grasper 10 at each grid point in an area of 300×300×100 h.

A true coordinate at each grid point is measured when the jig is complete. The X, Y, and Z drive values for contacting the tool 16 with the coordinate are found as mentioned above. Both values can be used to generate a correction map for acquiring X, Y, and Z drive values to be positioned to a specific coordinate value.

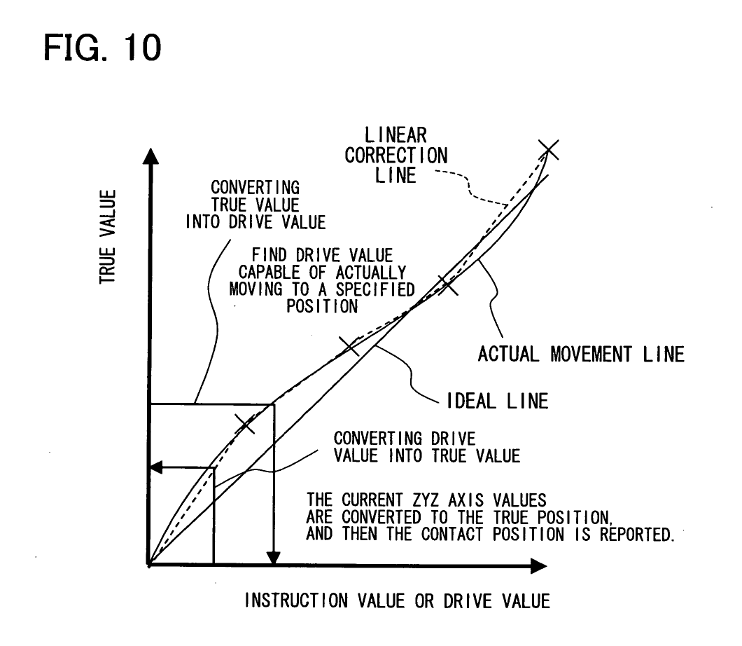

FIG. 10 provides a one-dimensional representation of a correction equation or a correction map using a true value axis and a drive value axis. The coordinate conversion using the correction map includes true value to drive value conversion and drive value to true value conversion. The true value to drive value conversion converts a true value to a drive value when receiving an instruction to move to a given position in a three-dimensional space. By contrast, the drive value to true value conversion converts a drive value to a true value when a contact is made to the jig.

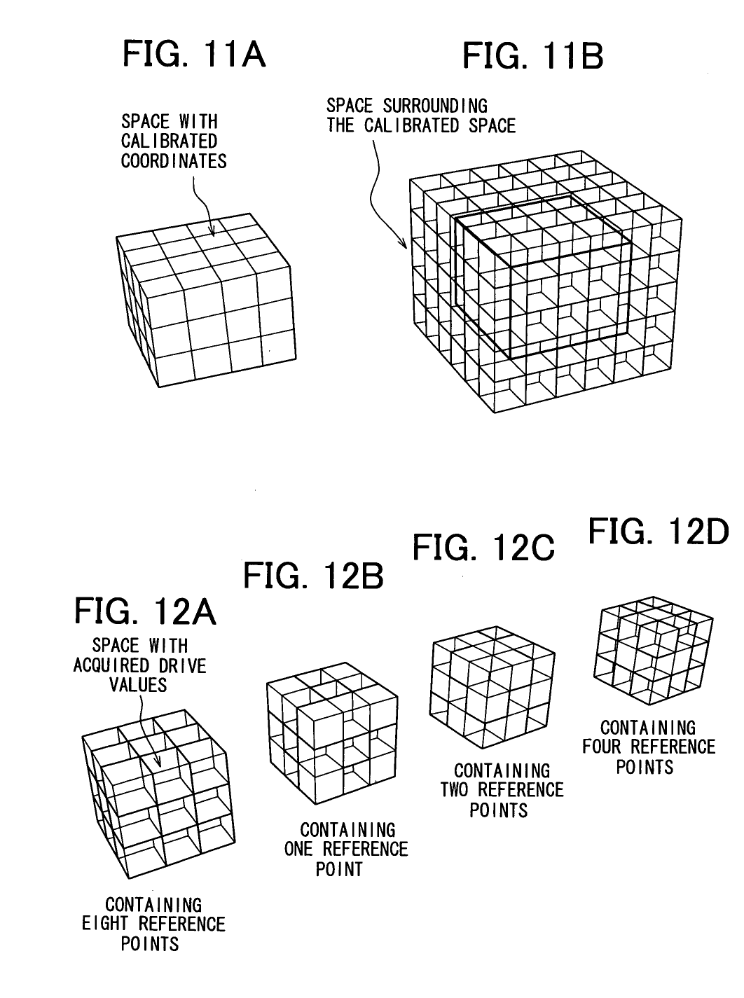

As shown in FIG. 11, a space surrounded by grid points and another space surrounding that space are assumed when the one-dimensional correction is extended to a three-dimensional correction.

The space in FIG. 11 is categorized as shown in FIG. 12A through FIG. 12D in accordance with the number of grid points or reference points usable for the calibration. The calibration method depends on the number of grid points that can be referenced. The description below corresponds to the number of grid points that can be referenced. FIG. 11 is a schematic diagram illustrating a space with calibrated coordinates and a space around that space.

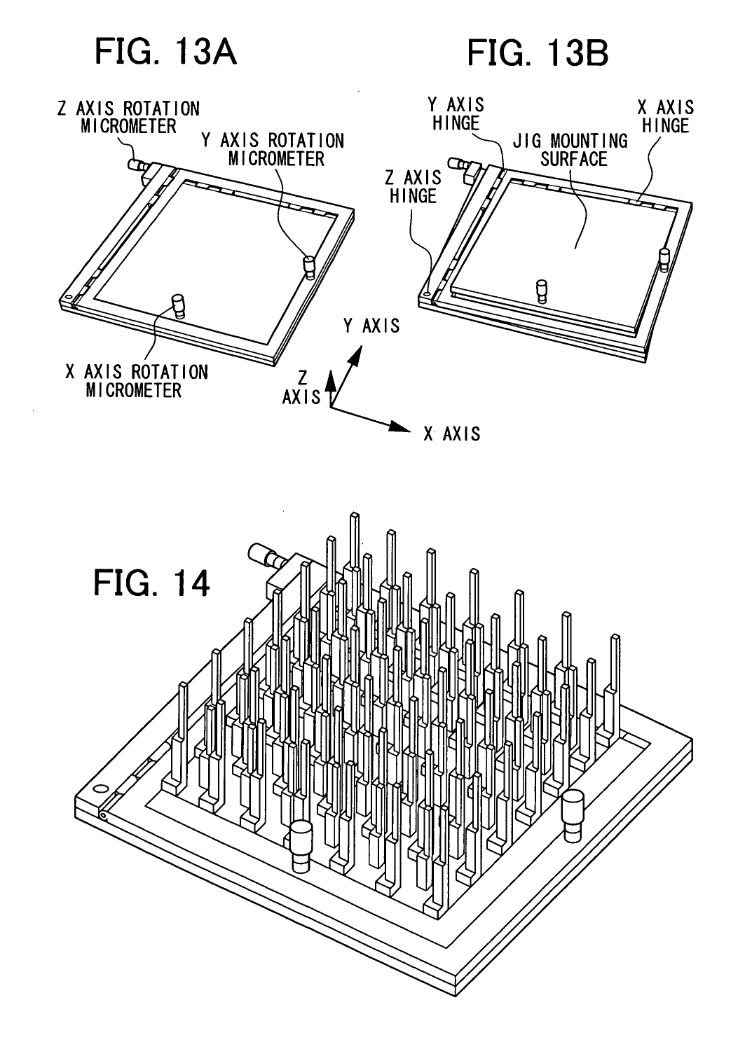

The mechanism and installation of the measurement jig will be described. The measurement jig has an adjustment mechanism as shown in FIGS. 13A and 13B so as to be parallel to and level with the rail 30. FIG. 13B shows a jig mounting surface moved by rotating rotation adjustment micrometers.

FIG. 14 is a schematic diagram illustrating the measurement jig mounted with correction bars. The mechanism is used to set the jig as follows. First, the rotation adjustment micrometer around the Z axis is moved so that Y values for the X axis measured on the rail are adjusted to the same value at the left and right ends of the jig. Then, the rotation adjustment micrometer around the Y axis is moved so as to level the jig in the horizontal direction or the X-axis direction. A level is used to measure the horizontal alignment. Finally, the rotation adjustment micrometer around the X axis is moved so as to level the jig in the depth direction or the Y-axis direction. A level is used to measure the horizontal alignment.

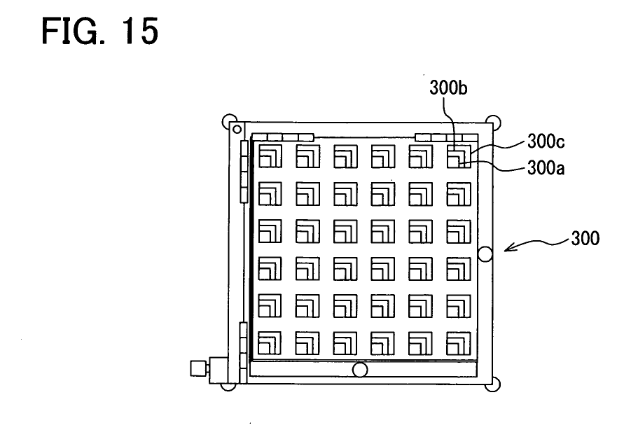

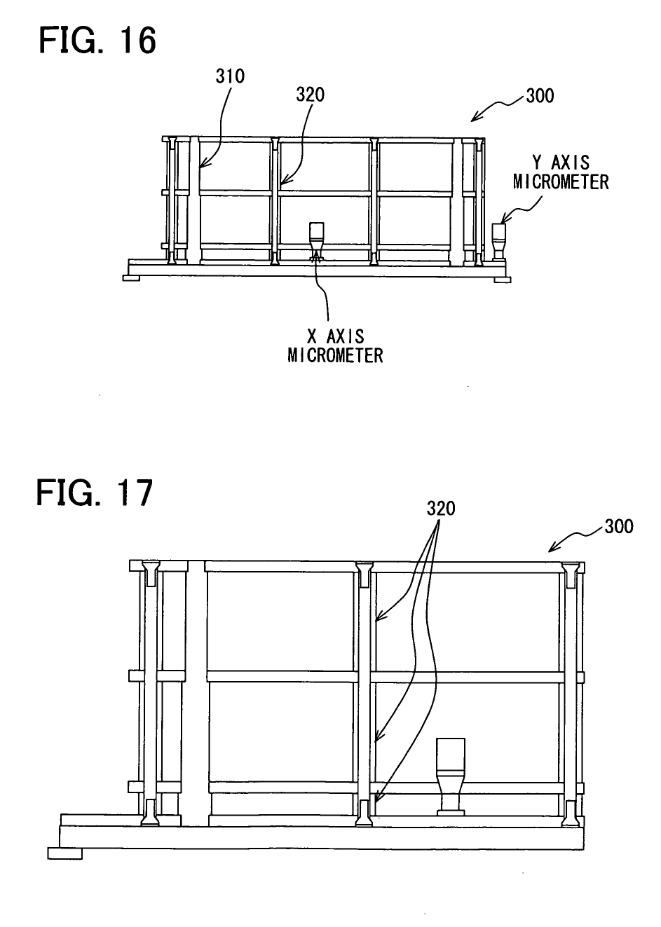

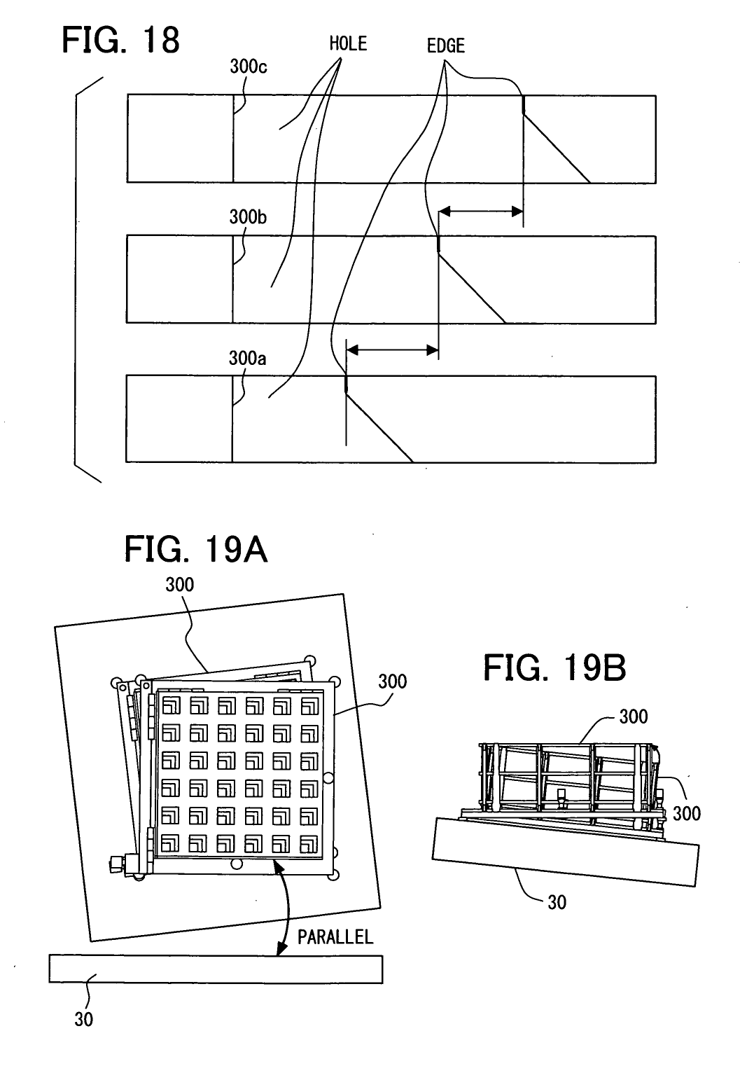

The actual jig is provided with grid points using square holes 300a through 300c in three-layer plates instead of providing the reference points using the above-described projections. FIG. 15 shows a plan view of a jig 300. FIG. 16 shows a sectional view of the jig 300. Reference numeral 320 denotes a shaft with a collar. As shown in FIG. 17, for example, a 45 mm collar is placed between measurement plates and is tightened from the top. Reference numeral 310 denotes a stepped shaft for positioning. As shown in FIG. 18, the square holes 300a through 300c in the three-layer plate are shifted between the three layers. Each hole is edged.

The jig 300 is aligned as follows. The micrometer attached to the jig 300 is moved so that the jig 300 parallels the rail and is perpendicular to the gravitational line. That is, the jig 300 is adjusted so as to be parallel with the rail as shown in FIG. 19A and horizontal as shown in FIG. 19B.

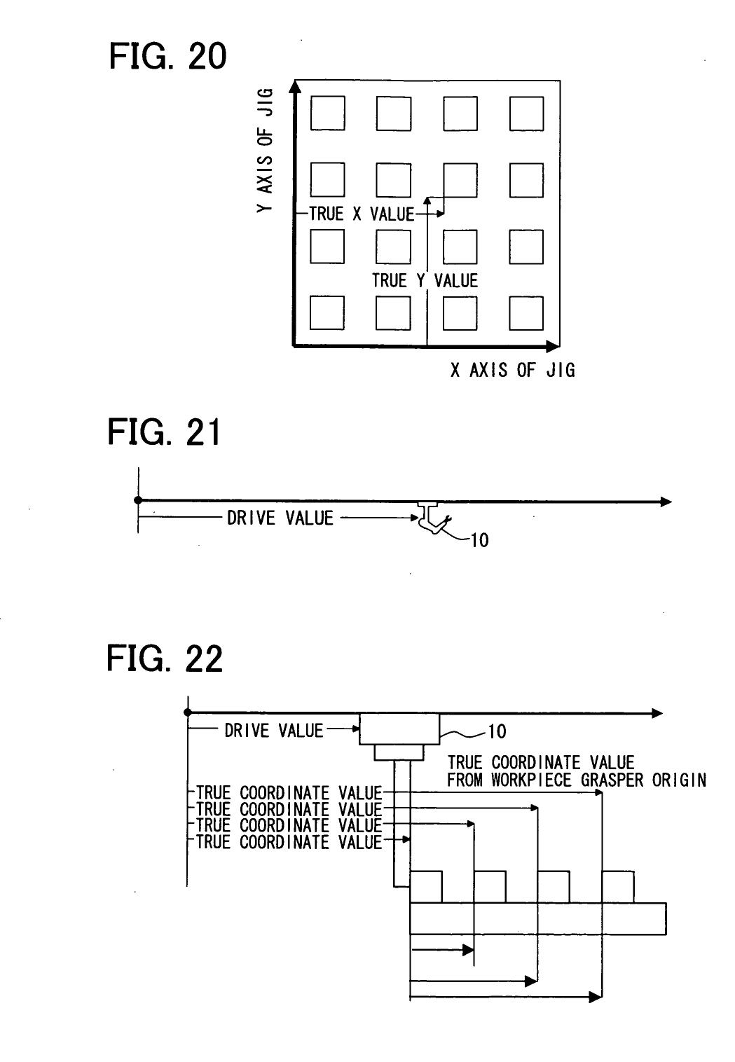

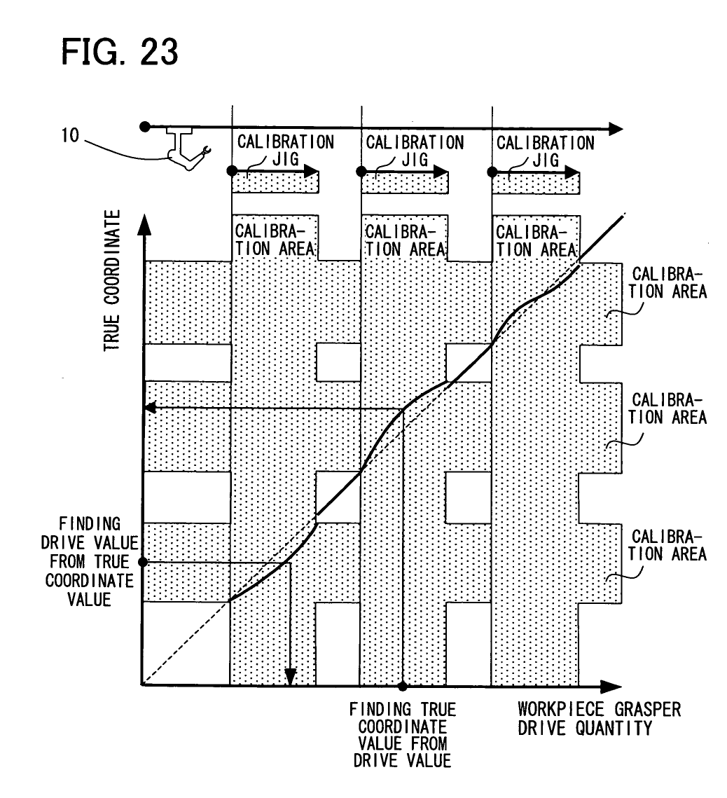

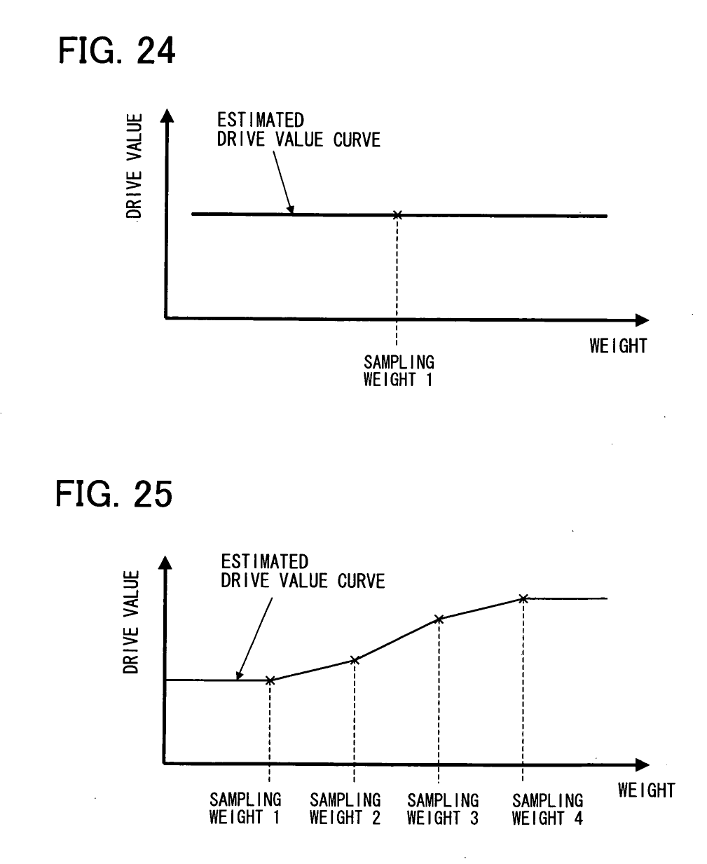

As shown in FIG. 20 and FIG. 21, a true value or a true coordinate value for a measure point on the jig is measured from the coordinate system for the jig. A drive value indicates a distance from the drive origin. Both absolutely differ from each other. The workpiece transfer apparatus performs the following to be able to convert the true value into the drive value and vice versa by positionally associating both with each other. The workpiece transfer apparatus detects the origin or the position corresponding to coordinate 0 for the absolute accuracy calibration jig. The workpiece transfer apparatus assumes a drive value detecting the origin to be a true value. The workpiece transfer apparatus finds the true coordinate value for the grid point on the jig from the origin by adding the drive value for the origin to the grid point measurement. FIG. 22 shows a one-dimensional representation of the relation. FIG. 23 shows a representation of multiple calibration jigs on the rail 30.

The correction method includes weight correction and travel correction. The weight correction is used for a deflection position error due to a weight. The travel correction is used for a position error occurring when the X, Y, and Z axes travel a certain distance along a rail that is not straight or is inaccurately perpendicular.

The weight correction depends on the rigidity of the XYZ robot against a transfer weight. The weight correction is unnecessary when the full rigidity is ensured. When the full rigidity is unavailable, it is necessary to sample and interpolate several weights in contact with grid points. The weight signifies a total weight of the workpiece grasper 10. The table is used to estimate a drive value for a given weight as follows.

Assume that Xedw, Yedw, and Zedw to be estimated drive values for weight W. Assume that Xedl, Yedl, and Zedl to be drive quantities at that time for weight WL that is lighter than and most approximate to the weight W. Assume that Xedh, Yedh, and Zedh to be drive quantities at that time for weight WH that is heavier than and most approximate to the weight W. Then, the weight W can be estimated given the specified drive values Xedw, Yedw, and Zedw as follows (EQ 1).

$$\vert \begin{matrix}Xedw \\ Yedw \\ Zedw\end{matrix} \vert = \frac{( W - WL ) \vert \begin{matrix}Xdwh \\ Ydwh \\ Zdwh\end{matrix} \vert + ( WH - W ) \vert \begin{matrix}Xdwl \\ Ydwl \\ Zdwl\end{matrix} \vert}{WH - WL} \qquad ( EQ 1 )$$

For the weight to be estimated, all sampled weights may be lower or upper ones instead of two corresponding to the lower and upper sides. The drive value for the most approximate weight is used as an estimated value. When the above described technique is used for one sampling weight, the drive value at that time is to be used for the entire weight.

There are four travel corrections depending on whether the number of reference points is one, two, four, or eight.

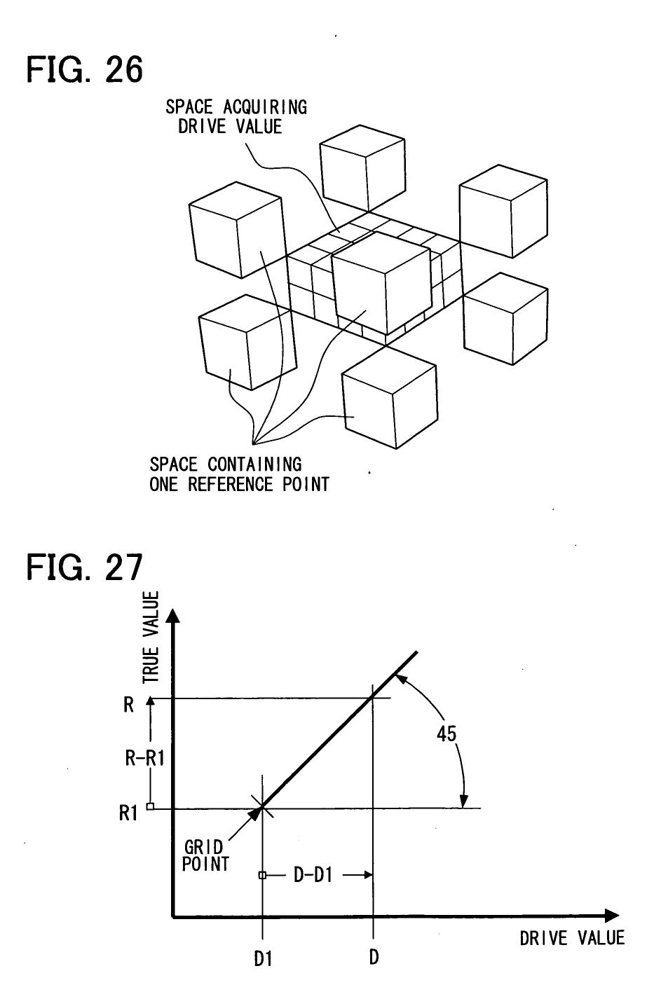

The following describes the travel correction for one reference point. As shown in FIG. 26, there are eight spaces each having only one reference point corresponding to corners of the space where the drive value is acquired. FIG. 27 shows a relation between the true value and the drive value. The conversion between the drive value and the true value is described below.

The true value to drive value conversion is D=D1+(R−R1)=D1+R−R1=R−(R1−D1). The drive value to true value conversion is R=R1+(D−D1) =R1+D−D1=D+(R1−D1).

The equations are three-dimensionally expanded for the conversion between the true value and the drive value as follows. Assume that Xjr, Yjr, and Zjr to be prior jig measurements at the reference point or the grid point. Assume that Xd, Yd, and Zd to be drive values in contact with the reference point or the grid point. The following shows calculation of Err1 (EQ 2), target position to drive value conversion (EQ 3) and drive value to true position conversion (EQ 4).

$$\begin{matrix}Err 1 = \vert \begin{matrix}Xjr \\ Yjr \\ Zjr\end{matrix} \vert - \vert \begin{matrix}Xdr \\ Ydr \\ Zdr\end{matrix} \vert = \vert \begin{matrix}Xjr - Xdr \\ Yjr - Ydr \\ Zjr - Zdr\end{matrix} \vert & ( EQ 2 ) \\ \vert \begin{matrix}Xd \\ Yd \\ Zd\end{matrix} \vert = \vert \begin{matrix}Zt \\ Yt \\ Zt\end{matrix} \vert - \vert \begin{matrix}Xjr - Xdr \\ Yjr - Ydr \\ Zjr - Zdr\end{matrix} \vert = \vert \begin{matrix}Xt - Xjr + Xdr \\ Yt - Yjr + Ydr \\ Zt - Zjr + Zdr\end{matrix} \vert & ( EQ 3 ) \\ \vert \begin{matrix}Xt \\ Yt \\ Zt\end{matrix} \vert = \vert \begin{matrix}Zd \\ Yd \\ Zd\end{matrix} \vert + \vert \begin{matrix}Xjr - Xdr \\ Yjr - Ydr \\ Zjr - Zdr\end{matrix} \vert = \vert \begin{matrix}Xd + Xjr - Xdr \\ Yd + Yjr - Ydr \\ Zd + Zjr - Zdr\end{matrix} \vert & ( EQ 4 )\end{matrix}$$

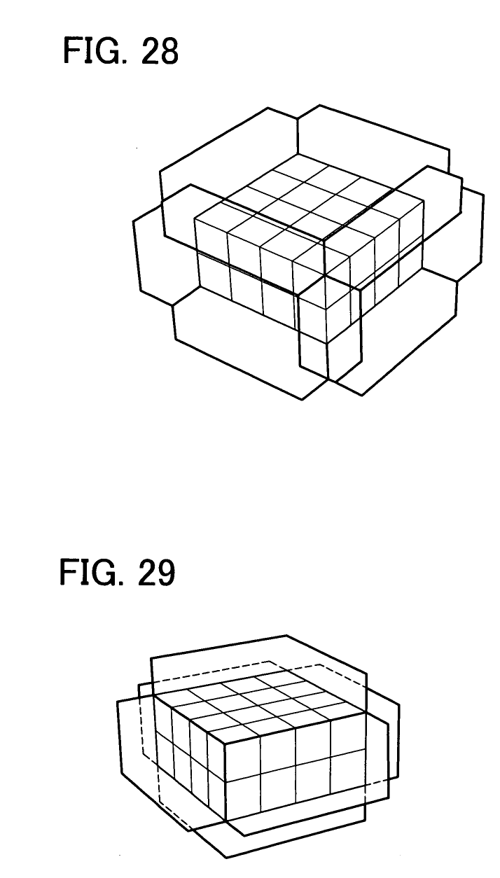

The following describes the travel correction for two reference points. As shown in FIG. 28, there are 12 correction-targeted spaces each having two reference points around a measured grid solid. The correction-targeted space has two reference points along any of the X, Y, and Z axes. A value for a given point between the two points is estimated by internally dividing a difference between the two points by a distance from the estimated point to the grid point for the two points. The correction is performed as follows.

Assume that Xjr1, Yjr1, and Zjr1 to be prior jig measurements for reference point 1 or grid point 1. Assume that Xdr1, Ydr1, and Zdr1 to be drive values in contact with reference point 1 or grid point 1. Assume that Xjr2, Yjr2, and Zjr2 to be prior jig measurements for reference point 2 or grid point 2. Assume that Xdr2, Ydr2, and Zdr2 to be drive values in contact with reference point 2 or grid point 2. Assume that Xt, Yt, and Zt to be targeted positions. Assume that Xd, Yd, and Zd to be drive values corresponding to the targeted positions.

$$\begin{matrix}Err 1 = \vert \begin{matrix}Xjr 1 \\ Yjr 1 \\ Zjr 1\end{matrix} \vert - \vert \begin{matrix}Xdr 1 \\ Ydr 1 \\ Zdr 1\end{matrix} \vert = \vert \begin{matrix}Xjr 1 - Xdr 1 \\ Yjr 1 - Ydr 1 \\ Zjr 1 - Zdr 1\end{matrix} \vert & ( EQ 5 ) \\ Err 2 = \vert \begin{matrix}Xjr 2 \\ Yjr 2 \\ Zjr 2\end{matrix} \vert - \vert \begin{matrix}Xdr 2 \\ Ydr 2 \\ Zdr 2\end{matrix} \vert = \vert \begin{matrix}Xjr 2 - Xdr 2 \\ Yjr 2 - Ydr 2 \\ Zjr 2 - Zdr 2\end{matrix} \vert & ( EQ 6 )\end{matrix}$$

Using Err1 and Err2 (EQ 5, EQ 6) the target position to drive value conversion (EQ 7) and the drive value to true position conversion (EQ 8) when two reference points exist in the X-axis direction can be expressed as follows.

$$\begin{matrix}\begin{matrix}\vert \begin{matrix}Xd \\ Yd \\ Zd\end{matrix} \vert = \vert \begin{matrix}Xt \\ Yt \\ Zt\end{matrix} \vert - \frac{( Xt - Xjr 1 ) Err 2 + ( Xjr 2 - Xt ) Err 1}{Xjr 2 - Xjr 1} \\ = \vert \begin{matrix}Xt \\ Yt \\ Zt\end{matrix} \vert - \frac{\begin{matrix}( Xt - Xjr 1 ) \vert \begin{matrix}Xjr 2 - Xdr 2 \\ Yjr 2 - Ydr 2 \\ Zjr 2 - Zdr 2\end{matrix} \vert + \\ ( Xjr 2 - Xt ) \vert \begin{matrix}Xjr 1 - Xdr 1 \\ Yjr 1 - Ydr 1 \\ Zjr 1 - Zdr 1\end{matrix} \vert\end{matrix}}{Xjr 2 - Xjr 1}\end{matrix} & ( EQ 7 ) \\ \begin{matrix}\vert \begin{matrix}Xt \\ Yt \\ Zt\end{matrix} \vert = \vert \begin{matrix}Xd \\ Yd \\ Zd\end{matrix} \vert + \frac{( Xd - Xdr 1 ) Err 2 + ( Xdr 2 - Xd ) Err 1}{Xdr 2 - Xdr 1} \\ = \vert \begin{matrix}Xd \\ Yd \\ Zd\end{matrix} \vert + \frac{\begin{matrix}( Xd - Xdr 1 ) \vert \begin{matrix}Xjr 2 - Xdr 2 \\ Yjr 2 - Ydr 2 \\ Zjr 2 - Zdr 2\end{matrix} \vert + \\ ( Xdr 2 - Xd ) \vert \begin{matrix}Xjr 1 - Xdr 1 \\ Yjr 1 - Ydr 1 \\ Zjr 1 - Zdr 1\end{matrix} \vert\end{matrix}}{Xdr 2 - Xdr 1}\end{matrix} & ( EQ 8 )\end{matrix}$$

Target position to drive value conversion and drive value to true position conversion can be expressed as follows (EQ 9, EQ 10) when two reference points exist in the Y-axis direction.

$$\begin{matrix}\begin{matrix}\vert \begin{matrix}Xd \\ Yd \\ Zd\end{matrix} \vert = \vert \begin{matrix}Xt \\ Yt \\ Zt\end{matrix} \vert - \frac{( Zt - Zjr 1 ) Err 2 + ( Zjr 2 - Zt ) Err 1}{Zjr 2 - Zjr 1} \\ = \vert \begin{matrix}Xt \\ Yt \\ Zt\end{matrix} \vert - \frac{\begin{matrix}( Zt - Zjr 1 ) \vert \begin{matrix}Xjr 2 - Xdr 2 \\ Yjr 2 - Ydr 2 \\ Zjr 2 - Zdr 2\end{matrix} \vert + \\ ( Zjr 2 - Zt ) \vert \begin{matrix}Xjr 1 - Xdr 1 \\ Yjr 1 - Ydr 1 \\ Zjr 1 - Zdr 1\end{matrix} \vert\end{matrix}}{Zjr 2 - Zjr 1}\end{matrix} & ( EQ 11 ) \\ \begin{matrix}\vert \begin{matrix}Xt \\ Yt \\ Zt\end{matrix} \vert = \vert \begin{matrix}Xd \\ Yd \\ Zd\end{matrix} \vert + \frac{( Zd - Zdr 1 ) Err 2 + ( Zdr 2 - Zd ) Err 1}{Zdr 2 - Zdr 1} \\ = \vert \begin{matrix}Xd \\ Yd \\ Zd\end{matrix} \vert + \frac{\begin{matrix}( Zd - Zdr 1 ) \vert \begin{matrix}Xjr 2 - Xdr 2 \\ Yjr 2 - Ydr 2 \\ Zjr 2 - Zdr 2\end{matrix} \vert + \\ ( Zdr 2 - Zd ) \vert \begin{matrix}Xjr 1 - Xdr 1 \\ Yjr 1 - Ydr 1 \\ Zjr 1 - Zdr 1\end{matrix} \vert\end{matrix}}{Zdr 2 - Zdr 1}\end{matrix} & ( EQ 12 )\end{matrix}$$

The following shows equation 11 for target position to drive value conversion and equation 12 for drive value to true position conversion when two reference points exist in the Z-axis direction.

$$\begin{matrix}\begin{matrix}\vert \begin{matrix}Xd \\ Yd \\ Zd\end{matrix} \vert = \vert \begin{matrix}Xt \\ Yt \\ Zt\end{matrix} \vert - \frac{( Yt - Yjr 1 ) Err 2 + ( Yjr 2 - Yt ) Err 1}{Yjr 2 - Yjr 1} \\ = \vert \begin{matrix}Xt \\ Yt \\ Zt\end{matrix} \vert - \frac{\begin{matrix}( Yt - Yjr 1 ) \vert \begin{matrix}Xjr 2 - Xdr 2 \\ Yjr 2 - Ydr 2 \\ Zjr 2 - Zdr 2\end{matrix} \vert + \\ ( Yjr 2 - Yt ) \vert \begin{matrix}Xjr 1 - Xdr 1 \\ Yjr 1 - Ydr 1 \\ Zjr 1 - Zdr 1\end{matrix} \vert\end{matrix}}{Yjr 2 - Yjr 1}\end{matrix} & ( EQ 9 ) \\ \begin{matrix}\vert \begin{matrix}Xt \\ Yt \\ Zt\end{matrix} \vert = \vert \begin{matrix}Xd \\ Yd \\ Zd\end{matrix} \vert + \frac{( Yd - Ydr 1 ) Err 2 + ( Ydr 2 - Yd ) Err 1}{Ydr 2 - Ydr 1} \\ = \vert \begin{matrix}Xd \\ Yd \\ Zd\end{matrix} \vert + \frac{\begin{matrix}( Yd - Ydr 1 ) \vert \begin{matrix}Xjr 2 - Xdr 2 \\ Yjr 2 - Ydr 2 \\ Zjr 2 - Zdr 2\end{matrix} \vert + \\ ( Ydr 2 - Yd ) \vert \begin{matrix}Xjr 1 - Xdr 1 \\ Yjr 1 - Ydr 1 \\ Zjr 1 - Zdr 1\end{matrix} \vert\end{matrix}}{Ydr 2 - Ydr 1}\end{matrix} & ( EQ 10 )\end{matrix}$$

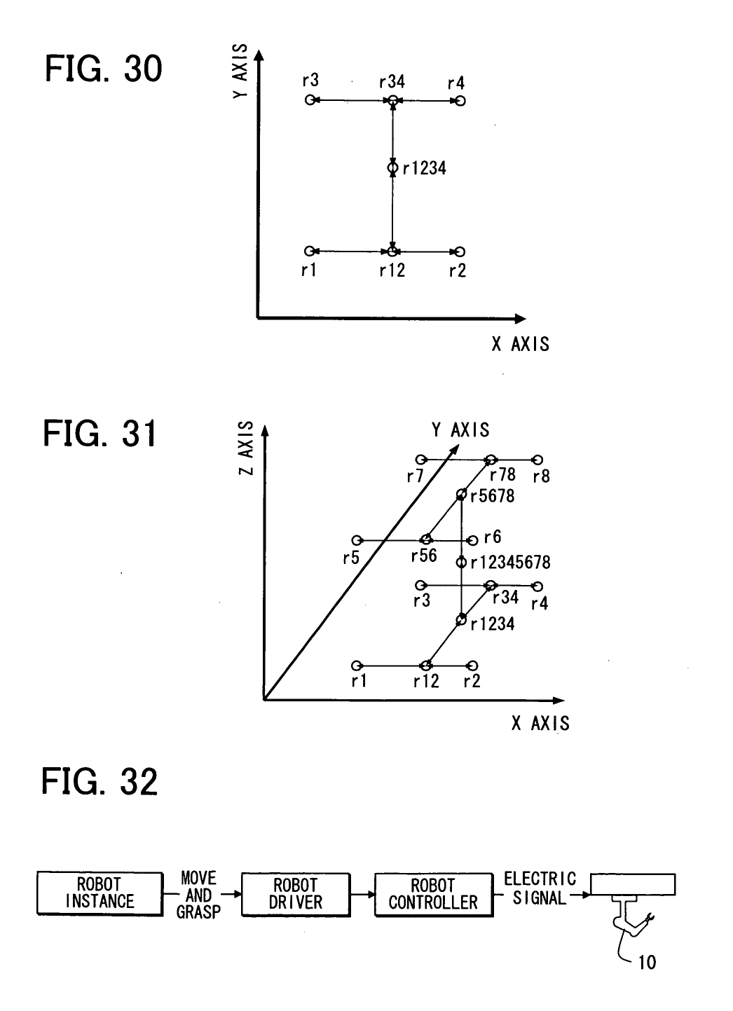

The following describes the travel correction for four reference points. As shown in FIG. 29, there are six correction-targeted spaces each having four reference points around a measured grid solid. The correction-targeted space contains four reference points on an XY, YZ, or XZ plane. For example, four points on the XY plane are used to describe the correction of the space. When four reference points are available, the above-described correction using two reference points are performed twice in the X and Y directions, as shown in FIG. 30.

The two points are corrected in the X-axis direction to find an r12 coordinate and Err1 and Err2 from r1 and r2 (EQ 13, EQ 14). The two points are corrected in the X-axis direction to find an r34 coordinate and Err3 and Err4 from r3 and r4 (EQ 15, EQ 16). The two points are corrected in the Y-axis direction to find an r1234 coordinate and Err12 from r12 and r34. Assume that Xjr1, Yjr1, and Zjr1 to be prior jig measurements for reference point 1 or grid point 1. Assume that Xdr1, Ydr1, and Zdr1 to be drive values in contact with reference point 1 or grid point 1. Assume that Xjr2, Yjr2, and Zjr2 to be prior jig measurements for reference point 2 or grid point 2. Assume that Xdr2, Ydr2, and Zdr2 to be drive values in contact with reference point 2 or grid point 2. Assume that Xjr3, Yjr3, and Zjr3 to be prior jig measurements for reference point 3 or grid point 3. Assume that Xdr3, Ydr3, and Zdr3 to be drive values in contact with reference point 3 or grid point 3. Assume that Xjr4, Yjr4, and Zjr4 to be prior jig measurements for reference point 4 or grid point 4. Assume that Xdr4, Ydr4, and Zdr4 to be drive values in contact with reference point 4 or grid point 4. Assume that Xt, Yt, and Zt to be targeted positions. Assume that Xd, Yd, and Zd to be drive values corresponding to the targeted positions.

$$\begin{matrix}Err 1 = \vert \begin{matrix}Xjr 1 \\ Yjr 1 \\ Zjr 1\end{matrix} \vert - \vert \begin{matrix}Xdr 1 \\ Ydr 1 \\ Zdr 1\end{matrix} \vert = \vert \begin{matrix}Xjr 1 - Xdr 1 \\ Yjr 1 - Ydr 1 \\ Zjr 1 - Zdr 1\end{matrix} \vert & ( EQ 13 ) \\ Err 2 = \vert \begin{matrix}Xjr 2 \\ Yjr 2 \\ Zjr 2\end{matrix} \vert - \vert \begin{matrix}Xdr 2 \\ Ydr 2 \\ Zdr 2\end{matrix} \vert = \vert \begin{matrix}Xjr 2 - Xdr 2 \\ Yjr 2 - Ydr 2 \\ Zjr 2 - Zdr 2\end{matrix} \vert & ( EQ 14 ) \\ Err 3 = \vert \begin{matrix}Xjr 3 \\ Yjr 3 \\ Zjr 3\end{matrix} \vert - \vert \begin{matrix}Xdr 3 \\ Ydr 3 \\ Zdr 3\end{matrix} \vert = \vert \begin{matrix}Xjr 3 - Xdr 3 \\ Yjr 3 - Ydr 3 \\ Zjr 3 - Zdr 3\end{matrix} \vert & ( EQ 15 ) \\ Err 4 = \vert \begin{matrix}Xjr 4 \\ Yjr 4 \\ Zjr 4\end{matrix} \vert - \vert \begin{matrix}Xdr 4 \\ Ydr 4 \\ Zdr 4\end{matrix} \vert = \vert \begin{matrix}Xjr 4 - Xdr 4 \\ Yjr 4 - Ydr 4 \\ Zjr 4 - Zdr 4\end{matrix} \vert & ( EQ 16 )\end{matrix}$$

The two points are corrected in the X-axis direction to find an r12 coordinate and Err from r1 and r2. Assume that Err12 to be an estimated error at the r12 point (EQ 17) represented below in standard and three-dimensional form.

$$Err 12 = \frac{( Xt - Xjr 1 ) Err 2 + ( Xjr 2 - Xt ) Err 1}{Xjr 2 - Xjr 1} \\ \vert \begin{matrix}Xerr 12 \\ Yerr 12 \\ Zerr 12\end{matrix} \vert = \frac{\begin{matrix}( Xt - Xjr 1 ) \vert \begin{matrix}Xjr 2 - Xdr 2 \\ Yjr 2 - Ydr2 \\ Zjr 2 - Zdr 2\end{matrix} \vert + \\ ( Xjr 2 - Xt ) \vert \begin{matrix}Xjr 1 - Xdr 1 \\ Yjr 1 - Ydr 1 \\ Zjr 1 - Zdr 1\end{matrix} \vert\end{matrix}}{Xjr 2 - Xjr 1} \qquad ( EQ 17 )$$

Assume that t12 to be an estimated true value at the r12 point (EQ 18).

$$t 12 = \vert \begin{matrix}Xt 12 \\ Xt 12 \\ Zt 12\end{matrix} \vert = \frac{( Xt - Xjr 1 ) \vert \begin{matrix}Xjr 2 \\ Yjr 2 \\ Zjr 2\end{matrix} \vert + ( Xjr 2 - Xt ) \vert \begin{matrix}Xjr 1 \\ Yjr 1 \\ Zjr 1\end{matrix} \vert}{Xjr 2 - Xjr 1} \qquad ( EQ 18 )$$

Assume that d12 to be an estimated drive quantity at the r12 point (EQ 19).

$$d 12 = \vert \begin{matrix}Xd 12 \\ Xd 12 \\ Zd 12\end{matrix} \vert = \frac{( Xt - Xjr 1 ) \vert \begin{matrix}Xdr 2 \\ Ydr 2 \\ Zdr 2\end{matrix} \vert + ( Xjr 2 - Xt ) \vert \begin{matrix}Xdr 1 \\ Ydr 1 \\ Zdr 1\end{matrix} \vert}{Xjr 2 - Xjr 1} \qquad ( EQ 19 )$$

The two points are corrected in the X-axis direction to find an r34 coordinate and Err from r3 and r4 (EQ 20). Assume that Err34 to be an estimated error at the r34 point.

$$Err 34 = \frac{( Xt - Xjr 3 ) Err 4 + ( Xjr 4 - Xt ) Err 3}{Xjr 4 - Xjr 3} \\ \vert \begin{matrix}Xerr 34 \\ Yerr 34 \\ Zerr 34\end{matrix} \vert = \frac{\begin{matrix}( Xt - Xjr 3 ) \vert \begin{matrix}Xjr 4 - Xdr 4 \\ Yjr 4 - Ydr 4 \\ Zjr 4 - Zdr 4\end{matrix} \vert + \\ ( Xjr 4 - Xt ) \vert \begin{matrix}Xjr 3 - Xdr 3 \\ Yjr 3 - Ydr 3 \\ Zjr 3 - Zdr 3\end{matrix} \vert\end{matrix}}{Xjr 4 - Xjr 3} \qquad ( EQ 20 )$$

Assume that t34 to be an estimated true value at the r34 point (EQ 21).

$$t 34 = \vert \begin{matrix}Xt 34 \\ Yt 34 \\ Zt 34\end{matrix} \vert = \frac{( Xt - Xjr 3 ) \vert \begin{matrix}Xjr 4 \\ Yjr 4 \\ Zjr 4\end{matrix} \vert + ( Xjr 4 - Xt ) \vert \begin{matrix}Xjr 3 \\ Yjr 3 \\ Zjr 3\end{matrix} \vert}{Xjr 4 - Xjr 3} \qquad ( EQ 21 )$$

Assume that d34 to be an estimated drive quantity at the r34 point (EQ 22).

$$d 34 = \vert \begin{matrix}Xd 34 \\ Yd 34 \\ Zd 34\end{matrix} \vert = \frac{( Xt - Xjr 3 ) \vert \begin{matrix}Xdr 4 \\ Ydr 4 \\ Zdr 4\end{matrix} \vert + ( Xjr 4 - Xt ) \vert \begin{matrix}Xdr 3 \\ Ydr 3 \\ Zdr 3\end{matrix} \vert}{Xjr 4 - Xjr 3} \qquad ( EQ 22 )$$

The two points are corrected in the X-axis direction to find an r1234 coordinate and Err from r12 and r34. The target position is converted to the drive value as follows (EQ 23).

$$\vert \begin{matrix}Xd \\ Yd \\ Zd\end{matrix} \vert = \vert \begin{matrix}Xt \\ Yt \\ Zt\end{matrix} \vert - \frac{( Yt - Yt 12 ) Err 34 + ( Yt 34 - Yt ) Err 12}{Yt 34 - Yt 12} \qquad ( EQ 23 )$$

The drive value is converted to the true position.

$$\vert \begin{matrix}Xt \\ Yt \\ Zt\end{matrix} \vert = \vert \begin{matrix}Xd \\ Yd \\ Zd\end{matrix} \vert + \frac{( Yd - Yd 12 ) Err 34 + ( Yd 34 - Yd ) Err 12}{Yd 34 - Yd 12} \qquad ( EQ 24 )$$

The following describes the travel correction for eight reference points. Travel correction for eight reference points is an extension of the correction for four reference points described above. The X, Y, and Z points are specified by the method of estimating Err and coordinate axes for points internally divided in the order of the X, Y, and Z axes based on the same method. Equations are generated for converting target positions for the X, Y, and Z points to drive values and an equation for converting drive values to target positions, as shown in FIG. 31.

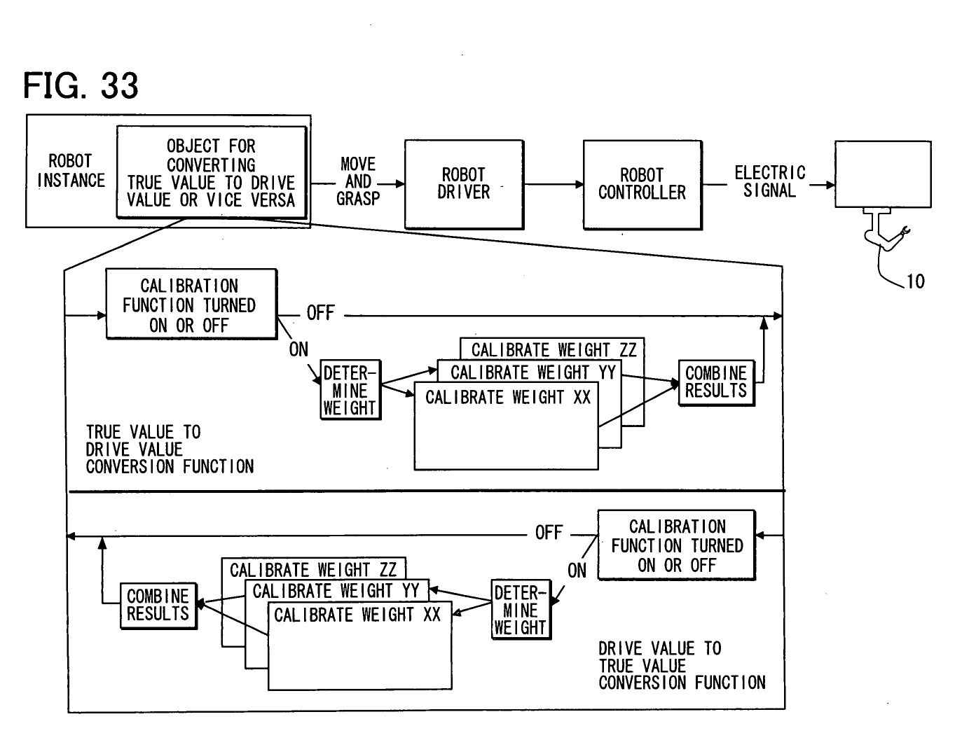

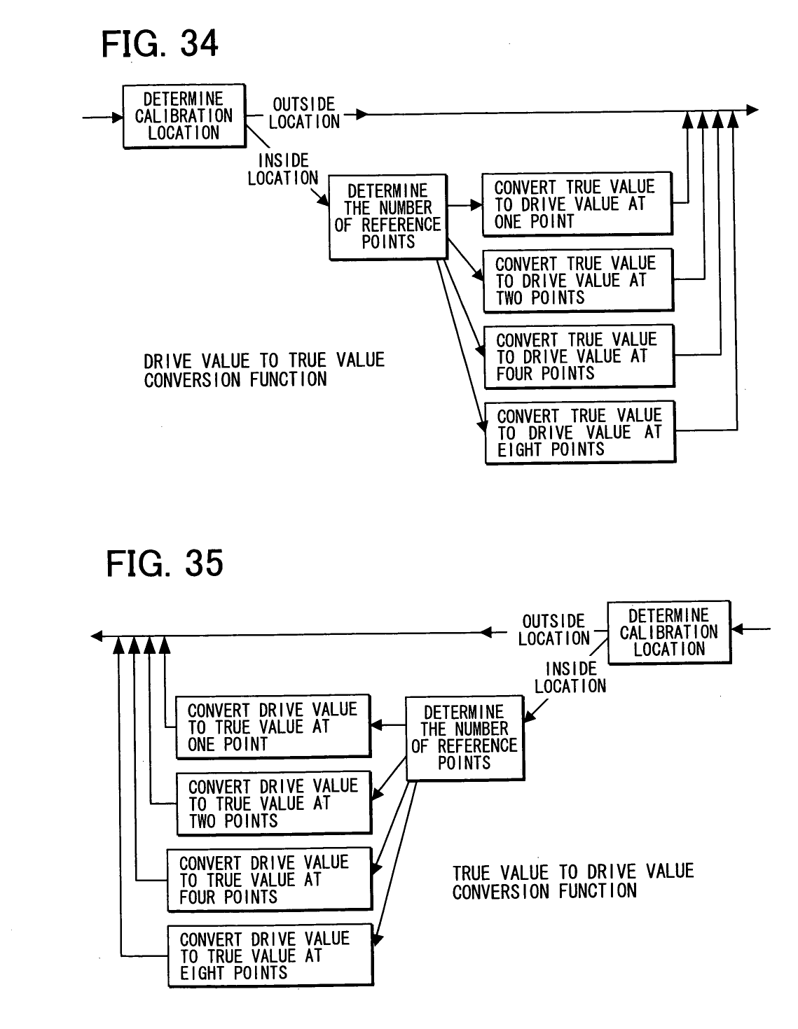

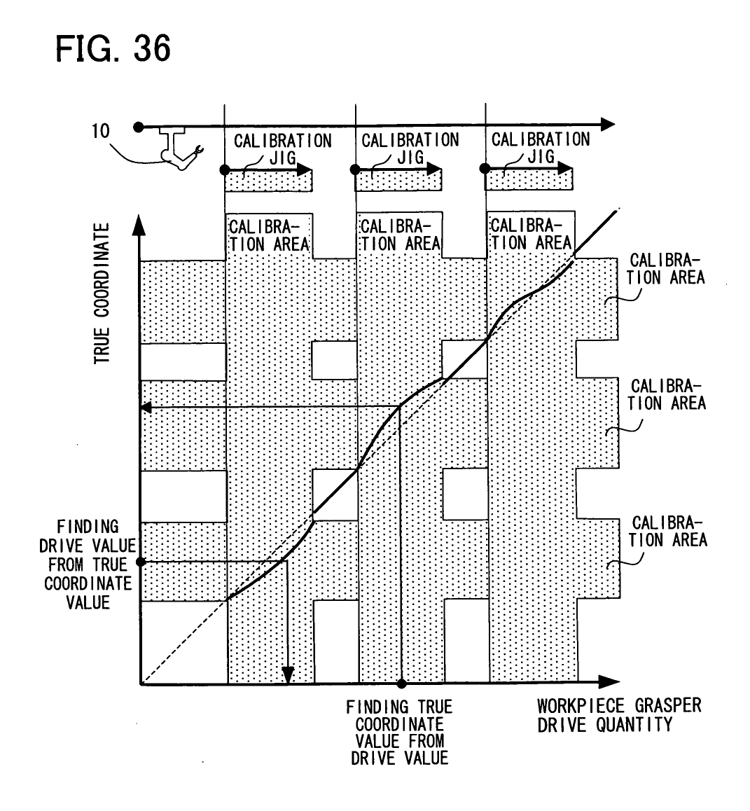

As shown in FIG. 32, a calibration system uses a correction PG to convert the true value to the drive value and supplies a robot driver with a drive instruction immediately before a robot instance issues a move instruction to the robot driver. When receiving a drive value from the robot driver, the system converts the drive value to the true value and then uses the value for a later calculation as shown in FIG. 33. Internally, the weight-based calibration system converts a true value to a drive value and a drive value to a true value as shown in FIG. 34 and FIG. 35. The area determination process determines whether or not a coordinate is included in the calibration area in FIG. 36.

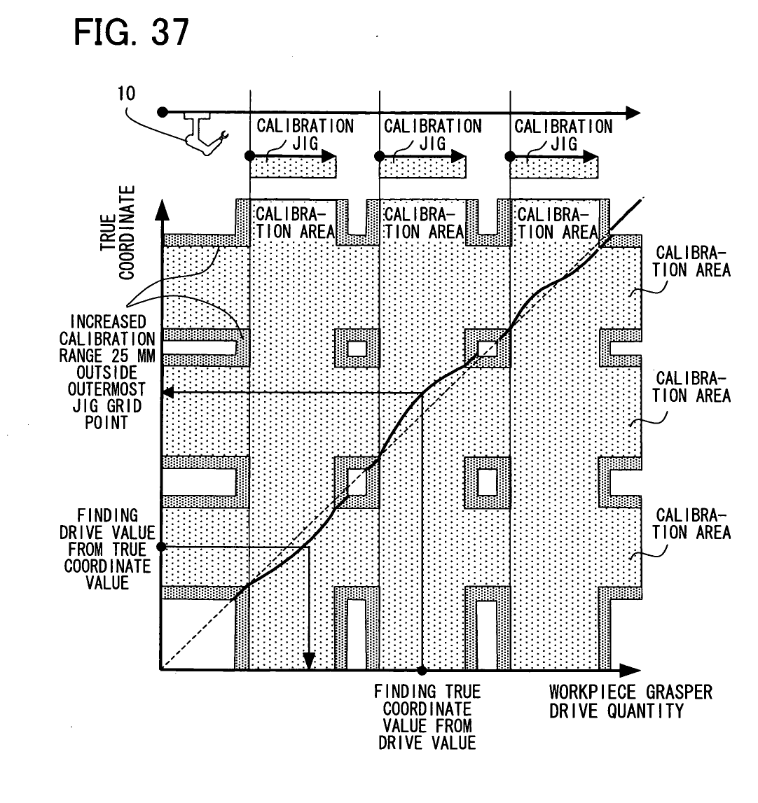

In FIG. 36, the calibration area is limited to grid points of the jig making it impossible to correct near the outside of the grid points. An actual calibration range covers a specified area approximately up to 25 mm outside an outermost grid point, as shown in FIG. 37. An intermittent point occurs at a boundary between the calibration area an a non-calibration area but causes no problem since the calibration area includes all the points to mount or dismount workpieces and the reference bar for referencing the points to mount or dismount workpieces.

The following describes correction of facility and jig positions.

Multi-shaped workpieces can be transferred when the workpiece grasper 10 is provided with the hand 16a or 16b capable of holding a single point and inserts the hand into a hole of the workpiece 200 to hold the workpiece 200. The transfer of multi-shaped workpieces requires robot teaching about a position to grasp the workpiece. The robot teaching signifies using a robot operation panel to physically move a robot as the workpiece grasper 10, moving the tip of the hand 16a or 16b to the hole as a holding section of the workpiece 200, and storing the corresponding coordinate.

Generally, new products and discontinued products must always be interchanged on a production line where various products flow. The following may occur when making an attempt to conduct the robot teaching for automatically mounting and dismounting new products under such production environment.

Since the production line produces not only articles associated with new products but also articles associated with current products, it is difficult to stop the line for the purpose of teaching, that is, updating the robot with information associated with the new product. In addition, stopping the production line decreases the utilization on the line reducing production efficiency.

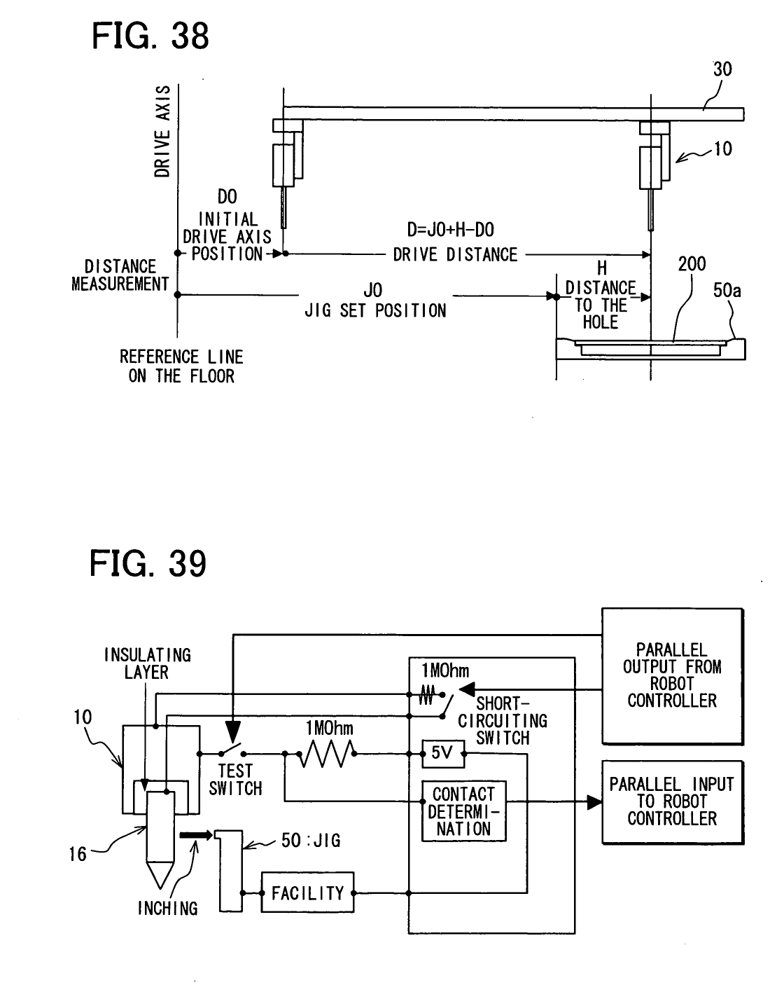

The offline teaching provides a means for addressing stoppage due to teaching. As shown in FIG. 38, the offline teaching supplies the controller with DO, JO, and H as numeric values and performs the calculation of D=JO+H−DO to find a drive quantity D for inserting the tip of the hand 16a or 16b into the hole.

When an attempt is made to actually use the above described technique, however, it is only possible to ensure several millimeters of measurement accuracy between the reference line on the floor and the rail end or the end of the jig 50, for example. It is difficult to use the above-described technique while ensuring the accuracy of approximately ±0.1 mm required to insert the hand 16a or 16b into the hole of the workpiece 200.

The contact-type facility and jig position calibration is a method of providing the offline teaching under the above-described environment. The hands 16a and 16b are automatically inched from a position slightly short of the edge of the jig 30, the drive quantity DC is stored when the hands 16a and 16b contact the jig 5, and then the hands 16a and 16b are moved to H+r, where r is the radius of the hands 16a and 16b, to position the hands 16a and 16b to the center of the hole.

While the inching technique is relatively simple in the one-dimensional space, the processing facility and the jig are placed in a three-dimensional space. Positions and angles of the processing facility and the jig must be calibrated in consideration for the horizontal alignment of the processing facility and the jig or a tilt of the same against the XY plane for installation and against a single-axis rail.

FIG. 39 shows an available construction example. The embodiment automatically detects a jig position. As shown in FIG. 39, the hands 16a and 16b contact the jig for conductivity check to detect a position.

The hands 16a and 16b have insulated tips to which a 5V is applied only for confirmation of the contact. When no test is conducted, the tip may accumulate static electricity due to contact with the workpiece 200. A short-circuiting switch connects the tips of the hands 16a and 16b to the support section 11 when no contact probe is conducted. When a contact test is made, a test switch is closed and the short-circuiting switch is opened. When no contact test is made, the test switch is opened and the short-circuiting switch is closed.

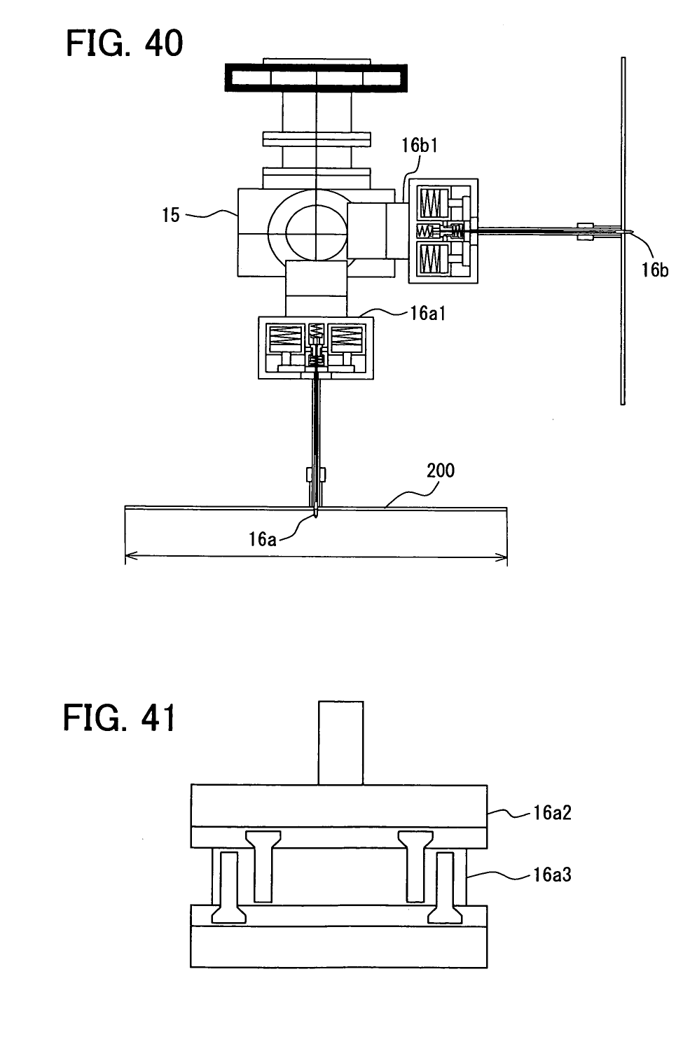

As shown in FIG. 40, the hands 16a and 16b can be insulated at the roots thereof. The insulation connects a flange section 16a2 and the succeeding portion via insulating bodies 16a1 and 16b1. An insulating plate 16a3 can be used as an insulating member. The insulating plate 16a3 can be also used for height adjustment. The insulating portion and the succeeding part of the workpiece grasper 10 may be set to +5 V or may be grounded via 1 mΩ. Attention should be paid so as to prevent a wiring that uses the hands 16a and 16b for grounding.

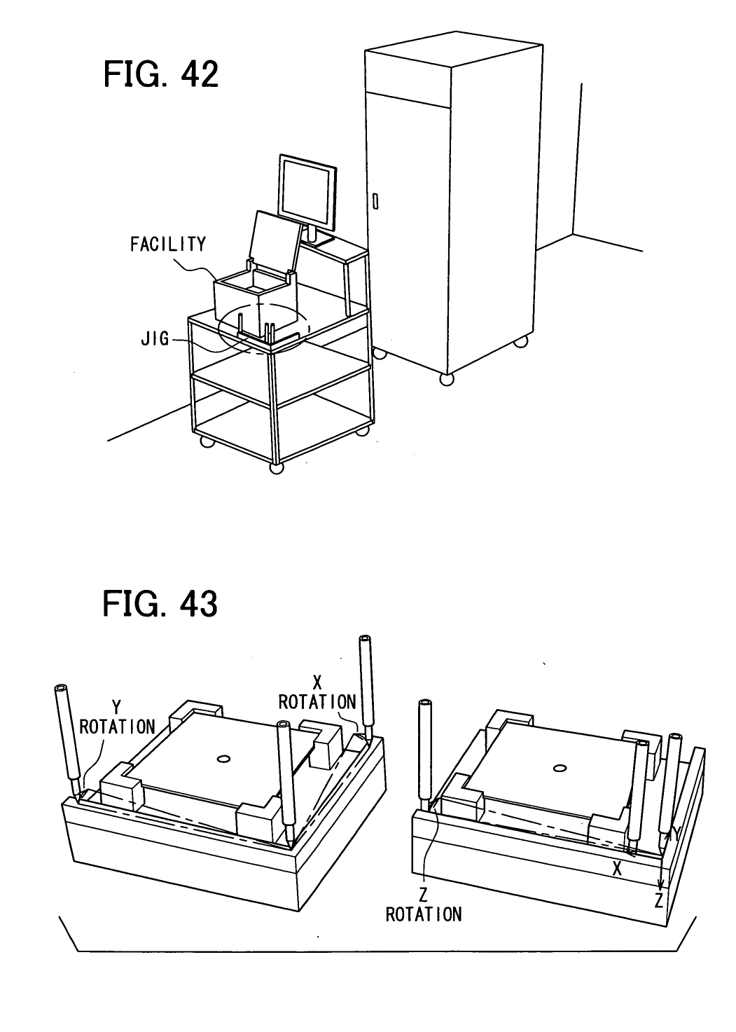

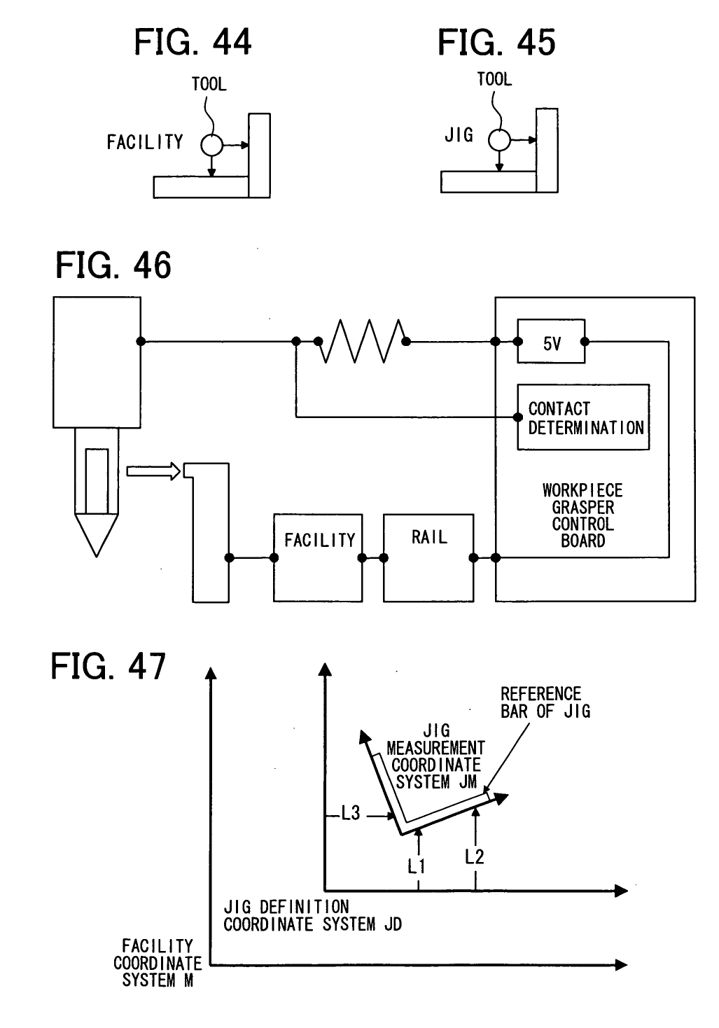

The facility and the jig are positioned as shown in FIG. 42 through FIG. 46 so that the tool contacts with the reference bar for detection. The facility may be installed with an accuracy of approximately ±10 mm. The jig may be installed with an accuracy of approximately ±3 mm.

FIG. 47 shows an example of the jig coordinate calibration viewed from an observing point of the coordinate system. A jig definition coordinate system JD is represented by 4×4 homogeneous coordinates of ^{M}JD viewed from a facility coordinate system M.

The jig definition coordinate system JD signifies data indicating the jig position and angle on the drawing that should correspond to the jig coordinate system when viewed from the facility coordinate system on a facility drawing and a jig drawing. When viewed from the jig definition coordinate system JD, a jig measurement coordinate system JM is represented by 4×4 homogeneous coordinates ^{JD}JM. The jig measurement coordinate system JM signifies data indicating the position and the angle of the actually installed jig viewed from the jig coordinate system on the drawing. The data is derived from L1, L2, and L3 corresponding to actually measured reference bar positions for the jig in the jig definition coordinate system JD.

A coordinate conversion equation ^{M}JM=^{M}JD^{JD}JM is used to find 4×4 homogeneous coordinates ^{M}JM in an actual jig installation coordinate system JM viewed from the facility coordinate system M. A contact probe is first conducted to acquire XYZ values that are then used to acquire a 4×4 homogeneous coordinate system for an error. The 4×4 homogeneous coordinate system for the error is converted to a 4×4 homogeneous coordinate system for actual positions of the facility as ^{W}M and the jig as ^{M}J.

A more detailed description follows. The contact probe requires a procedure of finding a point to start the inspection, finding a point to stop the inspection, operating the workpiece grasper 10 to conduct the contact probe, and acquiring a contact coordinate value.

Except the actual drive operations, the following describes how to find a contact probe start coordinate and a contact probe stop coordinate. The contact probe stop coordinate is used as follows. The facility or the jig may be placed at a quite different position when the contact probe is conducted. The contact probe stop coordinate abnormally terminates the contact probe when no contact is detected after the inspection up to the contact probe stop coordinate.

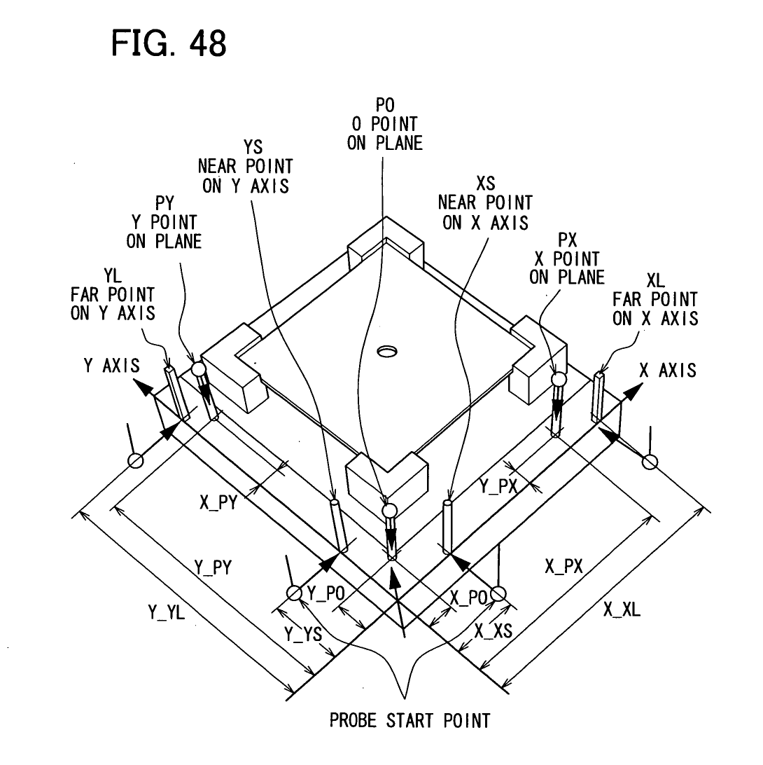

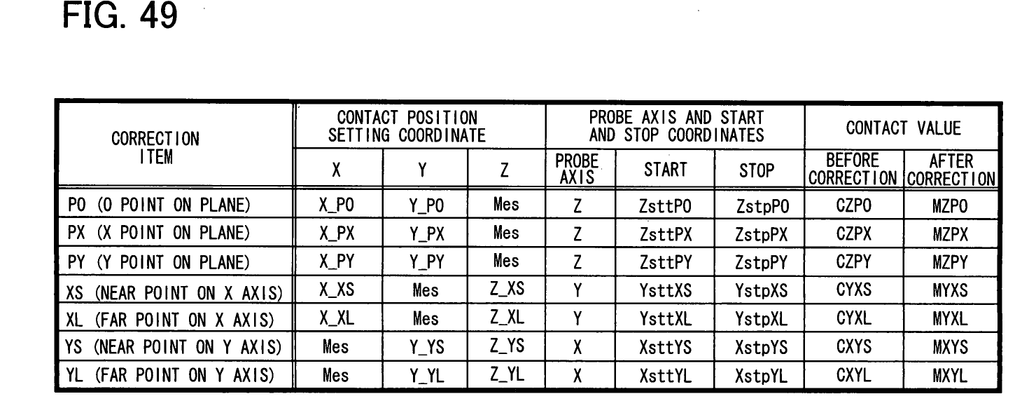

When the hands 16a and 16b contact with the reference bar to measure positions, the hands 16a and 16b must contact with the reference bar at specific positions of the reference bar while avoiding obstacles on the facility. Contact positions of the hands 16a and 16b are defined for each of the jig and the facility as shown in FIG. 48. In the dimensional drawing, for example, PO signifies a plane origin approximate to the origin for finding a plane. To make contact, the tips of the hands 16a and 16b move in the negative direction along the Z axis in FIG. 48.

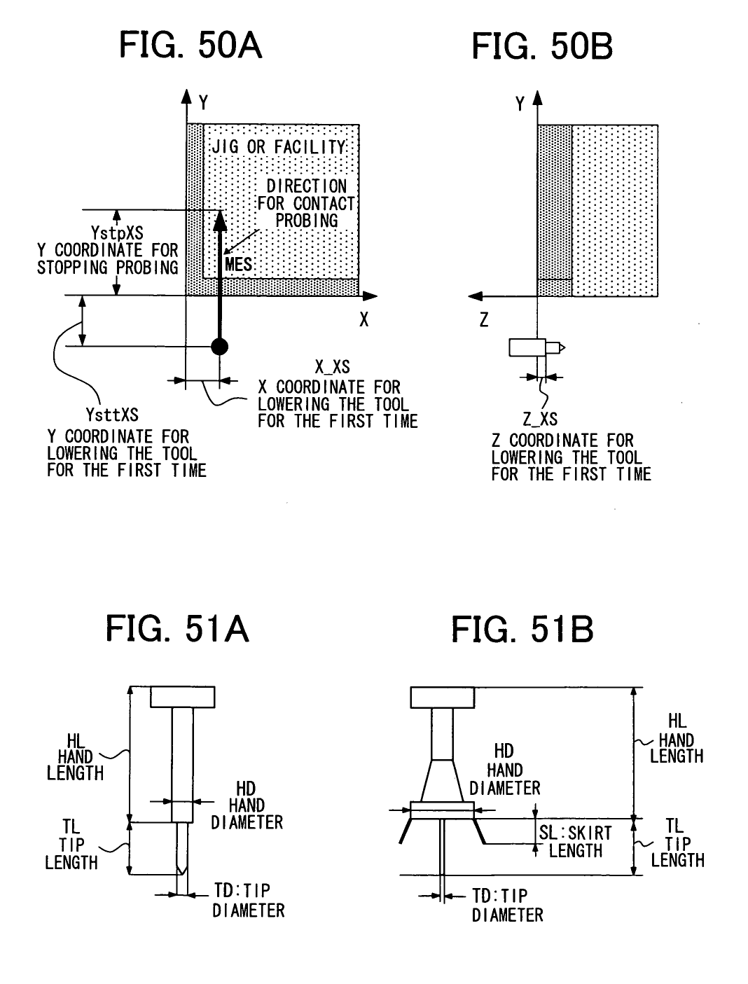

FIG. 49 defines coordinate symbols in accordance with parallel XYZ movements and angles to be corrected. A hatching cell indicates a measurement position to be specified by a user. A Mes cell indicates measurement of the axis so as to conduct the contact probe along the axis. A contact value before correction denotes a raw coordinate value when the tool is contacted. A contact value after correction results from the contacted raw coordinate value by correcting a tool radius (XY) and an excess quantity (Z). When XS, XL, YS, and YL are measured, only XS is measured when XS and XL are measured; and only XS is measured when YS and YL are measured. FIG. 50A and FIG. 50B are explanatory diagrams of X_XS, Mes, Z_XS, YsttXS, and YstpXS using XS correction as an example.

The outside of the tool is actually contacted while the tool coordinate system is defined around the tool center. The difference needs to be corrected to determine positions to start and stop the contact probe.

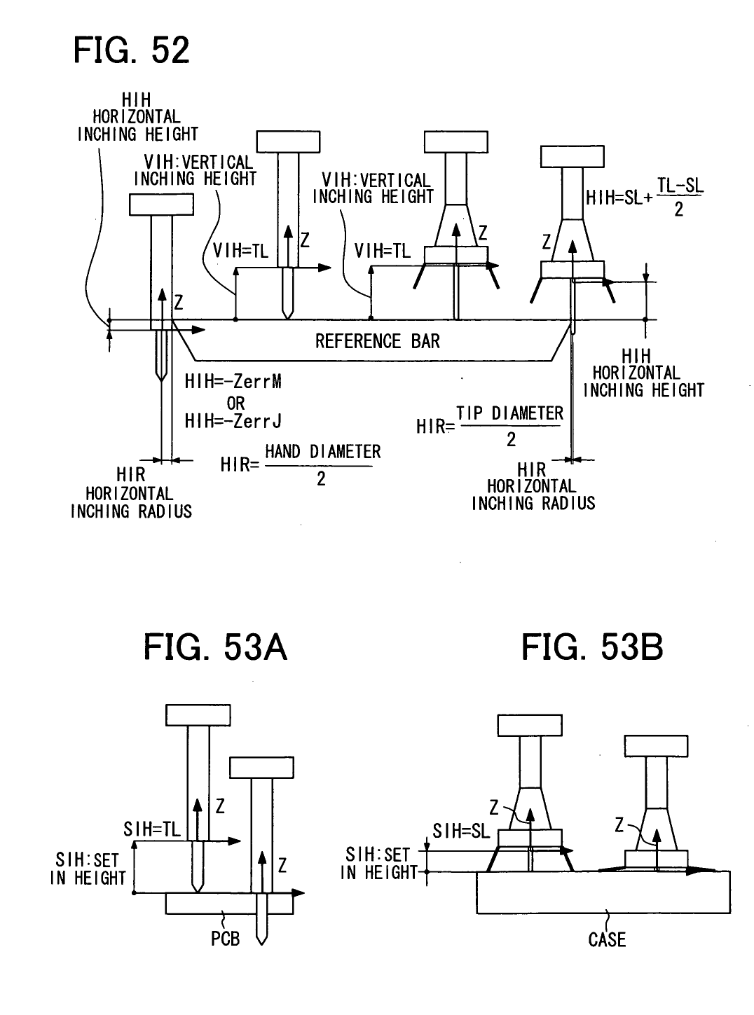

The following names are given to dimensional differences between the tool coordinate system around the tool center and the actually contacted tool outside. HIR denotes the tool radius at the contact portion during horizontal inching when a contact position is calibrated. HIH denotes the Z coordinate of the tool at the contact portion during horizontal inching when a contact position is calibrated. VIH denotes the Z coordinate of the tool at the contact portion during vertical inching when a contact position is calibrated. XYErrM/J actually includes XYErrM and XYErrj that respectively indicate errors between the declared position and the actual position of the facility and the jig in the X-axis direction and the horizontal Y-axis direction. ZErrM/J actually includes ZErrM and Zerr that respectively indicate errors between the declared position and the actual position of the facility and the jig in the vertical Z-axis. FIGS. 51A through 53B show nomenclatures of the facility, the jig, and the tool.

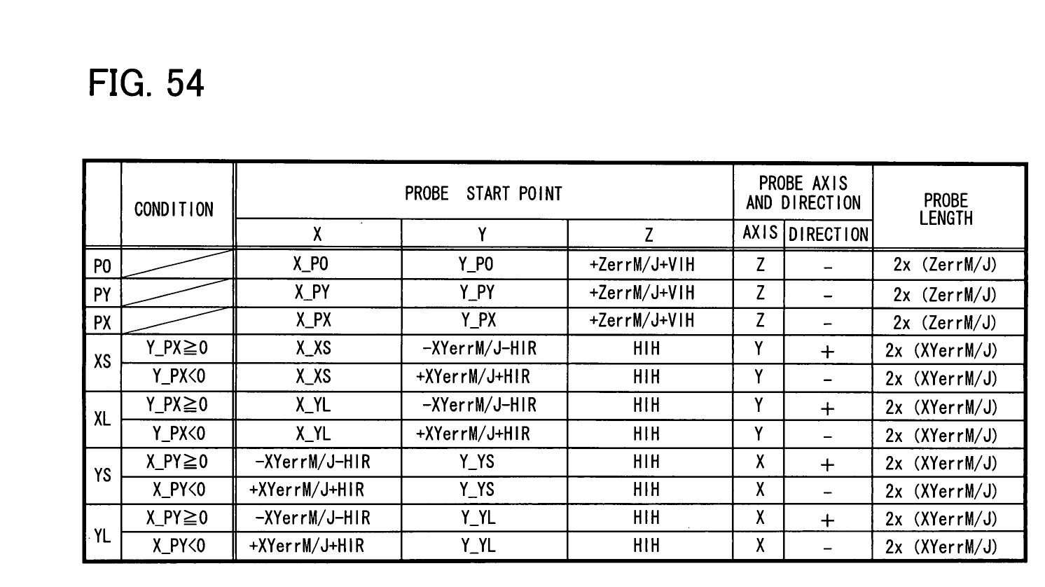

FIG. 54 shows the contact probe start point, the probe axis and probe direction, and the probe length according to such symbol system. The probe length signifies a distance to stop the probe when no contact occurs. The probe start point and the probe stop point depend on positive and negative X_PX and Y_PY because the reference bar is located at the positive or negative side of the plane to be probed.

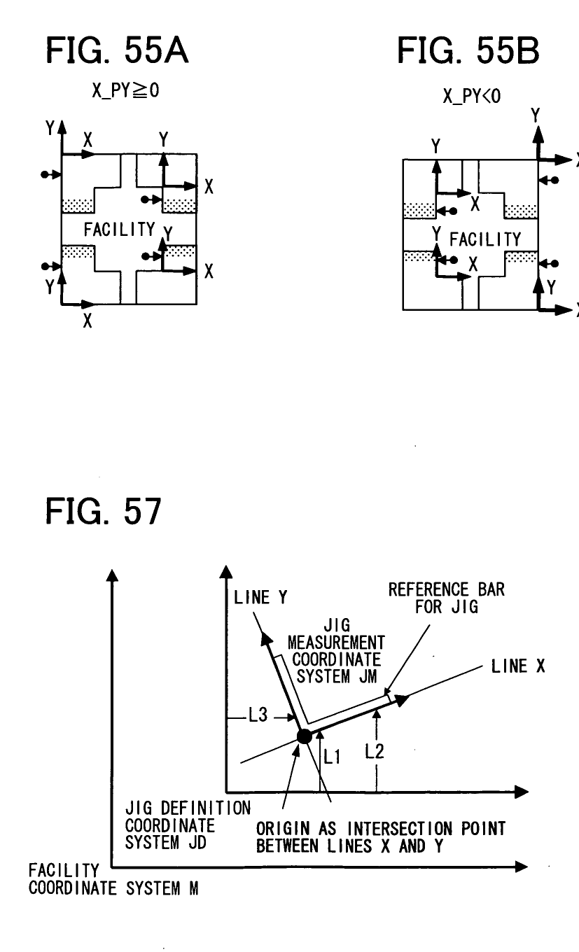

FIG. 55A shows a relation between the reference bar for X_PY≧0 and the coordinate system and FIG. 55B shows a relation between the reference bar for X_PY<0 and the coordinate system according to YS measurement as an example. As seen from FIG. 55A and FIG. 55B, the probe proceeds from the negative side to the positive side of the X axis under the condition of X_PY≧0. The probe proceeds from the positive side to the negative side of the X axis under the condition of X_PY<0.

Unlike the XY-axis probe, starting or stopping the Z-axis probe requires no distinction since the Z-axis probe proceeds from the top to the bottom, namely, from the positive side of the Z axis for the facility or the jig to the negative side thereof. That is, the reference plane is always positioned to the bottom.

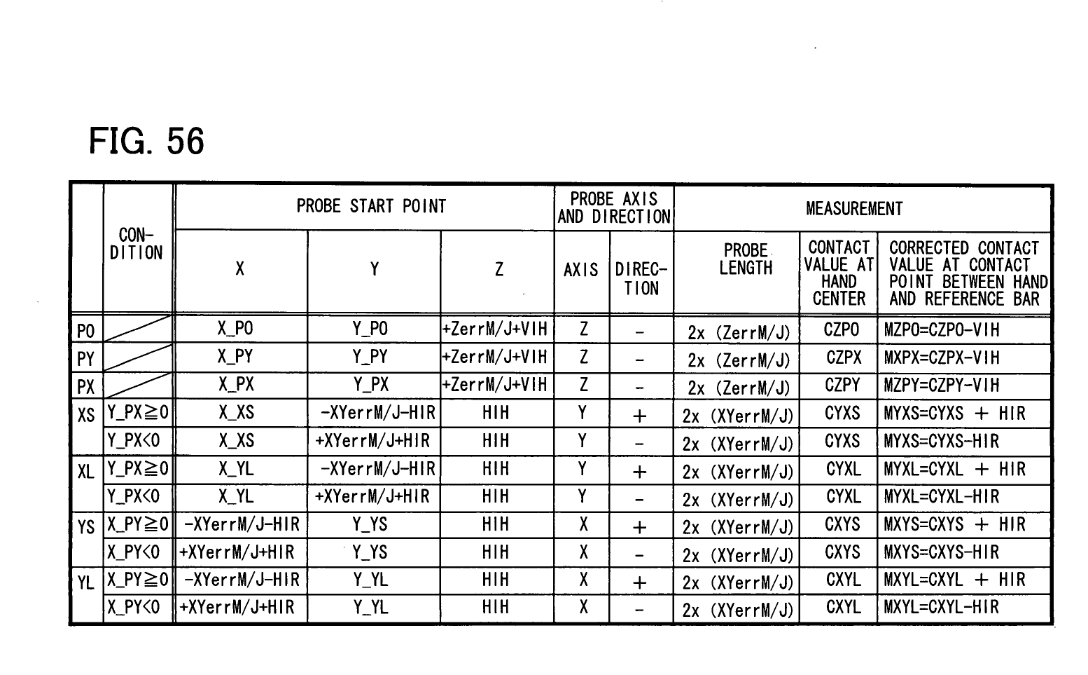

The coordinate of the contacted jig is located with an offset of HIH, HIR, or VIH from the following values. The tool coordinate system needs to be positioned by subtracting or adding the offset value to the contact value. Assume that CPO, CPX, CPY, CXS, CXL, CYS, and CYL to be coordinate system values for the contacted jig. Equations in FIG. 56 are used to find contact coordinates MPO, MPX, MPY, MXS, MXL, MYS, and MYL after the offset correction.

The XYZ values acquired from the contact are used to acquire the 4×4 homogeneous coordinate system for errors. After correcting the coordinates of the facility and installing the jig, the following conversion matrices must be found from the acquired XYZ values such as MZPO, MZPX, MZPY, MYXS, MYXL, MXYS, and MXYL. One is 4×4 homogeneous coordinate transformation matrix ^{MD}MM for the facility in a design measurement coordinate system MM viewed from a facility definition coordinate system MD. Another is 4×4 homogeneous coordinate transformation matrix ^{JD}JM for the jig in a jig measurement coordinate system MM viewed from a jig definition coordinate system MD. The 4×4 homogeneous coordinate system is expressed as follows (EQ 25).

$${}^{JD} JM = \vert \begin{matrix}{X}_{x} & {Y}_{X} & {Z}_{X} & {O}_{x} \\ {X}_{Y} & {Y}_{Y} & {Z}_{Y} & {O}_{y} \\ {X}_{Z} & {Y}_{Z} & {Z}_{Z} & {O}_{z} \\ 0 & 0 & 0 & 1\end{matrix} \vert \qquad ( EQ 25 )$$

In equation 25, Xx through Oz signify the following when representing the 4×4 homogeneous coordinate transformation matrix as base target for the target coordinate system viewed from the base coordinate system as mentioned above. Xx denotes a ratio of X unit vector components in the base coordinate system contained in an X unit vector of the target coordinate system. Xy denotes a ratio of Y unit vector components in the base coordinate system contained in an X unit vector of the target coordinate system. Xz denotes a ratio of Z unit vector components in the base coordinate system contained in an X unit vector of the target coordinate system. Yx denotes a ratio of X unit vector components in the base coordinate system contained in a Y unit vector of the target coordinate system. Yy denotes a ratio of Y unit vector components in the base coordinate system contained in a Y unit vector of the target coordinate system. Yz denotes a ratio of Z unit vector components in the base coordinate system contained in a Y unit vector of the target coordinate system. Zx denotes a ratio of X unit vector components in the base coordinate system contained in a Z unit vector of the target coordinate system. Zy denotes a ratio of Y unit vector components in the base coordinate system contained in a Z unit vector of the target coordinate system. Zz denotes a ratio of Z unit vector components in the base coordinate system contained in a Z unit vector of the target coordinate system. Oz denotes the origin of a target coordinate system corresponding to the X axis of the base coordinate system. Oy denotes the origin of a target coordinate system corresponding to the Y axis of the base coordinate system. Oz denotes the origin of a target coordinate system corresponding to the Z axis of the base coordinate system.

For example, finding the 4×4 homogeneous coordinate transformation matrix ^{JD}JM for the jig in the jig measurement coordinate system MM viewed from the jig definition coordinate system MD signifies finding 12 matrix elements Xx through Ox in the 4×4 homogeneous coordinate transformation matrix ^{JD}JM. To find the 12 values, an angle component is found and then a parallel movement component is found, as shown in FIG. 57.

The angle component is found first for the following reason. Since the origin is a single point in the space, the vicinity of the origin can be measured, but the origin itself cannot be measured by contact. To find the origin, a straight line X as the X axis of the jig measurement coordinate system and a straight line y of the Y axis of the jig measurement coordinate system are found from a measure point. An intersection point of the two straight lines is then found in order to find the origin.

The following describes how to find an angle vector to be corrected and the origin from a measurement in respective cases. An actual measurement process uses a combination of MZPO, MZPX, MZPY, MXYS, MXYL, and MYXS or a combination of MZPO, MZPX, MZPY, MYXS, MYXL, and MXYS. The measurement process will be described for each of the combinations.

The following describes the measurement of MZPO, MZPX, MZPY, MXYS, MXYL, and MYXS, the measurement of two points on the Y axis.

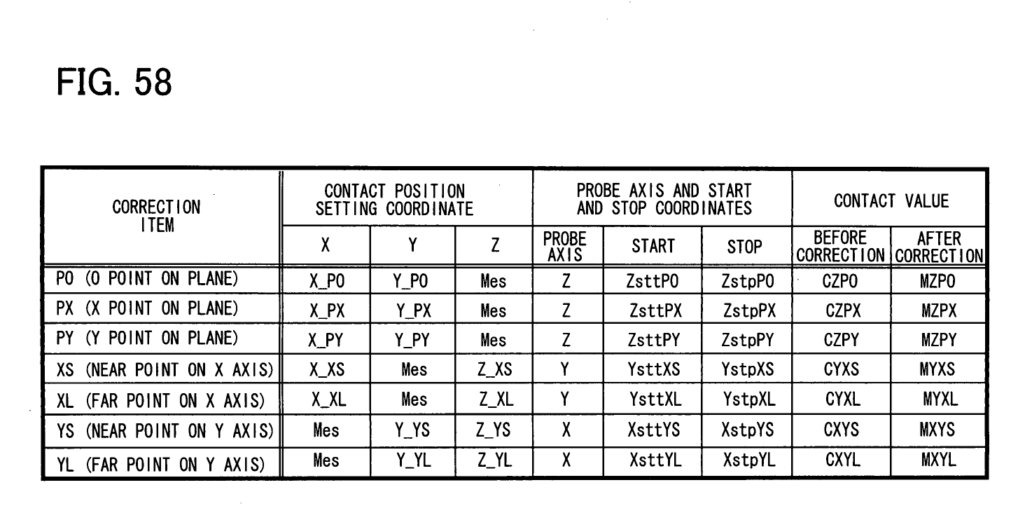

MZPO, MZPX, MZPY, MXYS, MXYL, and MYXS correspond to measurements for the positions in FIG. 58. Based on MZPO, MZPX, MZPY, MXYS, MXYL, and MYXS. The 4×4 homogeneous coordinate transformation matrix ^{JD}JM in the jig measurement coordinate system JM viewed from the jig definition coordinate system JD can be found as follows (EQ 26).

$${}^{JD} JM = \vert \begin{matrix}{X}_{x} & {Y}_{X} & {Z}_{X} & {O}_{x} \\ {X}_{Y} & {Y}_{Y} & {Z}_{Y} & {O}_{y} \\ {X}_{Z} & {Y}_{Z} & {Z}_{Z} & {O}_{z} \\ 0 & 0 & 0 & 1\end{matrix} \vert \qquad ( EQ 26 )$$

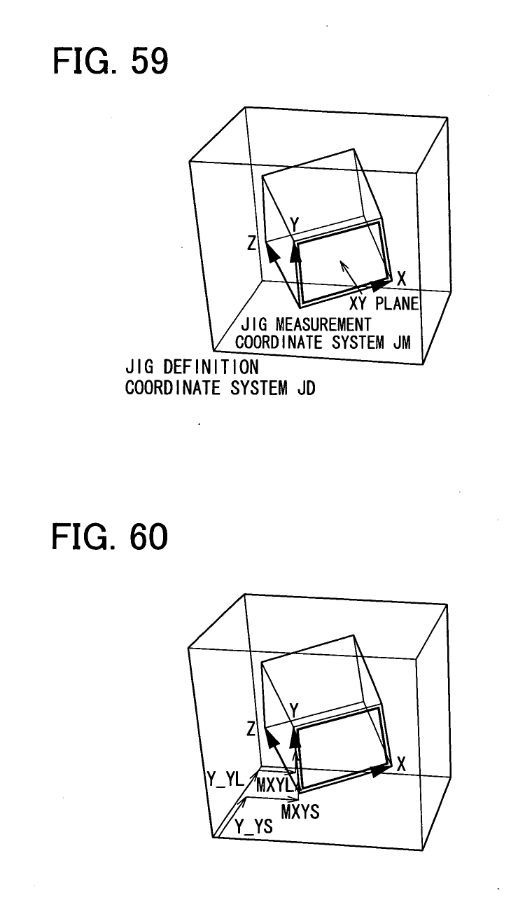

MZPO, MZPX, and MZPY are used to find an equation for the XY plane in the jig measurement coordinate system MM, as shown in FIG. 59.

The equation for the XY plane is assigned (MXYS, Y_YS) and (MXYL, Y_YL) to calculate Z coordinate values for the points, as shown in FIG. 60.

The two found points (MXYS, Y_YS, PZYS) and (MXYL, Y_YL, PZYL) pass through the Y axis of the jig measurement coordinate system JM. XYZ components of a straight line passing through the two points are used to find Y axis components (Yx, Yy, Yz) of the jig measurement coordinate system JM in EQ 26.

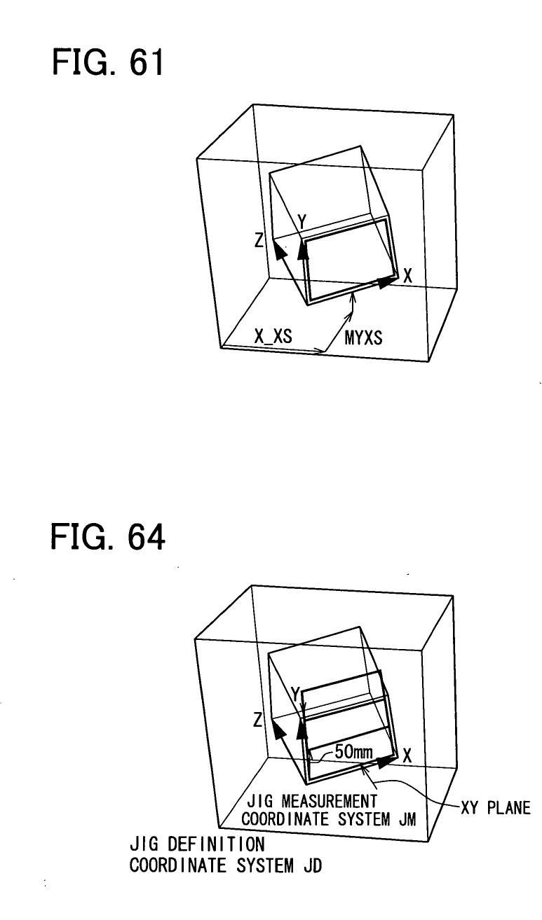

The equation for the XY plane is assigned values of (X_XS, MYXS) to calculate the Z coordinate value, as shown in FIG. 61. The found points are assumed to be (X_XS, MYXS, PZXS).

When a coordinate (Ox, Oy, Ox) is assumed to be the origin of the jig measurement coordinate system JM viewed from the jig definition coordinate system JD, the line passing through the two points (Ox, Oy, Oz) and (X_XS, MYXS, PZXS) found above becomes the X axis of the jig measurement coordinate system JM. The following relations (1) and (2) are used to find Ox, Oy, and Oz. In relation (1), the Y axis of the coordinate system JM is perpendicular to the line connecting (Ox, Oy, Oz) and (X_XS, MYXS, PZXS) as the X axis of the coordinate system JM. An inner product is 0. In relation (2), the point (Ox, Oy, Oz) is located on the third Y axis found above and satisfies the equation for the straight line on the Y axis.

X axis components (Xx, Xy, Xz) in the jig measurement coordinate system JM are found using the origin coordinate (Ox, Oy, Oz) and the point (X_XS, MYXS, PZXS) on the X axis in the fifth jig measurement coordinate system JM found above.

An outer product of the vector is found from X axis components (Xx, Xy, Xz) in the jig measurement coordinate system JM and Y axis components (Yx, Yy, Yz) in the jig measurement coordinate system JM to acquire Z axis components (Zx, Zy, Zz) in the jig measurement coordinate system JM.

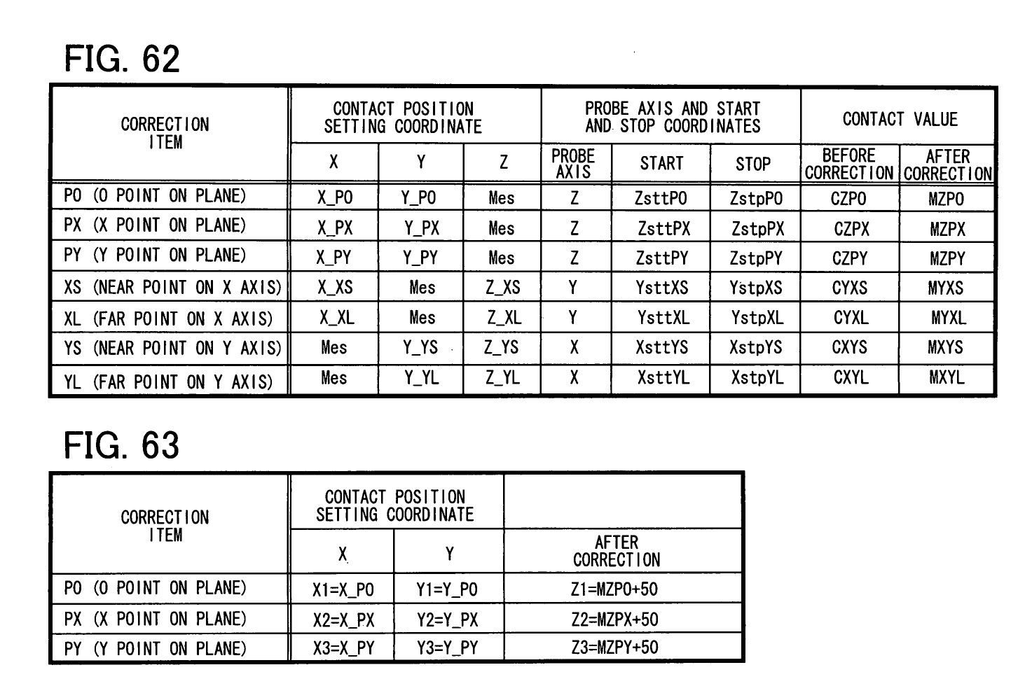

Three measure points are used to find an equation for a plane. The three points used here are combinations of XYZ values for the three points in FIG. 62. Each character string is long and is changed as shown in FIG. 63. 50 is added to the Z axis for convenience sake so as to avoid d=0 when finding an equation for a plane. As shown in FIG. 64, a plane to be found is 50 mm higher than the original XY plane in the Z axis direction.

The above-described three points are located on a plane and provide three equations shown below. Solving the equations finds values abc as follows, as shown in FIG. 64.

The above-described three points are assigned to the equation for plane ax+by+cz+d=0 as follows (EQ 27).

ax₁+by₁+cz₁+d=0

ax₂+by₂+cz₂+d=0

ax₃+by₃+cz₃+d=0 (EQ 27)

The following system of three equations are solved to find a, b, and c (EQ 28).

$$a = \frac{( - {z}_{3} + {z}_{1} ) {y}_{2} + ( - {z}_{1} + {z}_{2} ) {y}_{3} + {y}_{1} {z}_{3} - {z}_{2} {y}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} d \\ b = \frac{( {z}_{1} - {z}_{2} ) {x}_{3} + ( {z}_{3} - {z}_{1} ) {x}_{2} - {x}_{1} {z}_{3} + {z}_{2} {x}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} d \\ c = \frac{( y - y ) x - x y + ( ( y - y ) x + y x )}{( - {z}_{1} {y}_{2} + {z}_{2} {y}_{1} ) {x}_{3} + {z}_{3} x y + ( z y - y z ) x - z x y} d \qquad ( EQ 28 )$$

Based on d≠0, the results can be applied as follows (EQ 29).

$$aX + bY + cZ + d = 0 \\ \frac{a}{b} X + \frac{b}{d} Y + \frac{c}{d} Z + 1 = 0 \\ where \\ \frac{a}{d} = {a}^{′} \frac{b}{d} = {b}^{′} \frac{c}{d} = {C}^{′} , \qquad ( EQ 29 )$$

The equation for plane can be transformed as follows (EQ 30).

a′X+b′Y+C′Z+1=0 (EQ 30)

where a′, b′, and c′ can be expanded as follows (EQ 31).

$${a}^{′} = \frac{( - {z}_{3} + {z}_{1} ) {y}_{2} + ( - {z}_{1} + {z}_{2} ) {y}_{3} + {y}_{1} {z}_{3} - {z}_{2} {y}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} d \\ {b}^{′} = \frac{( {z}_{1} - {z}_{2} ) {x}_{3} + ( {z}_{3} - {z}_{1} ) {x}_{2} - {x}_{1} {z}_{3} + {z}_{2} {x}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} d \\ {c}^{′} = \frac{( {y}_{2} - {y}_{1} ) {x}_{3} + {x }_{1} {y}_{2} + ( ( {y}_{1} - {y}_{3} ) {x}_{2} + {y}_{3} {x}_{1} )}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} d \qquad ( EQ 31 )$$

EQ 31 can be simplified as follows (EQ 32).

$${a}^{′} = \frac{( {z}_{3} - {z}_{2} ) {y}_{1} + ( {z}_{1} - {z}_{3} ) {y}_{2} + ( {z}_{2} - {z}_{1} ) {y}_{3}}{\begin{matrix}( {y}_{2} {z}_{3} - {y}_{3} {z}_{2} ) {x}_{1} + ( {y}_{3} {z}_{1} - {y}_{1} {z}_{3} ) {x}_{2} + \\ ( {y}_{1} {z}_{2} - {y}_{2} {z}_{1} ) {x}_{3}\end{matrix}} d \\ {b}^{′} = \frac{( {z}_{2} - {z}_{3} ) {x}_{1} + ( {z}_{3} - {z}_{1} ) {x}_{2} - ( {z}_{1} + {z}_{2} ) {x}_{3}}{\begin{matrix}( {y}_{2} {z}_{3} - {y}_{3} {z}_{2} ) {x}_{1} + ( {y}_{3} {z}_{1} - {y}_{1} {z}_{3} ) {x}_{2} + \\ ( {y}_{1} {z}_{2} - {y}_{2} {z}_{1} ) {x}_{3}\end{matrix}} d \\ {c}^{′} = \frac{( {y}_{3} - {y}_{2} ) {x}_{1} + ( {y}_{1} - {y}_{3} ) {x}_{2} + ( {y}_{2} - {y}_{1} ) {x}_{3}}{\begin{matrix}( {y}_{2} {z}_{3} - {y}_{3} {z}_{2} ) {x}_{1} + ( {y}_{3} {z}_{1} - {y}_{1} {z}_{3} ) {x}_{2} + \\ ( {y}_{1} {z}_{2} - {y}_{2} {z}_{1} ) {x}_{3}\end{matrix}} d \qquad ( EQ 32 )$$

Let us find Y axis components Yx, Yy, and Yz of equation 25 from the equation for the plane. The two points pass through the Y axis of the jig measurement coordinate system JM in accordance with the equation for the plane. The XYZ components of the straight line passing through the two points are used to find a Y axis component below.

The equation for the plane found above is transformed into equation 33 as follows.

$$\begin{matrix}{a}^{′} X + {b}^{′} Y + {c}^{′} Y + 1 = 0 \\ {c}^{′} Z = 1 - {a}^{′} X - {b}^{′} Y \\ Z = \frac{- ( 1 + {a}^{′} X + {b}^{′} Y )}{{c}^{′}}\end{matrix} \qquad ( EQ 33 )$$

The plane has been previously found 50 mm shifted above for convenience sake. A correction of 50 mm can be applied and a coordinate can be found as follows (EQ 34).

$$Z = \frac{- ( 1 + {a}^{′} X + {b}^{′} Y )}{{c}^{′}} - 50 \qquad ( Equation 34 )$$

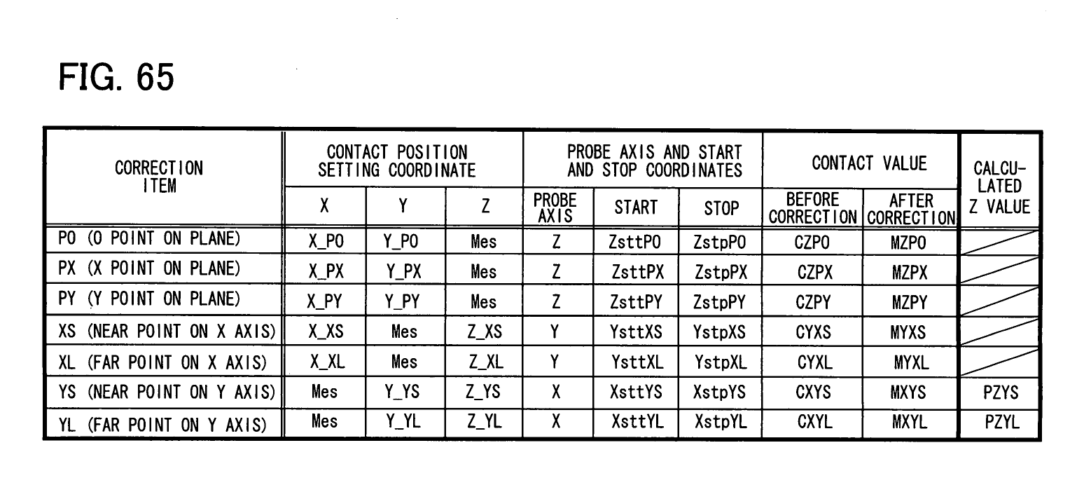

Equation 34 is assigned XY coordinates for the two points in FIG. 65 to find the Z coordinate.

Assuming that the equation finds the Z coordinate to be PZYS and PZYL, the Y axis of the jig measurement coordinate system JM passes through two points (MXYS, Y_YS, PZYS) and (MXYL, Y_YL, PZYL).

Y axis components Yx, Yy, and Yz of the jig measurement coordinate system JM can be found as follows (EQ 35).

$${Y}_{x} = \frac{MXYL - MXYS}{\sqrt{\begin{matrix}{( MXYL - MXYS )}^{2} + {( Y\_YL - Y\_YS )}^{2} + \\ {( PZYL - PZYS )}^{2}\end{matrix}}} \\ {Y}_{y} = \frac{Y\_YL - Y\_YS}{\sqrt{\begin{matrix}{( MXYL - MXYS )}^{2} + {( Y\_YL - Y\_YS )}^{2} + \\ {( PZYL - PZYS )}^{2}\end{matrix}}} \\ {Y}_{z} = \frac{PZYL - PZYS}{\sqrt{\begin{matrix}{( MXYL - MXYS )}^{2} + {( Y\_YL - Y\_YS )}^{2} + \\ {( PZYL - PZYS )}^{2}\end{matrix}}} \qquad ( EQ 35 )$$

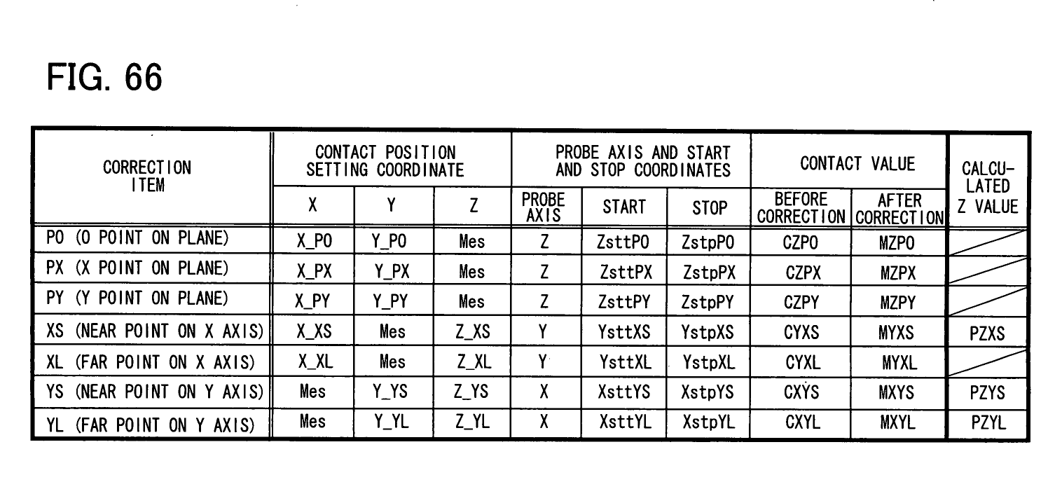

PZXS can be found from the equation for the plane. Similarly to the above-described technique, X_XS and MYXS are assigned to find PZXS as follows (EQ 36). FIG. 66 shows symbols for values to be assigned and found.

$$Z = \frac{- ( 1 - {a}^{′} X + {b}^{′} y )}{{c}^{′}} - 50 \qquad ( EQ . 36 )$$

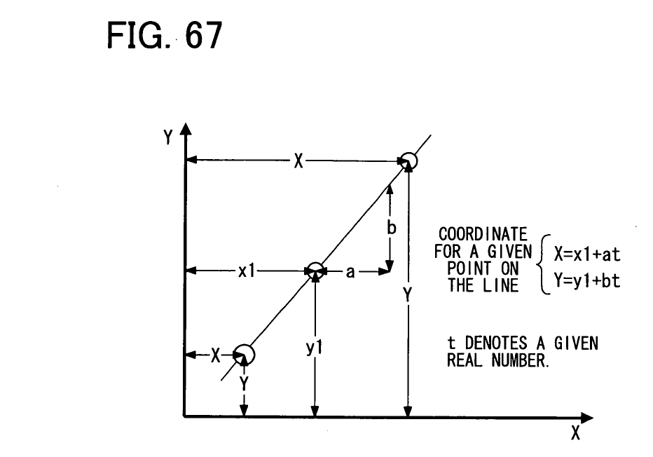

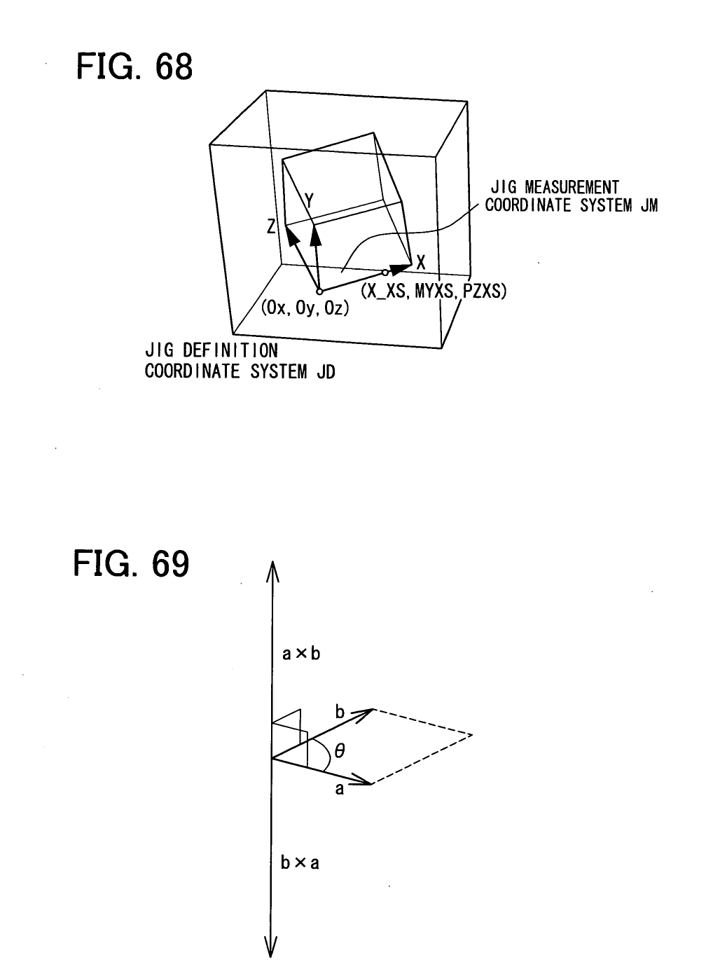

Assume an origin corresponding to Ox, Oy, and Oz can be found. For example, an equation for straight line can be represented as shown in FIG. 67 when a straight line gradient and a coordinate of a point on the straight line are known in two-dimensional coordinates. The same applies to the three-dimensional coordinate system. A given point on the Y axis of the jig measurement coordinate system JM found above can be represented as X=MXYS+tYx, Y=Y_YS+tYy, and Z=PZYS+tYz. Assume that Ox, Oy, and Oz are used to represent a coordinate of the intersection point between the X and Y axes in the jig measurement coordinate system JM, as shown in FIG. 68. Since the point (Ox, Oy, Oz) exists on the Y axis as well as X axis, there is a value for t that satisfies Ox=MXYS+tYx, Oy=Y_YS+tYy, and Oz=PZYS+tYz.

The components Xx, Xy, and Xz of the X axis can be represented as follows (EQ 37).

$$\begin{matrix}\begin{matrix}{X}_{x} = \frac{X\_XS - Ox}{\sqrt{\begin{matrix}{( X\_XS - Ox )}^{2} + {( MYXS - Oy )}^{2} + \\ {( PZXS - Oz )}^{2}\end{matrix}}} \\ = \frac{X\_XS - MXYS - tYx}{\sqrt{\begin{matrix}{( X\_XS - MXYS - tYx )}^{2} + \\ {( MYXS - Y\_YS - tYy )}^{2} + {( PZXS - PZYS - tYz )}^{2}\end{matrix}}}\end{matrix} & ( EQ . 37 ) \\ \begin{matrix}{X}_{y} = \frac{MYXS - Oy}{\sqrt{{( X\_XS - Ox )}^{2} + {( MYXS - Oy )}^{2} + {( PZXS - Oz )}^{2}}} \\ = \frac{MYXS - Y\_YS - tYy}{\sqrt{\begin{matrix}{( X\_XS - MXYS - tYx )}^{2} + \\ {( MYXS - Y\_YS - tYy )}^{2} + {( PZXS - PZYS - tYz )}^{2}\end{matrix}}}\end{matrix} & \\ \begin{matrix}{X}_{z} = \frac{PZXS - Oz}{\sqrt{{( X\_XS - Ox )}^{2} + {( MYXS - Oy )}^{2} + {( PZXS - Oz )}^{2}}} \\ = \frac{PZXS - PZYS - tYz}{\sqrt{\begin{matrix}{( X\_XS - MXYS - tYx )}^{2} + \\ {( MYXS - Y\_YS - tYy )}^{2} + {( PZXS - PZYS - tYz )}^{2}\end{matrix}}}\end{matrix} & \end{matrix}$$

The X and Y axes of the jig measurement coordinate system JM are crossed orthogonally, providing inner product 0 and XxYx+XyYy+XzYz=0.

The equation is solved to find t as follows (EQ 38).

$$\begin{matrix}\begin{matrix}0 = \frac{\begin{matrix}( X\_XS - MXYS - tYx ) Yx + \\ ( MYXS - Y\_YS - tYy ) Yy + ( PZXS - PZYS - tYz ) Yz\end{matrix}}{\sqrt{\begin{matrix}{( X\_XS - MXYS - tYx )}^{2} + \\ {( MYXS - Y\_YS - tYy )}^{2} + {( PZXS - PZYS - tYz )}^{2}\end{matrix}}} \\ = ( X\_XS - MXYS - tYx ) Yx + \\ ( MYXS - Y\_YS - tYy ) Yy + ( PZXS - PZYS - tYz ) Yz \\ = ( X\_XS - MXYS ) Yx + ( MYXS - Y\_YS ) Yy + \\ ( PZXS - PZYS ) Yz - ( YxYx + YyYy + YzYz ) t\end{matrix} & ( EQ 38 ) \\ \begin{matrix}( {Yx}^{2} + {Yy}^{2} + {Yz}^{2} ) t = ( X\_XS - MXYS ) Yx + \\ ( MYXS - Y\_YS ) Yy + \\ ( PZXS - PZYS ) Yz\end{matrix} & \\ t = \frac{\begin{matrix}( X\_XS - MXYS ) Yx + ( MYXS - Y\_YS ) Yy + \\ ( PZXS - PZYS ) Yz\end{matrix}}{{Yx}^{2} + {Yy}^{2} + {Yz}^{2}} & \end{matrix}$$

The found t is assigned to Ox=MXYS+tYx, Oy=Y_YS+tYy, and Oz=PZYS+tYz to find Ox, Oy, and Oz.

Let us find X axis components Xx, Xy, and Xz. The values Ox, Oy, and Oz found above are assigned to equation 38 to find Xx, Xy, and Xz.

$${X}_{x} = \frac{X\_XS - Ox}{\sqrt{\begin{matrix}{( X\_XS - Ox )}^{2} + {( MYXS - Oy )}^{2} + \\ {( PZXS - Oz )}^{2}\end{matrix}}} \\ {X}_{y} = \frac{MYXS - Oy}{\sqrt{\begin{matrix}{( X\_XS - Ox )}^{2} + {( MYXS - Oy )}^{2} + \\ {( PZXS - Oz )}^{2}\end{matrix}}} \\ {X}_{z} = \frac{PZXS - Oz}{\sqrt{\begin{matrix}{( X\_XS - Ox )}^{2} + {( MYXS - Oy )}^{2} + \\ {( PZXS - Oz )}^{2}\end{matrix}}} \qquad ( EQ 39 )$$

Let us find Z axis components Zx, Zy, and Zz. As shown in FIG. 69, an outer product ab of vectors a and b is equivalent to a vector perpendicular to both vectors a and b in such a manner as rotating a screw clockwise in the direction from a to b. In FIG. 69, let us assume the a vector to be the X axis unit vector and the b vector to be the Y axis unit vector in the jig measurement coordinate system JM. The outer product ab is then assumed to be a Z axis unit vector in the jig measurement coordinate system JM. Therefore, the Z axis unit vector (Zx, Zy, Zz) in the jig measurement coordinate system JM is found as Zx=XyYz−XzYy, Zy=XzYx−XxYz, and Zz=XxYy−XyYx using the X axis unit vector (Xx, Xy, Xz) and the Y axis unit vector (Yx, Yy, Yz) found above.

The following describes the measurement of MZPO, MZPX, MZPY, MYXS, MYXL, and MXYS, the measurement of two points on the X axis.

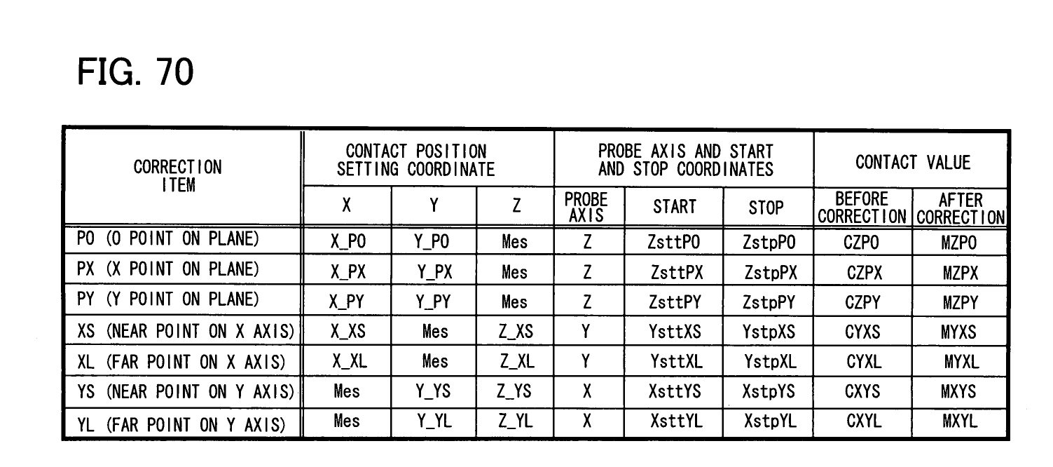

MZPO, MZPX, MZPY, MYXS, MYXL, and MXYS correspond to measurements for the positions in FIG. 70. The concept of the calculation is similar to that for MZPO, MZPX, MZPY, MXYS, MXYL, and MYXS and a description is omitted.

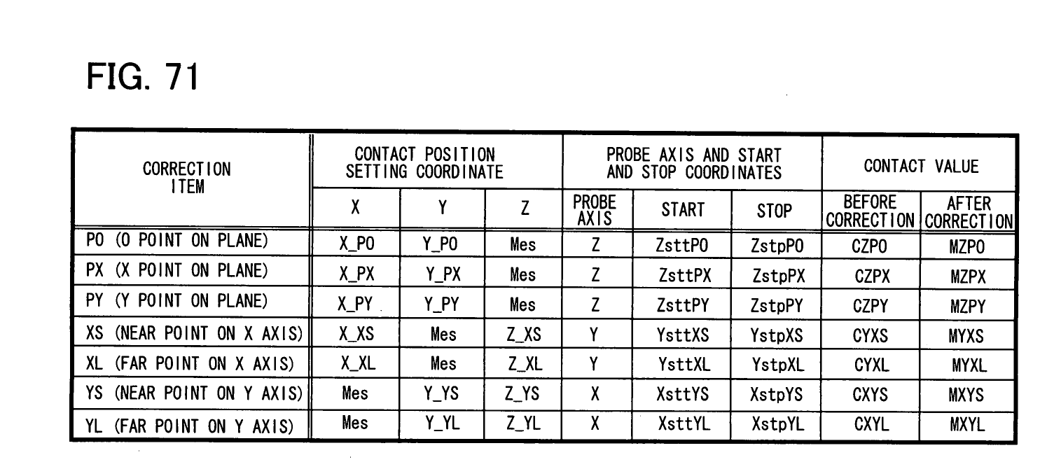

Three measure points are used to find an equation for a plane. The three points used here are combinations of XYZ values for the three points in FIG. 71. The combination is the same as that described for MZPO, MZPX, MZPY, MXYS, MXYL, and MYXS. The same calculation is used to find an equation for plane a′x+b′y+c′z+d=0.

The values for a′, b′, and c′ defines as follows (EQ 40).

$${a}^{′} = \frac{( - {z}_{3} + {z}_{1} ) {y}_{2} + ( - {z}_{1} + {z}_{2} ) {y}_{3} + {y}_{1} {z}_{3} - {z}_{2} {y}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} \\ {b}^{′} = \frac{( {z}_{1} - {z}_{2} ) {x}_{3} + ( {z}_{3} - {z}_{1} ) {x}_{2} - {x}_{1} {z}_{3} + {z}_{2} {x}_{1}}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {y}_{3} ) {x}_{2} - {z}_{2} {x}_{1} {y}_{3}\end{matrix}} \\ {c}^{′} = \frac{( {y}_{2} - {y}_{1} ) {x}_{3} + {x}_{1} {y}_{2} + ( ( {y}_{1} - {y}_{3} ) {x}_{2} + {y}_{3} {x}_{1} )}{\begin{matrix}( - {z}_{1} {y}_{2} + {z}_{2} {y}_{1} ) {x}_{3} + {z}_{3} {x}_{1} {y}_{2} + \\ ( {z}_{1} {y}_{3} - {y}_{1} {z}_{3} ) {x}_{2} - {z}_{2} {x}_{1} {y}_{3}\end{matrix}} \qquad ( EQ 40 )$$

Let us find X axis components Xx, Xy, and Xz from the equation for the plane. The two points pass through the Y axis of the jig measurement coordinate system JM in accordance with the equation for the plane. The XYZ components of the straight line passing through the two points are used to find an X axis component of equation 25.

The equation for the plane found above can be transformed as follows (EQ 41).

$$\begin{matrix}{a}^{′} X + {b}^{′} Y + {c}^{′} Y + 1 = 0 \\ {c}^{′} Z = 1 - {a}^{′} X - {b}^{′} Y \\ Z = \frac{- ( 1 + {a}^{′} X + {b}^{′} Y )}{{c}^{′}}\end{matrix} \qquad ( EQ 41 )$$

Above, the plane was previously found with a 50 mm shift for convenience. The 50 mm can be corrected the coordinate found as follows (EQ 42).

$$Z = \frac{- ( 1 + {a}^{′} X + {b}^{′} Y )}{{c}^{′}} - 50 \qquad ( EQ 42 )$$

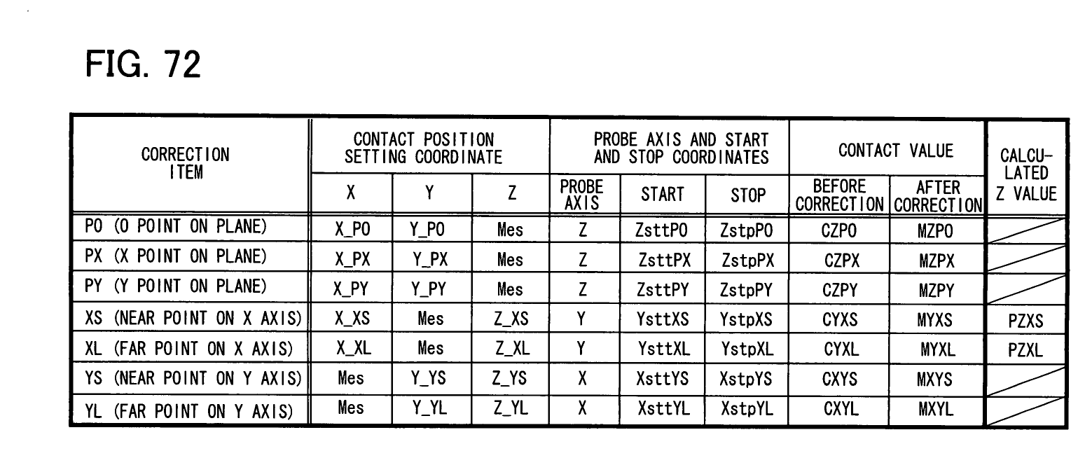

The above-described equation is assigned XY coordinates for the two points in FIG. 72 to find the Z coordinate. Assuming that the equation finds the Z coordinate to be PZXS and PZXL, the Y axis of the jig measurement coordinate system JM passes through two points (X_XS, MYXS, PZXS) and (X_XL, MYXL, PZXL).

Y axis components Yx, Yy, and Yz of the jig measurement coordinate system JM can be found as follows (EQ 43).

$${X}_{x} = \frac{X\_XL - X\_XS}{\sqrt{\begin{matrix}{( X\_XL - X\_XS )}^{2} + {( MMYXL - MYXS )}^{2} + \\ {( PZXL - PZX )}^{2}\end{matrix}}} \\ {X}_{y} = \frac{MMYXL - MYXS}{\sqrt{\begin{matrix}{( X\_XL - X\_XS )}^{2} + {( MMYXL - MYXS )}^{2} + \\ {( PZXL - PZX )}^{2}\end{matrix}}} \\ {X}_{z} = \frac{PZXL - PZXS}{\sqrt{\begin{matrix}{( X\_XL - X\_XS )}^{2} + {( MMYXL - MYXS )}^{2} + \\ {( PZXL - PZX )}^{2}\end{matrix}}} \qquad ( EQ 43 )$$

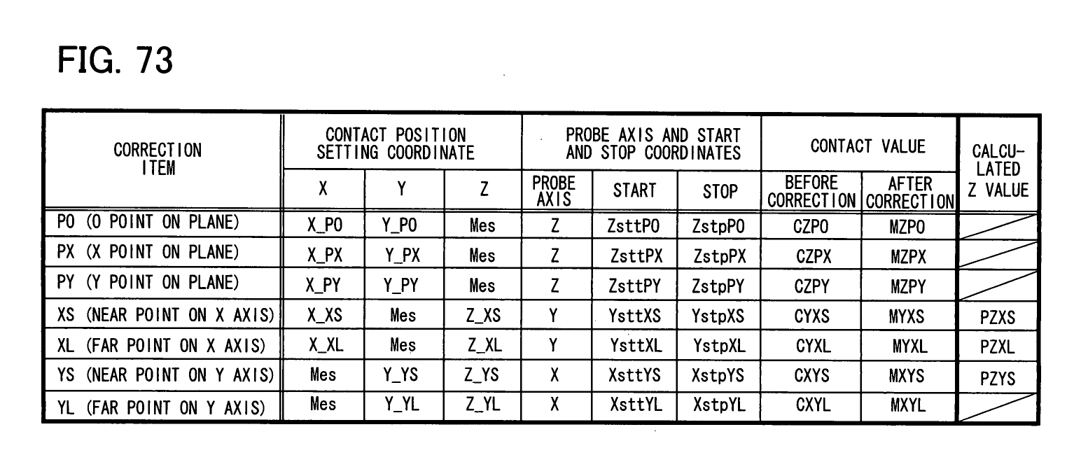

PZYS can be found from the equation for the plane. In a manner similar to the above-described technique, Y_YS and MXYS are assigned to find PZYS as follows (EQ 44). FIG. 73 shows symbols for values to be assigned and found.

$${Z}^{′} = \frac{- ( {a}^{′} X + bY )}{{C}^{′}} - 50 \qquad ( EQ 44 )$$

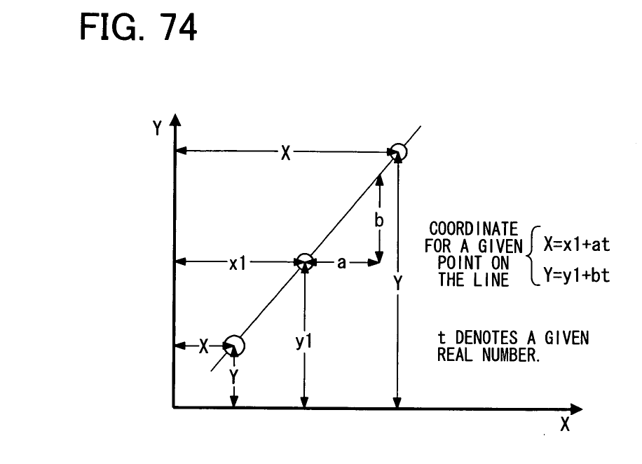

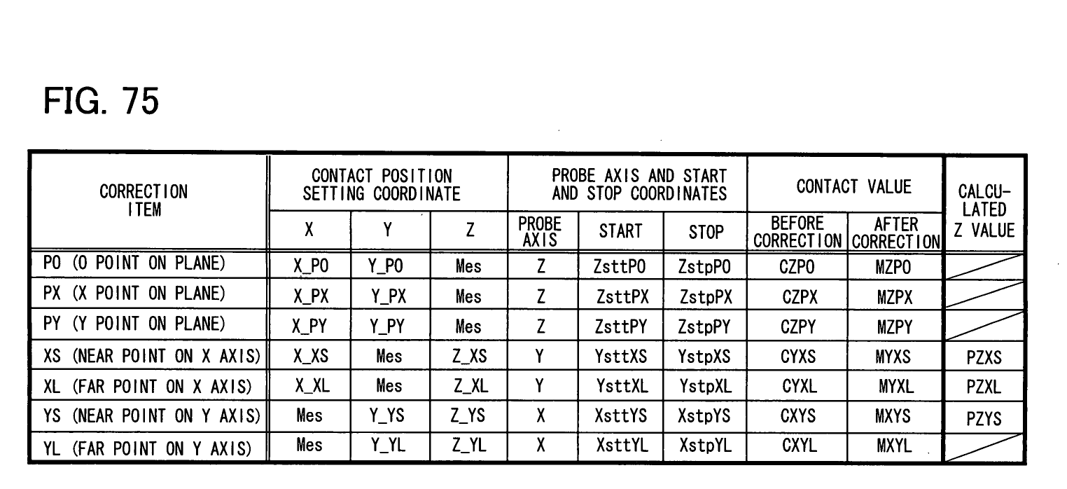

Let us find an origin corresponding to Ox, Oy, and Oz. For example, an equation for straight line can be represented as shown in FIG. 74 when a straight line gradient and a coordinate of a point on the straight line are known in two-dimensional coordinates. The same applies to the three-dimensional coordinate system. A given point on the X axis of the jig measurement coordinate system JM found above can be represented as X=X_XS+tXx, Y=MYXS+tXy, Z=PZXS+tXz, as shown in FIG. 75.

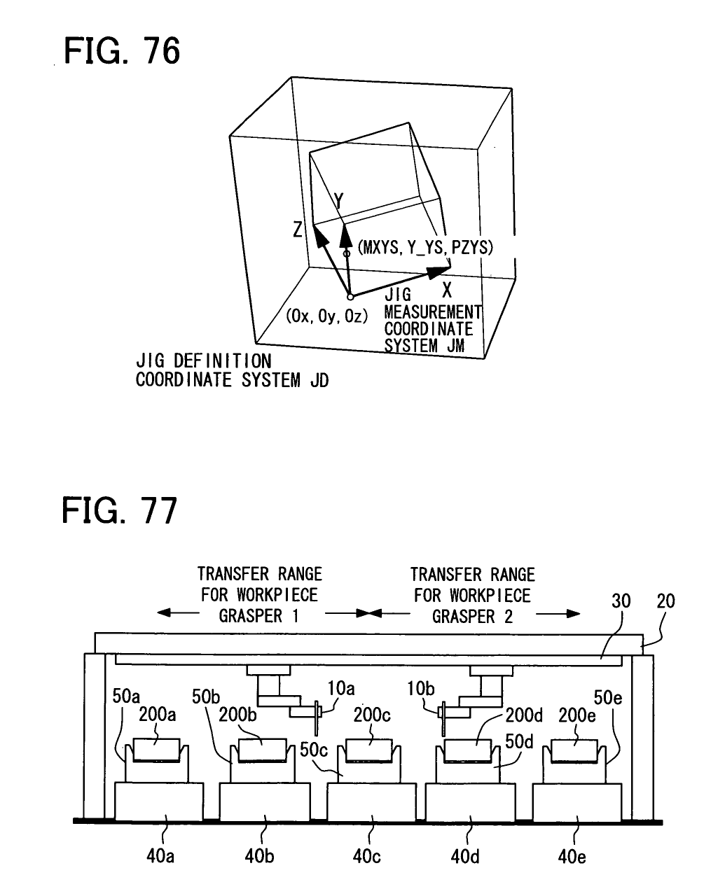

Assume that Ox, Oy, and Oz to represent a coordinate of the intersection point between the X and Y axes in the jig measurement coordinate system JM, as shown in FIG. 76. Since the point (Ox, Oy, Oz) exists on the X axis as well as the Y axis, there is a value for t that satisfies Ox=X_XS+tXx, Oy=MYXS+tXy, Oz=PZXS+tXz.

components Yx, Yy, and Yz of the Y axis can be represented as follows (EQ 45).

$$\begin{matrix}\begin{matrix}{Y}_{x} = \frac{MXYS - Ox}{\sqrt{{( MXYS - Ox )}^{2} + {( Y\_YS - Oy )}^{2} + {( PZYS - Oz )}^{2}}} \\ = \frac{( MXYS - XforOY - tXx )}{( \sqrt{\begin{matrix}\begin{matrix}{( MXYS - X\_XS - tXx )}^{2} + \\ {( Y\_YS - MYXS - tXy )}^{2} +\end{matrix} \\ {( PZYS - PZXS - tXz )}^{2}\end{matrix}} )}\end{matrix} & ( EQ 45 ) \\ \begin{matrix}{Y}_{y} = \frac{Y\_YS - Oy}{\sqrt{{( MXYS - Ox )}^{2} + {( Y\_YS - Oy )}^{2} + {( PZYS - Oz )}^{2}}} \\ = \frac{( Y\_YS - MYXS - tXy )}{( \sqrt{\begin{matrix}\begin{matrix}{( MXYS - X\_XS - tXx )}^{2} + \\ {( Y\_YS - MYXS - tXy )}^{2} +\end{matrix} \\ {( PZYS - PZXS - tXz )}^{2}\end{matrix}} )}\end{matrix} & \\ \begin{matrix}{Y}_{z} = \frac{PZYS - Oz}{\sqrt{{( MXYS - Ox )}^{2} + {( Y\_YS - Oy )}^{2} + {( PZYS - Oz )}^{2}}} \\ = \frac{( PZYS - PZXS - tXz )}{( \sqrt{\begin{matrix}\begin{matrix}{( MXYS - X\_XS - tXx )}^{2} + \\ {( Y\_YS - MYXS - tXy )}^{2} +\end{matrix} \\ {( PZYS - PZXS - tXz )}^{2}\end{matrix}} )}\end{matrix} & \end{matrix}$$

The X and Y axes of the jig measurement coordinate system JM are crossed orthogonally, providing inner product 0 and XxYx+XyYy+XzYz=0.

The equation is solved to find t as follows (EQ 46).

$$\begin{matrix}\begin{matrix}0 = \frac{\begin{matrix}\begin{matrix}Xx ( MXYS - X\_XS - tXx ) + \\ Xy ( Y\_YS - MYXS - tXy ) +\end{matrix} \\ Xz ( PZYS - PZXS - tXz )\end{matrix}}{\sqrt{\begin{matrix}{( MXYS - X\_XS - tXx )}^{2} + \\ {( Y\_YS - MYXS - tXy )}^{2} + {( PZYS - PZXStXz )}^{2}\end{matrix}}} \\ = Xx ( MXYS - X\_XS - tXx ) + \\ Xy ( Y\_YS - MYXS - tXy ) + Xz ( PZYS - PZXS - tXz ) \\ = Xx ( MXYS - X\_XS ) + Xy ( Y\_YS - MYXS ) + \\ Xz ( PZYS - PZXS ) - ( XxXx + XyXy + ZzXz ) t\end{matrix} & ( EQ 46 ) \\ \begin{matrix}( {Xx}^{2} + {Xy}^{2} + {Xz}^{2} ) t = Xx ( MXYS - X\_XS ) + \\ Xy ( Y\_YS - MYXS ) + \\ Xz ( PZYS - PZXS )\end{matrix} & \\ t = \frac{\begin{matrix}Xx ( MXYS - X\_XS ) + Xy ( Y\_YS - MYXS ) + \\ Xz ( PZYS - PZXS )\end{matrix}}{{Xx}^{2} + {Xy}^{2} + {Xz}^{2}} & \end{matrix}$$

The t found in EQ 46 is assigned to Ox=XforOY+tXx, Oy=MOy+tXy, and Oz=Zoy+tXz to find Ox, Oy, and Oz.

Y axis components Yx, Yy, and Yz can be found as follows (EQ 47). The values Ox, Oy, and Oz found above are assigned to equation 47 to find Yx, Yy, and Yz.

$${Y}_{x} = \frac{MXYS - Ox}{\sqrt{{( MXYS - Ox )}^{2} + {( Y\_YS - Oy )}^{2} + {( PZYS - Oz )}^{2}}} \\ {Y}_{y} = \frac{Y\_YS - Oy}{\sqrt{{( MXYS - Ox )}^{2} + {( Y\_YS - Oy )}^{2} + {( PZYS - Oz )}^{2}}} \\ {Y}_{z} = \frac{PZYS - Oz}{\sqrt{{( MXYS - Ox )}^{2} + {( Y\_YS - Oy )}^{2} + {( PZYS - Oz )}^{2}}} \qquad ( EQ 47 )$$

Z axis components Zx, Zy, and Zz can be found based on an outer product X and Y vectors. Z axis unit vector components (Zx, Zy, Zz) as Zx=XyYz−XzYy, Zy=XzYx−XxYz, and Zz=XxYy−XyYx can then be found.

The following operation is needed at a boundary between a transfer range of the workpiece grasper 10a and a transfer range of the next workpiece grasper 10b during workpiece transfer on the production line in accordance with the present embodiment. The workpiece grasper 10a places the workpiece 200 on a jig and the next workpiece grasper 10b picks up the workpiece 200 from the jig.

In FIG. 77, the facility 40c corresponds to the transfer boundary between the workpiece grasper 10a and the workpiece grasper 10b. The workpiece grasper 10a places a workpiece 200c on the facility 40c. The workpiece grasper 10b picks up the workpiece 200c from the facility 40c.

The workpiece graspers 10a and 10b both require the facility 40c and a jig 50c placed thereon to be positioned correctly. According to a simple solution, the workpiece graspers 10a and 10b each may calibrate positions by contact with reference to the facility 40c.

A setup stop time increases when the two workpiece graspers 10a and 10b each calibrate positions with reference to the same jig 50c. To address two calibrations, one workpiece grasper calibrates positions by contact and the other workpiece grasper uses a result of the calibration.

For examination of the issue of two or more calibrations, it is necessary to understand that the calibration of facility and jig contact positions signifies not only calibration of facility and jig positions but also calibration including installation accuracies of the rail 30 and the workpiece graspers. Rail installation accuracy will be first described to provide a basis for understanding calibration of facility and jig and how to use measurement results from the other workpiece graspers. In the following description and drawings, the workpiece grasper is also referred to as a workpiece grasper R or B.

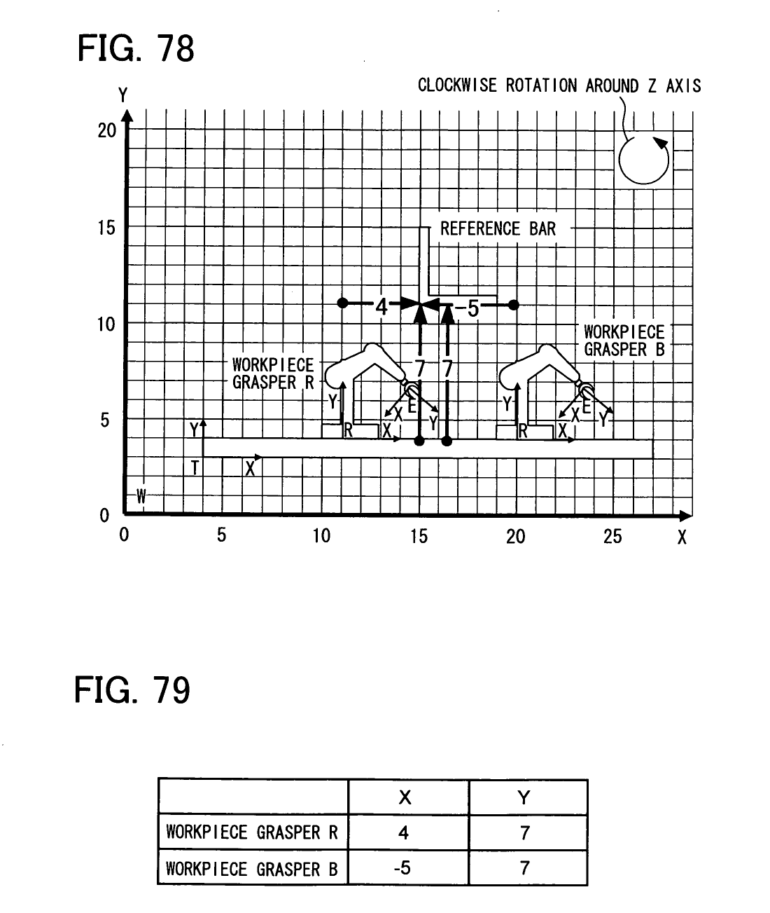

Suppose that the rail, the workpiece graspers R and B, and the reference bar to be calibrated are positionally related to each other as shown in FIG. 78. Positions of the reference bar are measured as shown in FIG. 79 when viewed from the workpiece graspers R and B. For example, a coordinate calculation system issues an instruction to the workpiece grasper R so as to calibrate the positions by performing the following calculations ^{W}T^{T}R^{R}E=^{W}C, (^{T}R)⁻¹(^{W}T)−^{1W}T^{T}R^{R}E=(^{T}R)⁻¹(^{W}T)^{-1W}C, and ^{R}E=(^{T}R)⁻¹(^{W}T)^{-1W}C.

The workpiece grasper R assumes the reference bar to be positioned at X=4 and Y=7 viewed from the workpiece grasper coordinate system and measures a deviation of the reference bar from the calculated position corresponding to the facility or the jig definition coordinate system.

The reference bar may be positioned as scheduled when it is possible to accurately measure a position of the rail in the world coordinate system and a position of the workpiece grasper on the rail to an accuracy of 1/100 millimeter. However, it is impossible to accurately measure a position of the rail in the world coordinate system and a position of the workpiece grasper on the rail to an accuracy of 1/100 millimeter. Normally, errors are measured to an accuracy of several millimeters between actual positions and the position of the rail in the world coordinate system and the position of the workpiece grasper on the rail.

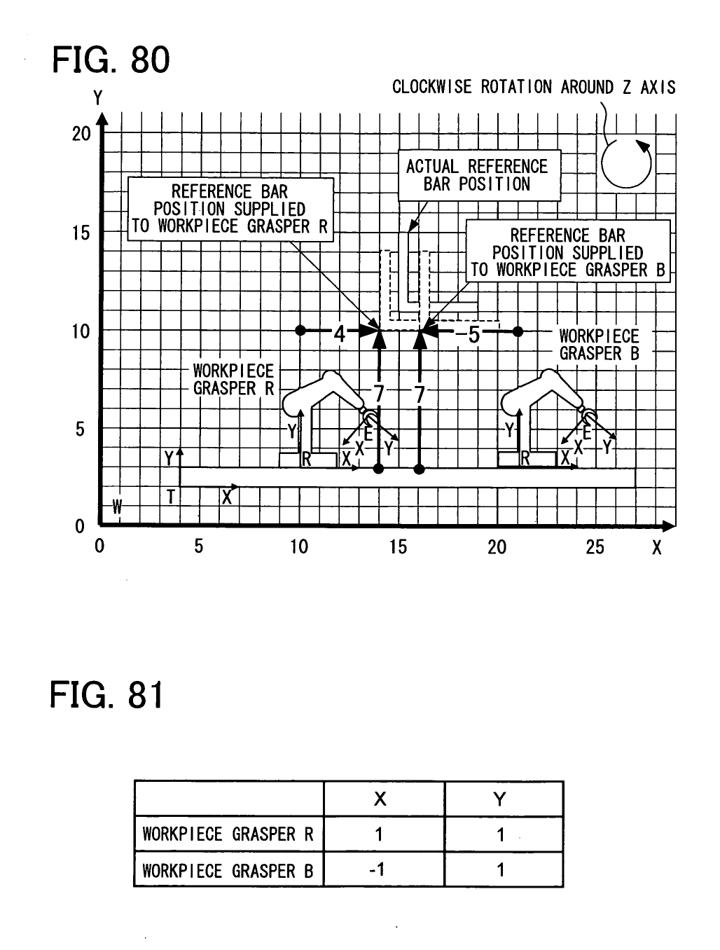

Suppose errors between defined positions and actual positions such as Y=−1 for the rail on the world coordinate system, X=−1 for the workpiece grasper R on the rail, and X=+1 for the workpiece grasper B on the rail. The coordinates defined for the rail in the world coordinate system and the workpiece grasper R and B on the rail are completely the same as the previous ones. The workpiece graspers R and B each start the coordinate calibration on the assumption that the reference bar is located as shown in FIG. 80. The workpiece graspers R and B provide measurements indicating that the actual reference bar position deviates from the estimated reference bar position as shown in FIG. 81. The workpiece grasper can move the tools as the hands 16a and 16b above the reference bar origin when moving as much as X=5 and Y=8 by correcting X=1 and Y=1 from X=4 and Y=7 as estimated first.

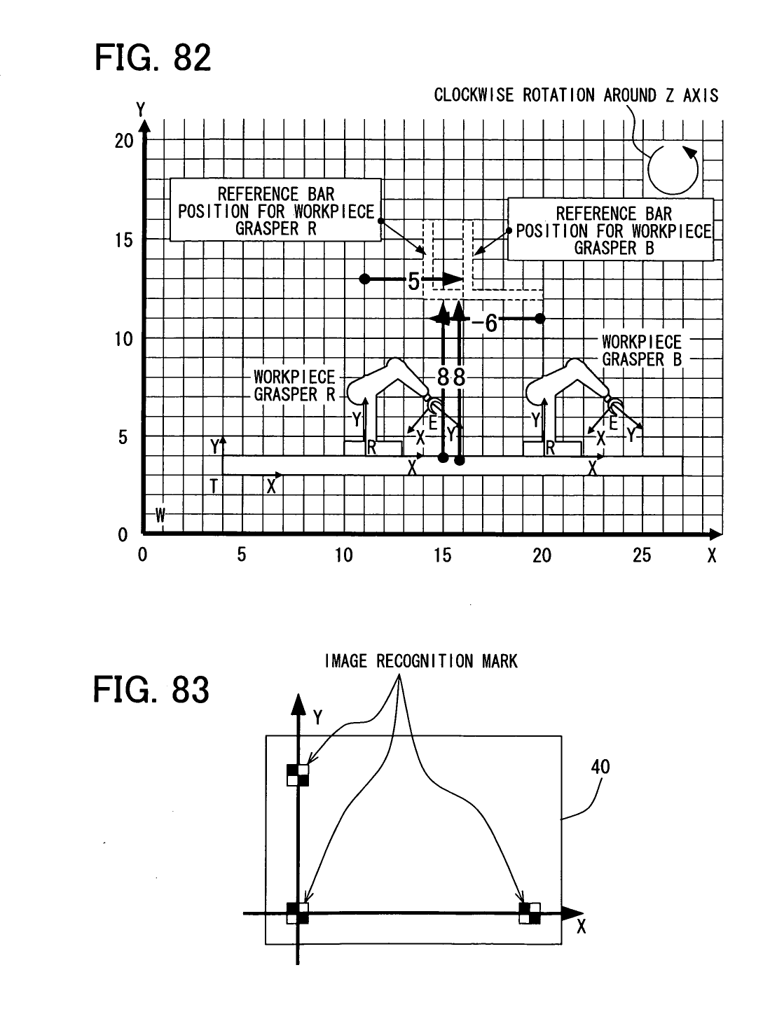

As shown in FIG. 82, all deviations concentrate on the facility position even though the rail in the world coordinate system or the workpiece grasper on the rail causes a positional deviation. The system recognizes the facility to be positioned as shown in FIG. 82.

Thus, the contact position correction can correct not only facility or jig positions but also positions of the reference bar for each workpiece grasper including errors between defined and actual positions of the facility and the rail in the world coordinate system and those of the workpiece grasper on the rail. The contact position correction is considered to provide a very powerful function of correcting positions. By contrast, the contact position correction is also considered incapable of directly using a facility position corrected by another workpiece grasper in the world coordinate system.

As mentioned above, another workpiece grasper calibrates facility positions including errors between defined and actual positions of the facility and the rail in the world coordinate system and those of the workpiece grasper on the rail. The calibrated facility position cannot be used as is. The following describes a method of using calibration information provided by another workpiece grasper.

The facility coordinate calibration is performed even when the calibration is duplicated for workpiece graspers. Viewed from the facility coordinate system, a jig coordinate MJ directly uses calibration information supplied from another facility. It is assumed that the facility position calibration always precedes the jig position calibration.

The above described technique is used for the following reason. The facility coordinate calibration is performed once when the power is turned on. Even when the workpiece graspers calibrate coordinates more than once, the facility coordinate calibration makes the effects on an operation time loss less serious than the jig position calibration. Since the facility position calibration precedes the jig position calibration, the facility positions are corrected when viewed from the workpiece graspers. The calibration has already corrected errors between defined and actual positions of the facility and the rail in the world coordinate system and those of the workpiece grasper on the rail. The reference bar for the jig is then searched in the corrected facility coordinate system. The jig coordinate system MJ viewed from the facility coordinate system is free from an effect of errors between defined and actual positions of the facility and the rail in the world coordinate system and those of the workpiece grasper on the rail.

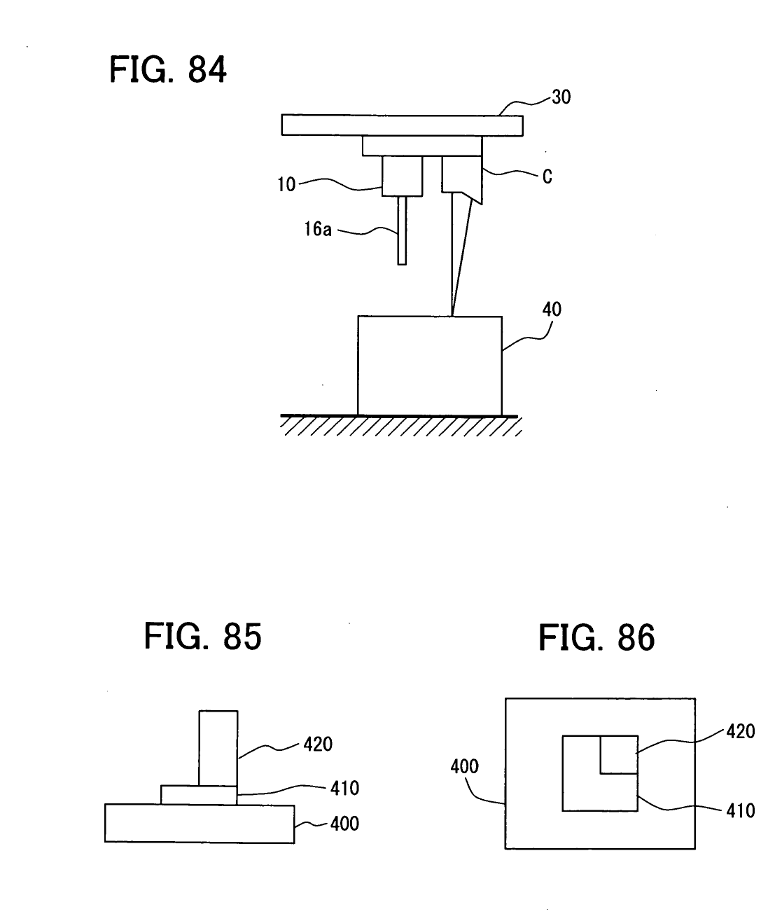

An optical method may be used instead of the contact-based function of measuring and correcting facility or jig positions as mentioned above. For example, FIG. 84 shows the use of a two-dimensional camera and a laser distance meter. An image recognition mark is given to the reference bar of the facility or the jig as shown in FIG. 83. An two-dimensional camera (not shown) captures the image recognition mark. A laser distance meter C measures a height of the image recognition mark. Facility or jig positions can be detected in the same manner as the contact position correction using the workpiece grasper.

The above described operation causes an offset between the hand 16a and the center axis of the camera and an offset between the hand 16a and a laser height measuring instrument C. The following describes an example of automatically measuring the offsets. A jig, as shown in FIGS. 85 and 86 includes a first member 410 and a second member 420. The first member 410 is mounted on a substrate 400 and has a smaller plane area than the substrate 400. The top surface of the first member 410 is painted black. The second member 420 is mounted on the first member 410 and has a smaller plane area than the first member 410. The top surface of the second member 420 is painted white.

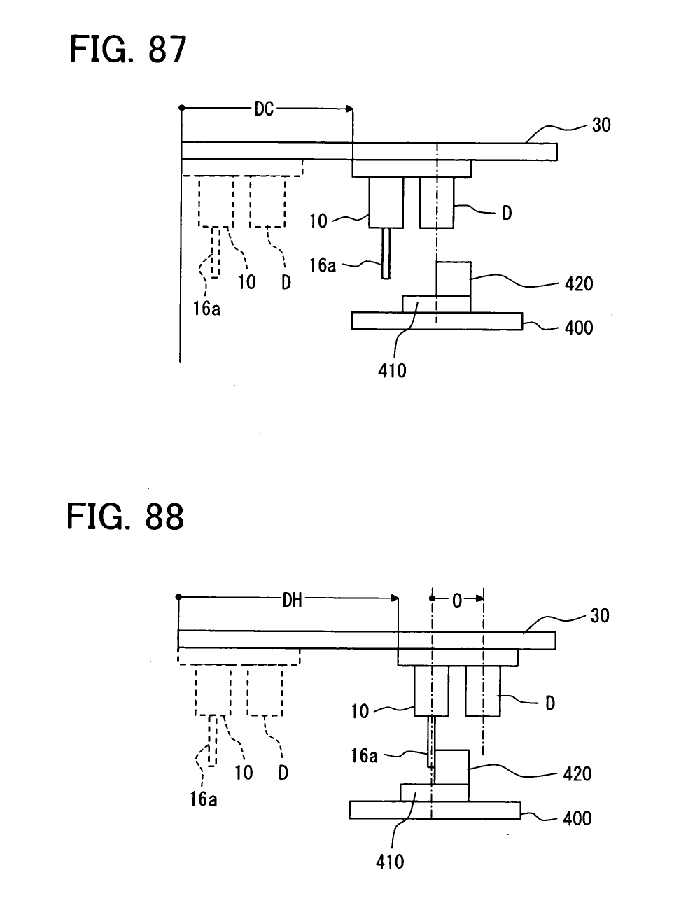

As shown in FIGS. 87 and 88, an operation is performed to find a robot drive quantity DC for adjusting a black-and-white boundary of the jig to the center line of the camera. Another operation is performed to find a workpiece grasper drive quantity DH for allowing the hand 16a to contact with a black-and-white boundary wall of the jig. An offset between the camera D and the hand 16a is 0=DH−DC−HR, where HR is a radius of the hand 16a.

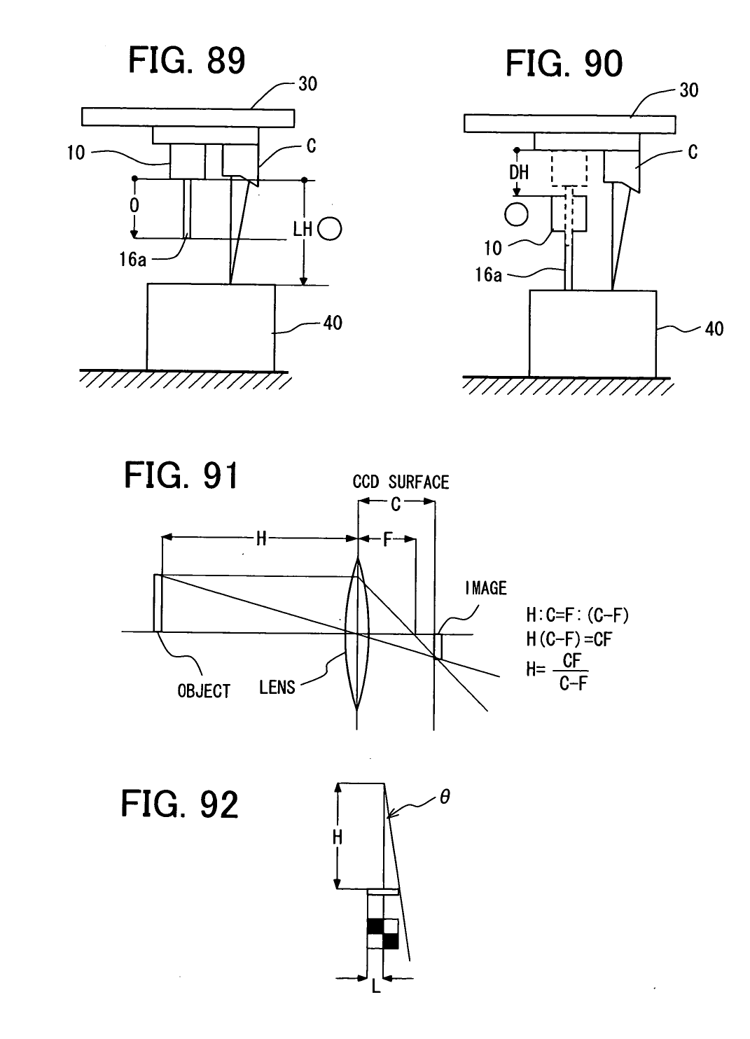

The following describes a height offset between the hand 16a and the laser height measuring instrument C. As shown in FIGS. 89 and 90, a distance meter C is used to measure a distance LH. The hand 16a is then lowered to contact with the top surface of the facility. A descending drive quantity is assumed to be DH. When the drive quantity is 0, an offset between the measuring instrument and the tip of the hand 16a is found to be 0 by subtracting DH from LH.

Only the camera may be used. Instead of measuring a distance using the above-described distance meter C, a distance is measured based on a focal length for focusing the camera as shown in FIG. 91. In addition, a mark is specifically sized. A distance is found based on an angle of the mark in the visual field. As shown in FIG. 92, H=L/tanθ when L is known.

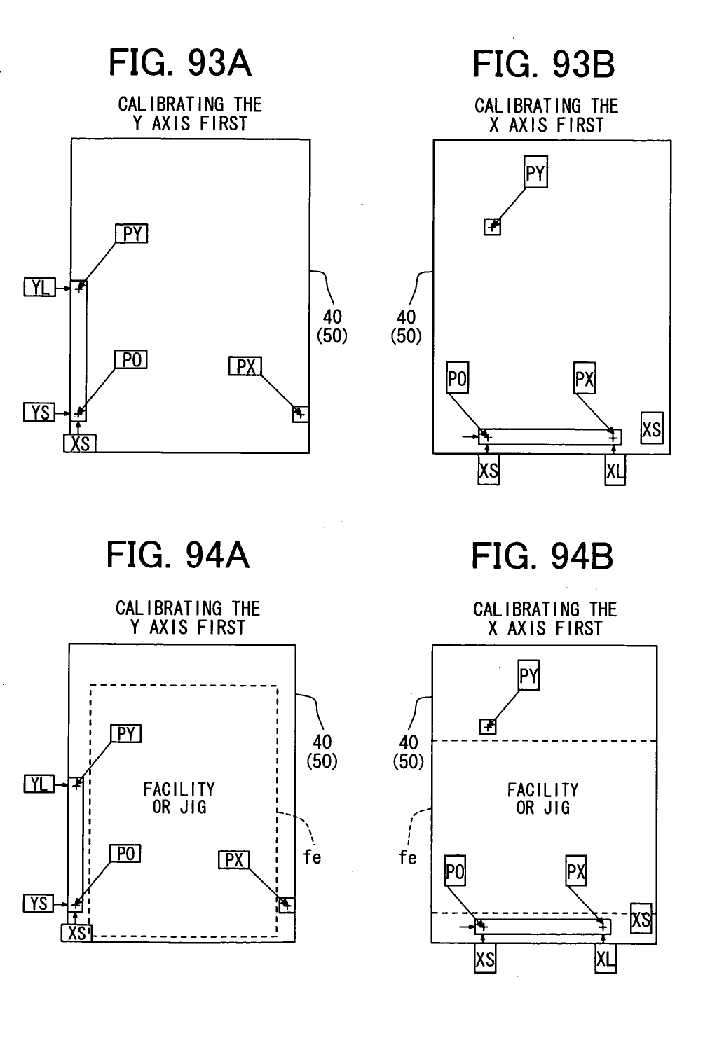

It may be advantageous to use a separate type contact reference bar as shown in FIG. 93A and FIG. 93B. FIG. 93A shows calibration of the Y axis first. FIG. 93B shows calibration of the X axis first.

As shown in FIG. 94A and FIG. 94B, the separate type contact reference bar is easy to use because of accessibility to an open portion fe at the center. When calibrating the Y axis first, only a PX can be separated for plane surface positioning. When calibrating the X axis first, only a PY can be separated for plane surface positioning. The PX, PY, and reference bar just must be aligned to another reference bar only for the vertical accuracy using a simple method such as, for example, fabricating two reference bars with the same thickness and bolting both to a top board of the facility 40 or the jig 50.

On a production line for electronic circuit boards, a printed board flows during beginning processes. After completion of processes for the printed board, the printed board is placed in a case. The succeeding processes include printing a name on the case or attaching an external bracket to the case. It may be preferable to transfer the case as a workpiece containing the printed board.

The case can be provided with a hole to use the hand capable of holding a single point. A vacuum contact hand may be used since the case may have a wide flat surface of Φ30 or more capable of vacuum contact.

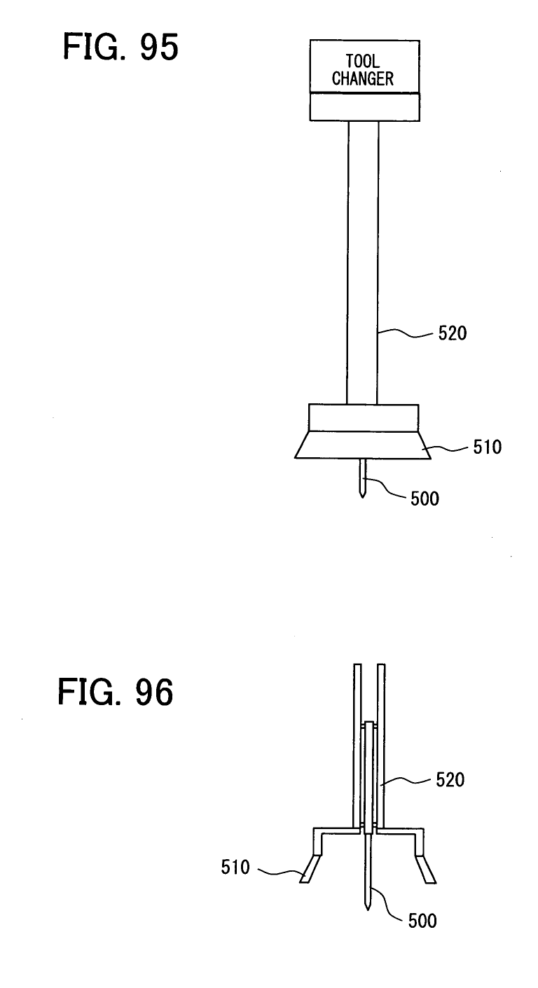

When a vacuum contact pad is used as a hand for the workpiece grasper 10, for example, a rubber 510 is provided for the tip of a cylindrical member 520 as shown in FIGS. 95 and 96. A contact probe 500 is provided at the center of the vacuum contact pad. A spring is used to elongate and contract the contact probe 500. This economically enables conductivity-based contact detection for contact position calibration.

What is claimed is:

1. A workpiece grasper used in a production line for transferring a workpiece and the workpiece processed using three or more processing facilities, the workpiece grasper grasping and placing the workpiece for the transferring the workpiece between ones of the three or more processing facilities, the workpiece grasper comprising:
two hands capable of grasping and placing the workpiece; and
a change mechanism for rotating the two hands above a line along a transfer direction of the workpiece to change a hand for grasping the workpiece from the processing facility and change a hand for placing the grasped workpiece on the processing facility.

2. The workpiece grasper of claim 1,
wherein the two hands are provided open with a specified angle for a base member arranged above a line along a transfer direction of the workpiece; and
wherein the change mechanism rotates the base member to rotate the two hands above a line along a transfer direction of the workpiece.

3. A method for transferring a workpiece in a production line the workpiece processed using three or more processing facilities using a workpiece grasper grasping and placing the workpiece for the transferring the workpiece between ones of the three or more processing facilities, the workpiece grasper having two hands capable of grasping and placing the workpiece; and a change mechanism for rotating the two hands above a line along a transfer direction of the workpiece to change a hand for grasping the workpiece from the processing facility and change a hand for placing the grasped workpiece on the processing facility, the method comprising:
a first process of grasping the workpiece from a given one of the three or more processing facilities using a first hand of the two hands;
a second process of moving the workpiece grasper to a second processing facility and allowing the change mechanism to change the first hand grasping the workpiece to a second hand;
a third process of causing the second hand to grasp the workpiece from the second processing facility;
a fourth process of causing the change mechanism to change the second hand to the first hand after the third process;
a fifth process of placing the workpiece grasped by the first hand on the second processing facility after the fourth process;
a sixth process of moving the workpiece grasper to a third processing facility and causes the first hand to grasp the workpiece from the third processing facility after the fifth process;
a seventh process of causing the change mechanism to change a hand for placing the workpiece to the second hand after the sixth process; and
an eighth process of placing the workpiece grasped by the second hand on the third processing facility after the seventh process.

4. A workpiece grasper for transferring a workpiece processed using three or more processing facilities, the workpiece transferred by the workpiece grasper grasping and placing the workpiece between ones of the three or more processing facilities, the workpiece grasper comprising:
a first hand and a second hand grasping and placing the workpiece in a jig;
a change mechanism for rotating the two hands above a line along a transfer direction of the workpiece to change a hand for grasping the workpiece from the processing facility and change a hand for placing the grasped workpiece on the processing facility; and
a calibration system providing an offline teaching of the workpiece grasper, the offline teaching correcting one or more error offsets associated with a position of the first hand and the second hand.

5. The workpiece grasper of claim 4, wherein the calibration system includes a contact system, the offline teaching of the workpiece grasper including automatically inching the first hand and the second hand from a position slightly short of the edge of the jig, a drive quantity DC stored when at least one of the first hand and the second hand contact the jig.

6. The workpiece grasper of claim 4, wherein the calibration system includes an optical system, the offline teaching of the workpiece grasper including automatically inching the first hand and the second hand from a position slightly short of the edge of the jig, a drive quantity DC stored when at least one of the first hand and the second hand reaches a predetermined optical mark.

7. The workpiece grasper of claim 6, wherein optical system includes a laser system.

8. The workpiece grasper of claim 6, wherein optical system includes a camera system.

9. A workpiece transfer apparatus automatically transferring a workpiece on a production line having a plurality of processing facilities for processing the workpiece, each of the plurality of processing facilities provided with a jig, the workpiece transfer apparatus including a workpiece grasper moved along a rail and controlled by a controller, the workpiece grasper including a support section, a Y-axis adjusting section, a Z-axis adjusting section, a θ-axis adjusting section, a base member detachably supporting a first hand and a second hand, wherein:
the Y-axis adjusting section includes a Y-axis actuator adjusting the first hand and the second hand in the Y-axis direction;
the Z-axis adjusting section includes a Z-axis actuator adjusting the first hand and the second hand in the Z-axis direction;
the θ-axis adjusting section includes an θ-axis actuator adjusting the first hand and the second hand in the θ-axis direction;
the first hand and the second hand are opened at a specified angle;
the base member includes a rotation mechanism for switching between the first hand and the second hand, the rotation mechanism rotating the base member a predetermined distance above the plurality of processing facilities in the transfer direction of the workpiece, the first hand and the second hand opened at the specified angle, which is centered around the rotation axis.

10. The workpiece transfer apparatus according to claim 9, wherein, when the workpiece has a hole, one of the first hand and the second hand is inserted into the hole to hold the workpiece using an internal pipe and a rod member.

11. The workpiece transfer apparatus according to claim 10, wherein the internal pipe includes a cylindrical portion extending in the axis direction of the hole and a divided portion divided into multiple portions at the end of the cylindrical portion.

12. The workpiece transfer apparatus according to claim 10, wherein the rod member includes a projected portion smaller than the hole and larger than an opening of the internal pipe and wherein before a part of the internal pipe and the rod member is inserted into the hole, the projected portion is placed outside the internal pipe.

13. The workpiece transfer apparatus according to claim 12, wherein when the part of the internal pipe and the rod member is inserted into the hole, the rod member moves opposite to the insertion direction to place the projected portion inside the internal pipe so as to widen the divided portion and hold the workpiece.

14. The workpiece transfer apparatus according to claim 9, wherein a first one of the first hand and the second hand holds the workpiece and a second one of the first and second hand seats the workpiece.

15. The workpiece transfer apparatus according to claim 9, wherein while a first one of the first hand and the second hand grasps a first one of the workpiece from a first one of the plurality of processing facilities, a second one of the first and second hands seats a second previously grasped workpiece on one of the plurality of processing facilities.

16. A method for transferring workpieces in a production line including a plurality of processing facilities, the production line including a workpiece grasper having a first hand and a second hand, the method comprising:
grasping a first workpiece from a first one of the plurality of processing facilities with the first hand, the first hand being an active hand;
moving the workpiece grasper to a second one of the plurality of processing facilities and changing the active hand from the first hand to the second hand;
grasping a second workpiece from a second one of the plurality of processing facilities with the second hand and changing the active hand from the second hand to the first hand and placing the first workpiece grasped by the first hand on the second one of the plurality of processing facilities;
moving the workpiece grasper to a third one of the plurality of processing facilities;
grasping a third workpiece from the third one of the plurality of processing facilities with the first hand and changing the active hand from the first hand to the second hand and placing the second workpiece grasped by the second hand on the third one of the plurality of processing facilities; and
correcting the accuracy of at least one of the moving the workpiece grasper to the second one, the moving the workpiece grasper to the third one, the grasping the first workpiece, the grasping the second workpiece, and the grasping the third workpiece.

17. The method for transferring workpieces according to claim 16, wherein, when the first the second and the third workpieces include a hole, the method further comprises, inserting a portion of one of the first hand and the second hand into the hole to hold the first the second and the third workpieces.

18. The method for transferring workpieces according to claim 16, wherein:
each of the plurality of processing facilities in includes a jig;
the correcting the accuracy of the at least one of the moving the workpiece grasper to the second one and the moving the workpiece grasper to the third one includes bringing the workpiece grasper into contact with a reference portion of a jig associated with the one and accurately moving the workpiece grasper from a first position in contact with the reference portion to a second position for the grasping.

19. The method for transferring workpieces according to claim 18, wherein:
a drive quantity is used to move the workpiece grasper to the first position in contact with the reference portion; and
when the at least one includes the moving the workpiece grasper to the second one and the moving the workpiece grasper to the third one, the correcting the accuracy of the at least one includes correcting in a first dimension by measuring and calibrating the accuracy of the moving based on a previous measurement of accuracy of movement from the first position to the second position and comparing the drive quantity with a true quantity.

20. The method for transferring workpieces according to claim 16, wherein:
when the at least one includes the grasping the first workpiece, the grasping the second workpiece, and the grasping the third workpiece, the correcting the accuracy is conducted using a calibration jig to correct in at least a second and third dimension, the calibration jig including one or more rectangular metal columns having at least one corner positioned to a specified grid point.

21. The method for transferring workpieces according to claim 20, wherein:
the calibration jig includes a plurality of specified grid points, the plurality of grid points provided at level points a distance from a bottom of the jig;
the workpiece grasper reads a true coordinate value at each of an X, a Y, and a Z drive values associated with contact between the a contact tool on the workpiece grasper and each of the specified grid points; and
generating a correction map for acquiring corrected X, Y, and Z drive values for the workpiece grasper, the corrected drive values corresponding to true coordinate values.

22. A measurement jig for measuring and calibrating movement of a workpiece grasper in a workpiece transfer apparatus having a plurality of processing facilities each of the plurality of processing facilities having a processing jig, the measurement jig having a planar base, the measurement jig being placed in a position corresponding to one of the processing jig and the workpiece, the measurement jig comprising:
an adjustment mechanism to allow the measurement jig to be adjusted to as to be parallel to and level with a rail associated with the workpiece transfer apparatus; and
correction elements forming a reference grid, reference points on the reference grid for measuring and correcting a drive position of the workpiece grasper when a portion of the workpiece grasper contacts the correction elements.

23. The measurement jig in accordance with claim 22, wherein the correction elements include correction bars.

24. The measurement jig in accordance with claim 22, further comprising three layer plates, wherein the correction elements include edged holes in the three layer plates.

25. The measurement jig in accordance with claim 22, wherein:
the adjustment mechanism includes a measurement jig mounting surface having an X axis rotation adjustment micrometer, a Y axis rotation adjustment micrometer, and a Z axis rotation adjustment micrometer;
the Z axis rotation adjustment micrometer is moved so that Y values for the X axis measured on the rail are adjusted to the same value at the left and right ends of the jig;
the Y axis rotation adjustment micrometer is moved so as to level the measurement jig in the X axis direction; and
the X axis rotation adjustment micrometer is moved so as to level the jig in the Y-axis direction.

26. A method of correcting movement of a workpiece grasper for grasping a workpiece in a workpiece transfer apparatus, the workpiece grasper transferred along a rail extending over a plurality of processing facilities for processing the workpiece, a weight of the workplace measured at a plurality of grid points, the method comprising
correcting a deflection position error due to a weight of the workpiece if a force associated with a full rigidity of the workpiece grasper is exceeded, the deflection position error corrected by sampling and interpolating the weight measured at the plurality of grid points; and
correcting travel position error of the workpiece grasper along the rail, the travel position error capable of occurring in one or more of a X axis, a Y axis, and a Z axis, when the workpiece grasper travels a certain distance along the rail when the rail is one or more of inaccurately perpendicular and inaccurately straight, the correcting the travel position error conducted using n number of reference points.

27. A method of correcting movement of a workpiece grasper according to claim 26, wherein n equals 4.

28. A method of correcting movement of a workpiece grasper according to claim 26, wherein n equals 8.

29. A method of teaching movement of a workpiece grasper in a workpiece transfer apparatus, the workpiece grasper transferred along a rail extending over a plurality of processing facilities for processing a plurality of workpieces, the plurality of workpieces grasped according to a grasping instruction, at least some of the plurality of workpieces being differently shaped from others of the plurality of workpieces, the differently shaped some of the plurality of workpieces requiring a different grasping instruction, each of the plurality of processing facilities having a jig, a position of at least one of the plurality of processing facilities and the jig associated therewith capable of being corrected, the method comprising
teaching the workpiece grasper regarding a first position associated with the grasping instruction and a second position associated with the different grasping instruction;
transferring one of the plurality of workpieces from one of the plurality of processing facilities to another of the plurality of processing facilities, the workpiece grasper provided with a first hand and a second hand, one of the first hand and the second hand capable of grasping the one of the plurality of different shaped workpieces by a first specified contact area on the one by inserting a portion of the hand into a first hole associated with the first specified contact area according to the grasping instruction; and
transferring one of the differently shaped plurality of workpieces from the one of the plurality of processing facilities to the another of the plurality of processing facilities, another one of the first hand and the second hand capable of grasping the one of the differently shaped plurality of different shaped workpieces by a second specified contact area on the one by inserting the portion of the hand into a second hole associated with the first specified contact area according to the different grasping instruction.

30. The method of teaching movement of a workpiece grasper according to claim 29, wherein the teaching the workpiece grasper includes offline teaching with numeric values to find a drive quantity for the inserting the portion of the one of the first hand and the second hand into the first hole and the second hole.

31. The method of teaching movement of a workpiece grasper according to claim 30, wherein the offline teaching includes:
automatically inching the one of the first hand and the second hand from a position slightly short of an edge of the jig;
storing a drive quantity when contact between the one of the first hand and the second hand and the jig is detected; and
moving the one of the first hand and the second hand to position the on at a center of one of the first hole and the second hole.
